(19) United States
(12) Patent Application Publication
(10) Pub. No.: US 2026/0347527 A1
(43) Pub. Date: Nov. 5, 2026

(54) Fluorinated Copolymer Bottlebrushes for Optical Applications

(71) Applicant: Duke University, Durham, NC (US)

(72) Inventors: Matthew L. Becker, Chapel Hill, NC (US); Virginia Ritter, Chappaqua, NY (US)

(21) Appl. No.: 19/483,011

(22) PCT Filed: May 8, 2024
(86) PCT No.: PCT/US2024/028439

§ 371 Date: Nov. 10, 2025

Related U.S. Application Data
(60) Provisional application No. 63/500,718, filed on May 8, 2023.

(51) Int. Cl. C08F 290/06; C08F 293/00

(52) U.S. Cl. CPC C08F 290/068; C08F 293/005; C08F 2438/03; C08F 2800/10

(57) ABSTRACT

In various embodiments, the present invention is directed to an optically clear bottlebrush copolymers comprising one or more acryloxy or monomethacryloxy terminated polydimethylsiloxane (PDMS-MA) units, and or more acryloxy or monomethacryloxy terminated fluorinated siloxane (Fluoro-MA) units, and 2-cyano isobutane end groups. In addition to being optically clear, the viscosity and other properties of these bottlebrush copolymers are controllable making them suitable for a variety of applications. In some embodiments, the optically clear bottlebrush copolymers of the present invention will have complex viscosity (η) at 37° C. that make them are suitable for use as filler materials in intraocular lenses (IOLs) and accommodating or adaptive intraocular lenses (A-IOLs) for use in surgery for treating cataracts and other optical maladies.

### NAMES OF THE PARTIES TO A JOINT RESEARCH AGREEMENT

The present application stems from work done pursuant to a Joint Research Agreement between Duke University of Durham, North Carolina and Adaptilens, LLC of Chestnut Hill, Massachusetts.

### FIELD OF THE INVENTION

One or more embodiments of the present invention relate to bottlebrush copolymers. In certain embodiments, the invention relates to biostable polymer bottlebrushes that have optical properties for use in intraocular lenses.

### BACKGROUND OF THE INVENTION

Polymers are split into two general classes: thermoplastics and thermosets. Due to lacking a crosslinked network, thermoplastics can be soluble in good solvents and become soft or melt when heated, in this way they can be reprocessable and remoldable. Thermosets, on the other hand, contain crosslinked networks and are irreversibly cured for high-performance applications. Elastomers are a class of materials that contain lightly crosslinked polymer networks which give elasticity to the elastomers. Soft elastomers can be prepared by increasing the molecular weight of the network strand (polymer chains between two junctions/crosslinking points) and by decreasing the chain entanglement of the polymer chains. Polymer chains start generating entanglement within the system above a certain molecular weight called chain entanglement molecular weight, and these entangled chains are permanently trapped upon crosslinking which then behave as topological crosslinks. These chain entanglements can be prevented or delayed by changing the “volume” of the polymer chain which is possible through changing the architecture of the polymer chain from linear to branched or regime where the side chains are highly stretched and crowded which forces the backbone into a highly extended state, commonly referred to as bottlebrush.

Bottlebrush polymers (BBPs) are a type of polymers with long and densely grafted side chains. BBPs can be synthesized using different approaches such as grafting to, grafting from, and grafting through approaches. In the grafting to approach, long polymer chains asymmetrically terminated with a functional group can be chemically connected to a polymer backbone with many functional groups ideally on every repeating unit which are reactive to the functional group on the long polymer chains. The grafting from approach requires a polymer backbone with initiator sites ideally on every repeating unit. Using small-molecule monomers, polymer side chains can be grown from the polymer backbone, typically using Controlled Radical Polymerization (CRP) techniques such as Atom Transfer Radical Polymerization (ATRP) and Reversible Addition-Fragmentation Chain Transfer (RAFT) Polymerization. Finally, the grafting through approach allows using macromonomers with a polymerizable unit on one chain end and utilizing different polymerization techniques such as reversible deactivation radical polymerization (RDRP; i.e., ATRP or RAFT) or ring-opening metathesis polymerization (ROMP). While RDRP requires commonly used styrenic or (meth)acrylic functional groups, ROMP utilizes norbornene-based polymer chain ends to polymerize macromonomers into BBPs.

The different approaches discussed earlier have given rise to different grafting densities. Generally, the grafting to approach gives the lowest grafting density and the grafting through approach produces the highest grafting density among these three approaches. The difference in the grafting density due to the selection of different grafting approaches stems from the steric hindrance generated between the components (i.e., between polymer backbone-long side chain for grafting to, growing chains on the polymer backbone for grafting from, and growing BBPs-macromonomers for grafting through). To synthesize true BBPs, the grafting density should be high enough that it gives the BBPs rigidity and prevents entanglement. BBPs and bottlebrush gels can be differentiated depending on the macromonomer identity (the side chain plays a central role to determine the final properties of the resulting BBPs), side-chain degree of polymerization (DP), backbone DP, grafting density (distance between each side chain), and crosslinking density (for bottlebrush gels).

Recent developments in the technology of certain intraocular lenses (IOLs) and accommodating or adaptive intraocular lenses (A-IOLs) for use in surgery for treating cataracts have created a need for optically clear, biostable, polymer filling materials having a suitable refractive index (nr) and complex viscosity. Over time, the lens in the eye becomes stiffer and less flexible, making it more difficult for the eye to focus on near objects. This gradual, age-related loss of accommodation is called presbyopia. As people age further, the lens becomes thickened and opaque forming a cataract and causing blurred vision. The standard of care is to have cataract surgery to remove the cataract and replace it with an IOL. The current standard lenses are monofocal lenses which cannot adjust for both near and far sight, leaving patients dependent upon glasses. A-IOLs would allow patients to see clearly over a range of distances without eyeglasses or contact lenses. Various different polymers have been used in lens refilling IOLs and in other types of A-IOLs with mixed results. Many of these materials require solvents or other diluting fluids to arrive at working viscosities. Both Jean Marie Parel, MD (Bascom Palmer) and Steven Koopmans (Pharmacia) attempted to restore accommodation by refilling the capsular bag with a soft polymer (Hao et al, 2010; Koopmans, 2003 and 2006). They both injected in situ polymerizing materials directly into the capsular bag. Both scientists ended their efforts after in vivo animal trials presented significant complications including inflammation of the eye and posterior capsular opacification (PCO). (Koopmans, 2014, Hao 2012) Similarly, Nishi's attempts at developing an endocapsular balloon filled with silicone oil failed when severe posterior capsule opacification occurred (Nishi 1997) The Fluid Vision IOL is a hydrophobic acrylic lens with a hollow optic and two hollow haptics filled with silicone oil. When the ciliary muscles contract, the oil shifts from the haptics into the optic to change the shape of the lens. Although this IOL is still in Phase II clinical trials, problems with the lens include the slow speed at which patients focus and the inconsistent effective lens position. (Young)

A clear, synthetic route to generating optically clear, biostable polymer brushes that have tunable viscosity and optical properties that can be used as a soft, flexible material to be molded into in IOLs and A-IOLs are needed in the art. Such a polymer could be used to create an A-IOL that could be custom-molded for each patient. The A-IOL would remain soft and flexible, like the young, healthy human lens. When the ciliary muscles of the eye contract during accommodation, the flexible lens will change shape such that the power of the lens will increase and allow the patient to focus at near. Once the muscles of accommodation relax, the lens will resume its baseline shape, allowing the patient to see at distance.

Recently, attempts have been made to create bottlebrush polymers for use in IOLs and A-IOLs using RAFT polymerization polydimethylsiloxane-based polymers and copolymers. Unfortunately, known polydimethylsiloxane-based bottlebrush polymers are slightly water soluble and allowing some water to mix with the polymer and a stable emulsion to form. This emulsion scatters visible light, produces an optical haze which renders the bottlebrush polymer unsuitable for optical use. Further, during the RAFT polymerization reaction, the monomers will polymerize at a location at or near the center of the RAFT agent, splitting the RAFT chain transfer agent, with each half of the RAFT chain transfer agent forming an end group for the bottlebrush polymer formed. The presence of thiocarbonyl or similar end groups from the RAFT chain transfer agent, have been found to give these polymers as yellow tint which is undesirable for optical applications.

Custom-made IOLs do not exist. Before cataract surgery, three primary measurements of the eye are taken and inserted into a formula to determine the correct IOL power for each eye. These measurements are the axial length of the eye, the corneal curvature (keratometry), and the anterior chamber depth. Currently, these three measurements are used only to determine the IOL power for each patient's eye. However, if lenses could be molded and custom-made for each eye, these measurements would be considered alongside other measurements of a patient's eye in order to mold a unique accommodating intraocular lens so that each eye could see optimally.

Since custom-made IOLs do not exist, there are certain ocular problems that cannot be corrected by current IOLs. For example, toric IOLs can only correct “regular” astigmatism. Regular astigmatism is defined as a symmetrical steepening along a specific axis, bisecting in the center of the cornea in the configuration of a bowtie. In contrast, irregular astigmatism is uneven, or curved in multiple directions. Irregular astigmatism, often referred to as a Complex Cornea, is much more difficult to treat and cannot be treated with current IOLs. Similarly, while lower order aberrations of the cornea (such as sphere and cylinder) can be corrected with glasses or contact lenses, many higher order aberrations (HOA) of the cornea (such as coma and trefoil) cannot be corrected. More than 60 different HOAs have been identified, and many cannot be corrected with glasses or contact lenses.

Advanced scans of the front of the eye, such as corneal topography, provide a map of the shape and curvature of the cornea. Using corneal topography, aberrometry (wavefront technology), and other imaging and diagnostic tools, one could create a computer model of the ideal shape of an accommodative IOL for each patient. Using the computer model, a mold could be made, and the material could be molded inside of it to create custom-made, accommodating IOL to correct for each specific eye's needs. In addition to correcting for corneal aberrations, a custom-made accommodating IOL could be molded to fit perfectly into each patient's capsular bag. Ultrasound or MRI imaging of each patient's lens could be used to determine details such as lens equatorial diameter, volume, and surface area. These variables could also be plugged into a computer model of the eye to help determine the ideal shape of an A IOL for each patient.

What is needed in the art for a solvent-free, optically clear bottlebrush polymer or copolymer suitable for use in intraocular lenses (IOLs) and accommodating or adaptive intraocular lenses (A-IOLs) for use in surgery for treating cataracts and other optical maladies.

### SUMMARY OF THE INVENTION

In one or more embodiments, the present invention provides an optically clear bottlebrush copolymer suitable for use in intraocular lenses (IOLs) and accommodating or adaptive intraocular lenses (A-IOLs) for use in surgery for treating cataracts and other optical maladies. The bottlebrush copolymers of the present invention are optically clear and avoid the haze and/or yellow tint common to these types of polymers. As set forth above, known polysiloxane-based bottlebrush copolymers are slightly water soluble and allowing some water to enter the polymer and an emulsion to form. This emulsion produces an optical haze rendering the polymer unsuitable for optical use. In addition, these bottlebrush copolymers are preferably formed using reversible addition fragmentation chain-transfer (RAFT) polymerization and these reactions will generally form a bottlebrush copolymer having yellow thiocarbonyl end groups, giving the polymer a yellow tint.

The optically clear bottlebrush copolymers of the present invention avoid these optical haze and/or yellow tint problems. The bottlebrush copolymers of the present invention avoid the optical haze problems by fluorinating some of the polydimethylsiloxane chains to prevent water from entering the polymer. In various embodiments, the yellow tint problem is avoided by means of a second reaction that removes the yellow thiocarbonyl end groups and adding one or more terminal 2-cyano isobutane (—C(CH₃)₂CN) groups. In various embodiments, the optically clear bottlebrush copolymers of the present invention comprises one or more monomethacryloxy terminated polydimethylsiloxane (PDMS-MA) units, and or more monomethacryloxy terminated fluorinated siloxane (Fluoro-MA) units, and 2-cyano isobutane end groups. In some other embodiments, the optically clear bottlebrush copolymers of the present invention comprises one or more monomethacryloxy terminated polydimethylsiloxane (PDMS-MA) units, one or more monomethacryloxy terminated fluorinated siloxane (Fluoro-MA) units, UV blocking dye units and has 2-cyano isobutane end groups. In addition to being optically clear, the viscosity and other properties of these bottlebrush copolymers are controllable making them suitable for a variety of applications. In various embodiments, the optically clear bottlebrush copolymers of the present invention will have complex viscosity (η) at 37° C. that make them are suitable for use as filler materials in intraocular lenses (IOLs) and accommodating or adaptive intraocular lenses (A-IOLs) for use in surgery for treating cataracts and other optical maladies.

In a first aspect, the present invention is directed to an optically clear bottlebrush copolymer comprising one or more monomethacryloxy terminated polydimethylsiloxane (PDMS-MA) units and one or more monomethacryloxy terminated fluorinated siloxane (Fluoro-MA) units. In one or more embodiments, the optically clear bottlebrush copolymer of the present invention includes any one or more of the above referenced embodiments of the first aspect of the present invention further comprising one or more terminal 2-cyano isobutane (—C(CH₃)₂CN) groups.

In some embodiments, the PDMS-MA units are the residue of monomers having a formula selected from:

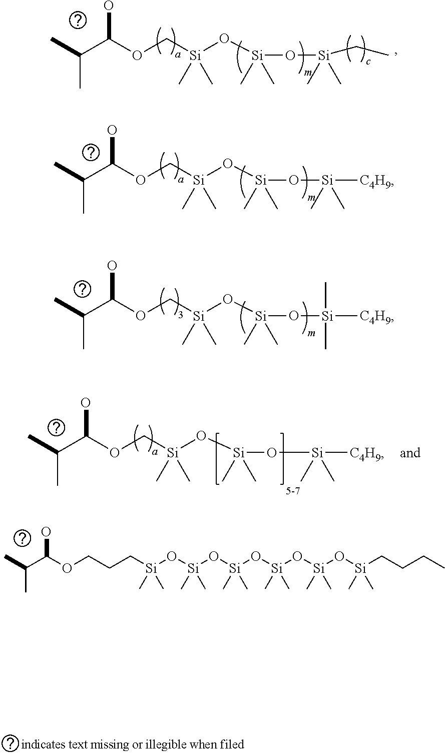

where a is an integer from about 1 to about 6; c is an integer from 1 to 5; and m is an integer from about 2 to about 20. In some of these embodiments, the PDMS-MA units comprise the residue of monomethacryloxypropyl-terminated polydimethylsiloxane, asymmetric monomers.

In one or more embodiments, the optically clear bottlebrush copolymer of the present invention includes any one or more of the above referenced embodiments of the first aspect of the present invention wherein the Fluoro-MA units are the residue of monomers having a formula selected from:

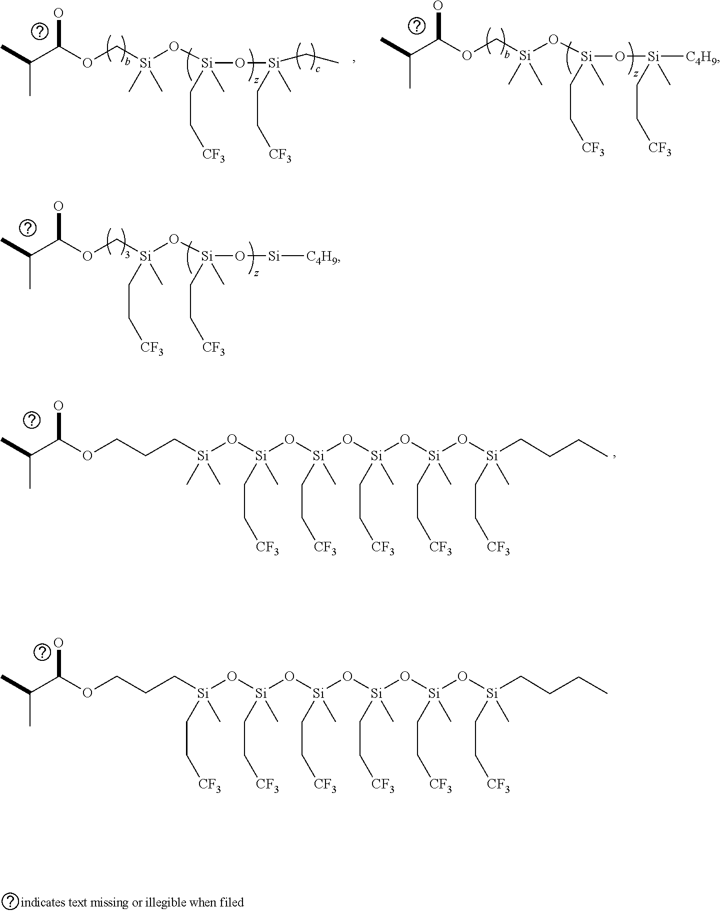

where b is an integer from about 1 to about 6; c is an integer from 1 to 5; and z is an integer from about 2 to about 20. In one or more embodiments, the optically clear bottlebrush copolymer of the present invention includes any one or more of the above referenced embodiments of the first aspect of the present invention wherein the Fluoro-MA units are the residue of monomethacryloxypropyl-terminated poly(3,3,3-trifluoropropyl)methylsiloxane, asymmetric monomers.

In one or more embodiments, the optically clear bottlebrush copolymer of the present invention includes any one or more of the above referenced embodiments of the first aspect of the present invention containing from about 1 mol. % to about 99 mol. %, preferably from about 50 mol. % to about 99 mol. %, preferably from about 70 mol. % to about 99 mol. %, and more preferably from about 80 mol. % to about 90 mol. % Fluoro-MA units. In one or more embodiments, the optically clear bottlebrush copolymer of the present invention includes any one or more of the above referenced embodiments of the first aspect of the present invention containing about 90 mol. % Fluoro-MA units.

In one or more embodiments, the optically clear bottlebrush copolymer of the present invention includes any one or more of the above referenced embodiments of the first aspect of the present invention comprising a random copolymer of monomethacryloxypropyl-terminated polydimethylsiloxane, asymmetric and monomethacryloxypropyl-terminated poly(3,3,3-trifluoropropyl)methylsiloxane, asymmetric.

In various embodiments, the optically clear bottlebrush copolymer of the present invention will have at least one and preferably two, 2-cyano isobutane (—C(CH₃)₂CN) end groups. In all of these embodiments, however, the yellow thiocarbonyl end groups left over from the RAFT polymerization are removed to produce the optically clear bottlebrush copolymer.

In one or more embodiments, the optically clear bottlebrush copolymer of the present invention includes any one or more of the above referenced embodiments of the first aspect of the present invention having a degree of polymerization of from about 10 to about 200, preferably from about 20 to about 100, and more preferably from about 50 to about 80. In one or more embodiments, the optically clear bottlebrush copolymer of the present invention includes any one or more of the above referenced embodiments of the first aspect of the present invention having a degree of polymerization of 50.

In one or more embodiments, the optically clear bottlebrush copolymer of the present invention includes any one or more of the above referenced embodiments of the first aspect of the present invention having a complex viscosity (η) at 37° C. of from about 5 Ps·s to about 15 Ps·s, preferably from about 5 Ps·s to about 15 Ps·s, and more preferably from about 9 Ps·s to about 15 Ps·s, as measured by a rheometer. In one or more embodiments, the optically clear bottlebrush copolymer of the present invention includes any one or more of the above referenced embodiments of the first aspect of the present invention having a complex viscosity (η) at 37° C. of from 14 Ps·s to 15 Ps·s, as measured by a rheometer.

In one or more embodiments, the optically clear bottlebrush copolymer of the present invention includes any one or more of the above referenced embodiments of the first aspect of the present invention having the formula selected from:

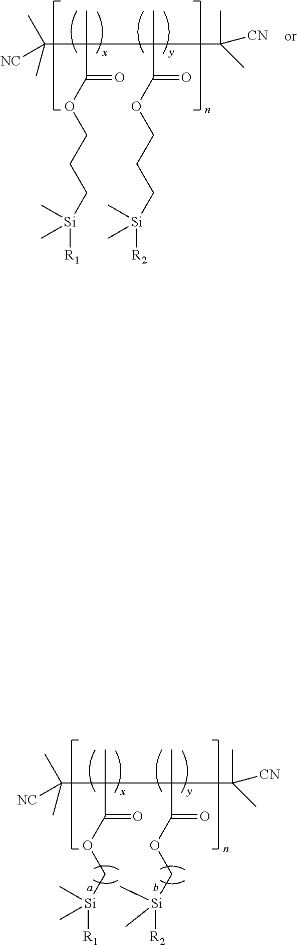

where R₁ is a siloxane; R₂ is a fluorinated siloxane; x is a mole fraction from about 0.99 to about 0.01; y is a mole fraction from about 0.01 to about 0.99; n is the degree of polymerization from about 10 to about 200; a is an integer from about 1 to about 6; b is an integer from about 1 to about 6; and x+y=1.00. In one or more embodiments, the optically clear bottlebrush copolymer of the present invention includes any one or more of the above referenced embodiments of the first aspect of the present invention having a formula selected from:

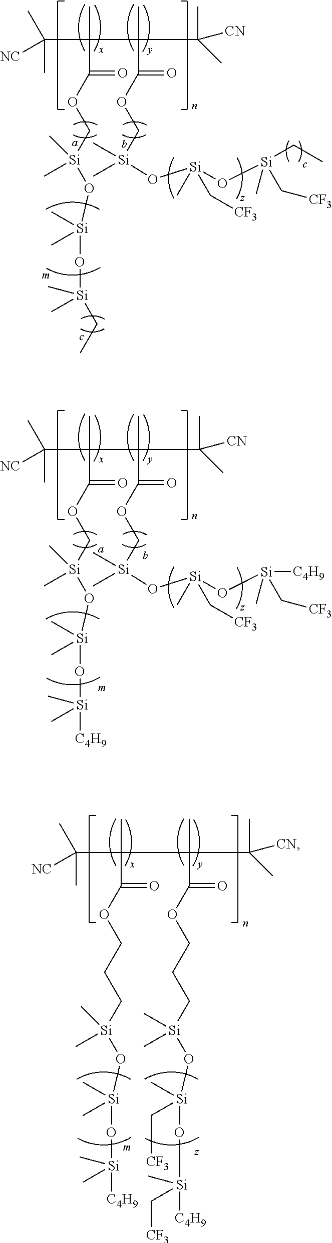

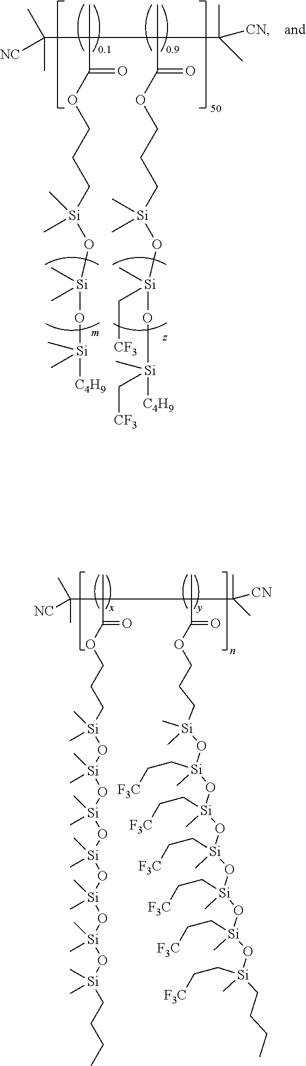

where x is a mole fraction from about 0.99 to about 0.01; y is a mole fraction from about 0.01 to about 0.99; n is the degree of polymerization from about 10 to about 200; a is an integer from about 1 to about 6; b is an integer from about 1 to about 6; c is an integer from 1 to 6; m is an integer from about 2 to about 20; and z is an integer from about 2 to about 20; and x+y=1.00. In some other embodiments, m is an integer from about 4 to about 8 and z is an integer from about 3 to about 8. Here, as well as elsewhere in the specification and claims, individual range values can be combined to form additional non-disclosed ranges.

In a second aspect, the present invention is directed to an optically clear UV blocking bottlebrush copolymer comprising the optically clear UV blocking bottlebrush copolymer described above further comprising one or more UV blocking dye units. In some of these embodiments, the UV blocking dye units are the residue of 2-[3-(2H-Benzotriazol-2-yl)-4-hydro-xyphenyl]ethyl methacrylate (BTAMA) monomers.

In one or more embodiments, the optically clear UV blocking bottlebrush copolymer of the present invention includes any one or more of the above referenced embodiments of the second aspect of the present invention containing from about 0.1 mol. % to about 5 mol. %, preferably from about 0.1 mol. % to about 3 mol. %, and more preferably from about 0.1 mol. % to about 1 mol. % BTAMA units. In one or more embodiments, the optically clear UV blocking bottlebrush copolymer of the present invention includes any one or more of the above referenced embodiments of the second aspect of the present invention comprising a random copolymer of monomethacryloxypropyl-terminated polydimethylsiloxane, asymmetric, monomethacryloxypropyl-terminated poly(3,3,3-trifluoropropyl)methylsiloxane, asymmetric, and 2-[3-(2H-Benzotriazol-2-yl)-4-hydro-xyphenyl]ethyl methacrylate.

In one or more embodiments, the optically clear UV blocking bottlebrush copolymer of the present invention includes any one or more of the above referenced embodiments of the second aspect of the present invention having the formula:

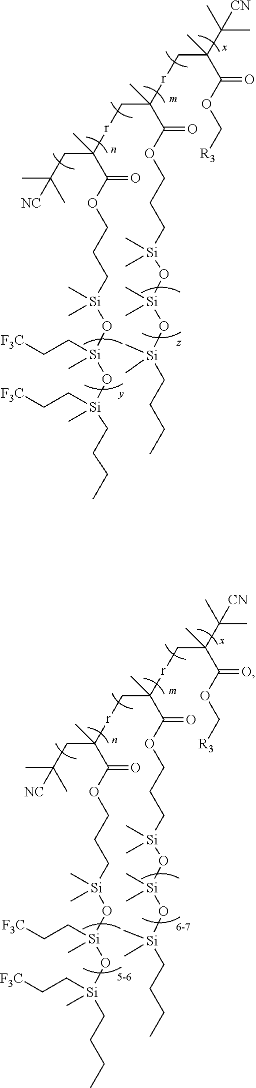

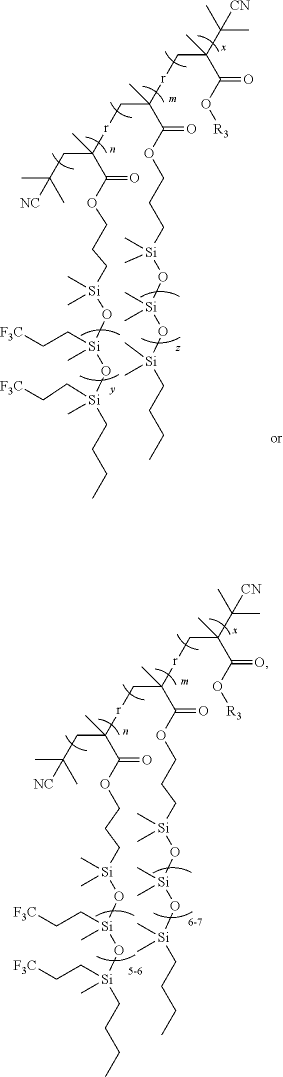

wherein n, m, and x are mole fractions where n+m+x=1, y is an integer from about 2 to about 20; z is an integer from about 2 to about 20; R₃ is a UV blocking group and r indicates random polymerization. Here, as well as elsewhere in the specification and claims, individual range values can be combined to form additional non-disclosed ranges.

In one or more embodiments, the optically clear UV blocking bottlebrush copolymer of the present invention includes any one or more of the above referenced embodiments of the second aspect of the present invention having the formula:

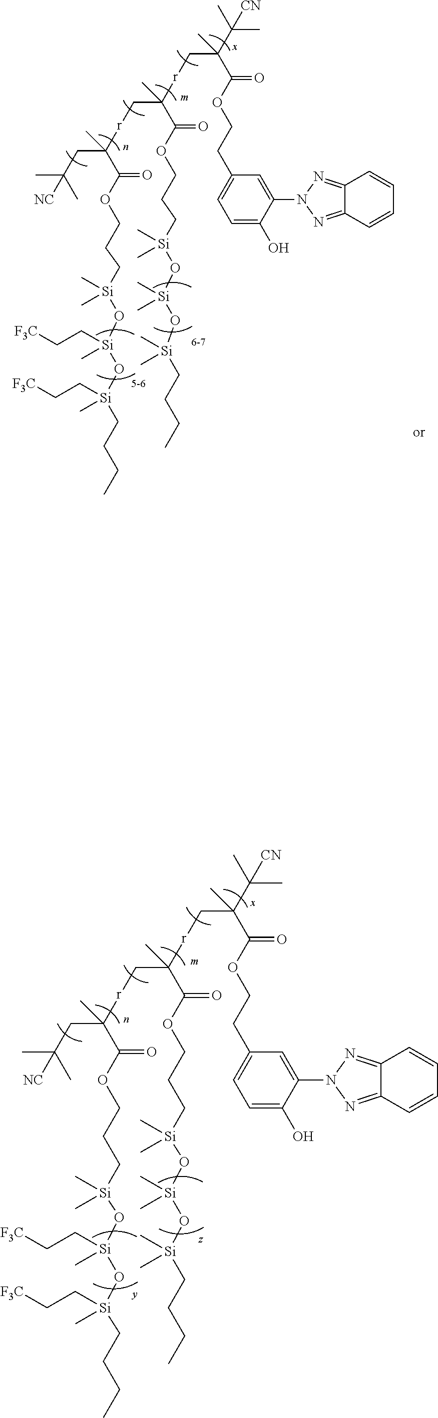

where n, m, and x are mole fractions (n+m+x=1); y is an integer from about 2 to about 20; z is an integer from about 2 to about 20; and r indicates random polymerization.

In a third aspect, the present invention is directed to a method for forming an optically clear bottlebrush copolymer comprising: combining one or more monomethacryloxypropyl-terminated polydimethylsiloxane, asymmetric (PDMS-MA), one or more monomethacryloxypropyl-terminated poly(3,3,3-trifluoropropyl)methylsiloxane, asymmetric (Fluoro-MA), a chain transfer agent suitable for RAFT polymerization reactions; an initiator, and an anhydrous solvent in a sealed reaction vessel; sparging the reaction mixture with an inert gas and heating it for from about 12 hours to about 24 hours; quenching the reaction by opening the reaction vessel to the air and allowing it to cool; washing the resulting mixture with a polar organic solvent to produce a yellow bottlebrush copolymer intermediate having yellow thiocarbonyl end groups; dissolving the yellow bottlebrush copolymer intermediate and an initiator in a suitable anhydrous solvent in a sealed reaction vessel; sparging the reaction mixture in an inert gas and heating it for from about 2 hours to about 6 hours to remove said yellow thiocarbonyl end groups; and concentrating the reaction mixture to remove the anhydrous solvent and washing it to produce an optically clear bottlebrush copolymer.

In one or more embodiments, the method of the present invention includes any one or more of the above referenced embodiments of the third aspect of the present invention wherein each one of the chain transfer agent suitable for reversible addition fragmentation chain-transfer (RAFT) polymerization reactions is selected from the group consisting of dithiobenzoates, trithiocarbonates, 2-cyano-2-propyl dodecyl trithiocarbonate, 4-cyano-4-[(dodecylsulfanylthiocarbonyl)sulfanyl] pentanoic acid, 4-cyano-4-(thiobenzoylthio) pentanoic acid; 4-(benzodithioyl)-4-cyanopentanoic acid, 2-cyanopropan-2-yl benzodithioate, and combinations thereof.

In one or more embodiments, the method of the present invention includes any one or more of the above referenced embodiments of the third aspect of the present invention wherein each one of the chain transfer agents has a formula selected from the group consisting of:

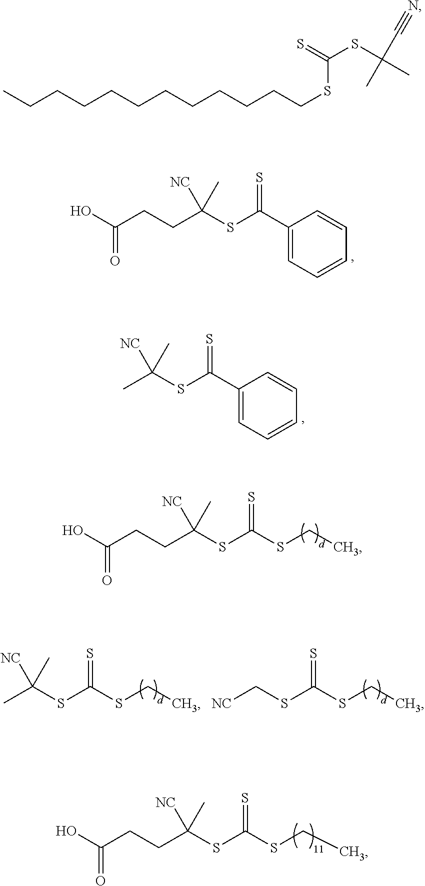

where d is an integer from about 3 to about 11. In some of these embodiments, the chain transfer agent has the formula:

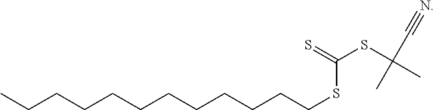 [SMILES: CCCCCCCCCCCCSC(=S)SC(C)(C)C#N]

In one or more embodiments, the method of the present invention includes any one or more of the above referenced embodiments of the third aspect of the present invention wherein the each one of the initiators is selected from azo compounds, organic peroxides, inorganic peroxides, or combinations thereof. In one or more embodiments, the method of the present invention includes any one or more of the above referenced embodiments of the third aspect of the present invention wherein the initiator is 2,2′-azobis(2-methylpropionitrile) (AIBN). In one or more embodiments, the method of the present invention includes any one or more of the above referenced embodiments of the third aspect of the present invention wherein the anhydrous solvent in at least one is anhydrous toluene.

In one or more embodiments, the method of the present invention includes any one or more of the above referenced embodiments of the third aspect of the present invention wherein the step of washing the resulting mixture with a polar organic solvent comprises: adding an excess of methanol to the reaction mixture and vortexing; cooling the mixture in an ice bath for from about 30 seconds to about 30 min to form a biphasic system having a methanol supernatant; and decanting off the methanol supernatant to leave the yellow bottlebrush copolymer intermediate having yellow thiocarbonyl end groups.

In one or more embodiments, the method of the present invention includes any one or more of the above referenced embodiments of the third aspect of the present invention wherein steps of washing, cooling and decanting are repeated from 2 to 4 times before moving on to the next step.

In one or more embodiments, the method of the present invention includes any one or more of the above referenced embodiments of the third aspect of the present invention wherein the step of washing the reaction mixture comprises: adding an excess of methanol to the reaction mixture and vortexing; cooling the mixture in an ice bath for from about 30 seconds to about 30 min to form a biphasic system having a methanol supernatant; decanting off the methanol supernatant to leave the optically clear bottlebrush copolymer; dissolving the optically clear bottlebrush copolymer in a suitable solvent and passing it through a 2 μm PTFE filter; concentrating the resulting filtered polymer to remove any remaining solvent; and drying the polymer under vacuum for from 6 to 18 hours to produce the optically clear bottlebrush copolymer. In one or more embodiments, the method of the present invention includes any one or more of the above referenced embodiments of the third aspect of the present invention wherein the steps of washing, cooling and decanting are repeated from 2 to 4 times to produce the optically clear bottlebrush copolymer.

In one or more embodiments, the method of the present invention includes any one or more of the above referenced embodiments of the third aspect of the present invention wherein the step of combining further comprises adding a UV blocking dye methacrylate monomer to said sealed reaction vessel. In one or more embodiments, the method of the present invention includes any one or more of the above referenced embodiments of the third aspect of the present invention wherein said UV blocking dye monomer is 2-[3-(2H-Benzotriazol-2-yl)-4-hydro-xyphenyl]ethyl methacrylate (BTAMA) monomer.

### BRIEF DESCRIPTION OF THE DRA WINGS

For a more complete understanding of the features and advantages of the present invention, reference is now made to the detailed description of the invention along with the accompanying figures in which:

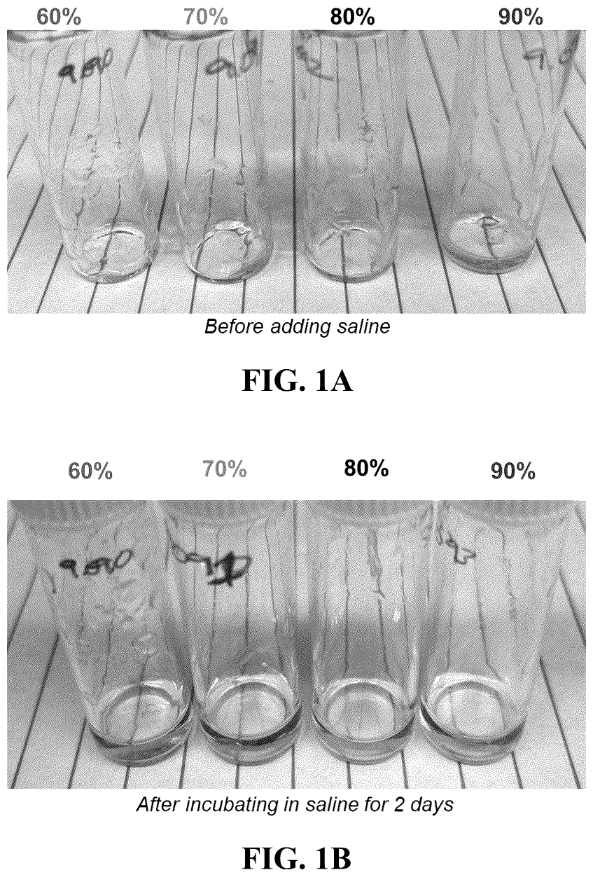

FIGS. 1A-B are images of the optically clear bottlebrush copolymers of the present invention taken before (FIG. 1A) and after (FIG. 1A) incubation in a saline solution for 2 days;

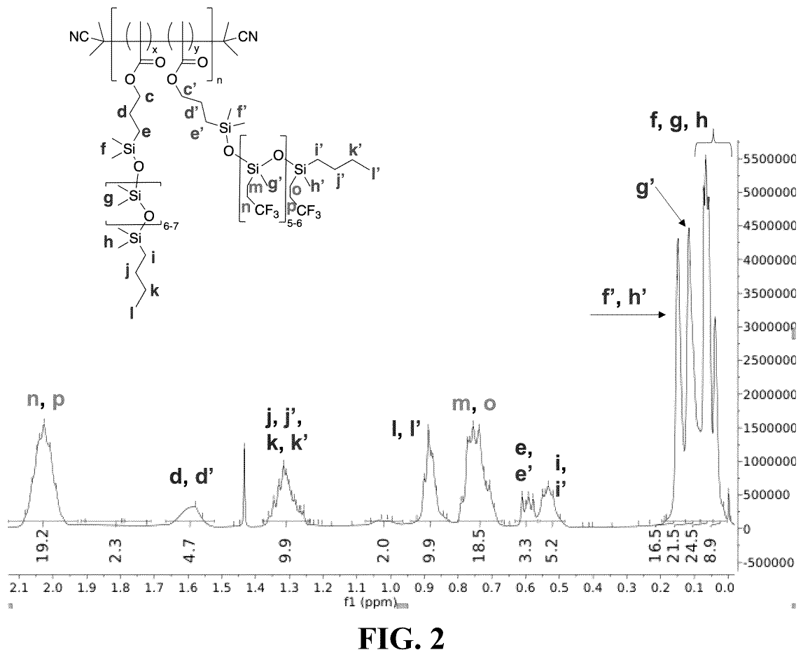

FIG. 2 is an exemplary ¹H NMR with proton assignments for the copolymer 60F-50;

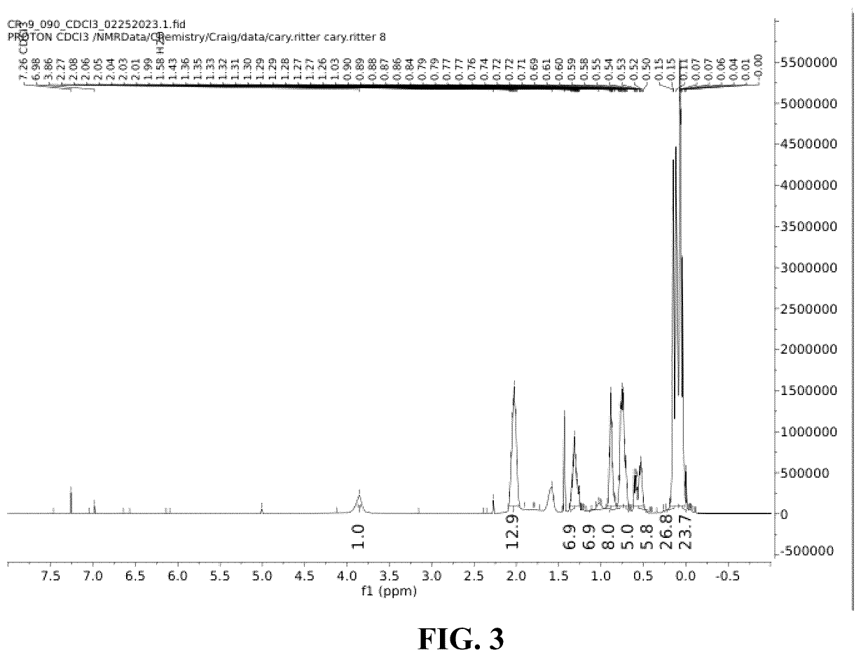

FIG. 3 is an ¹H NMR spectra of 60F-50 (500 MHz, CDCl₃);

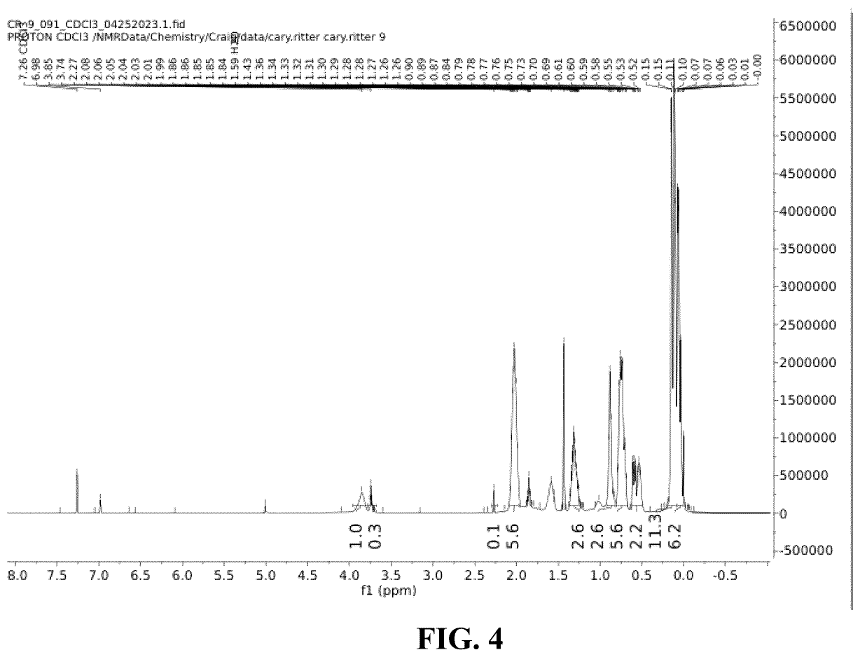

FIG. 4 is an ¹H NMR spectra of 70F-50 (500 MHz, CDCl₃);

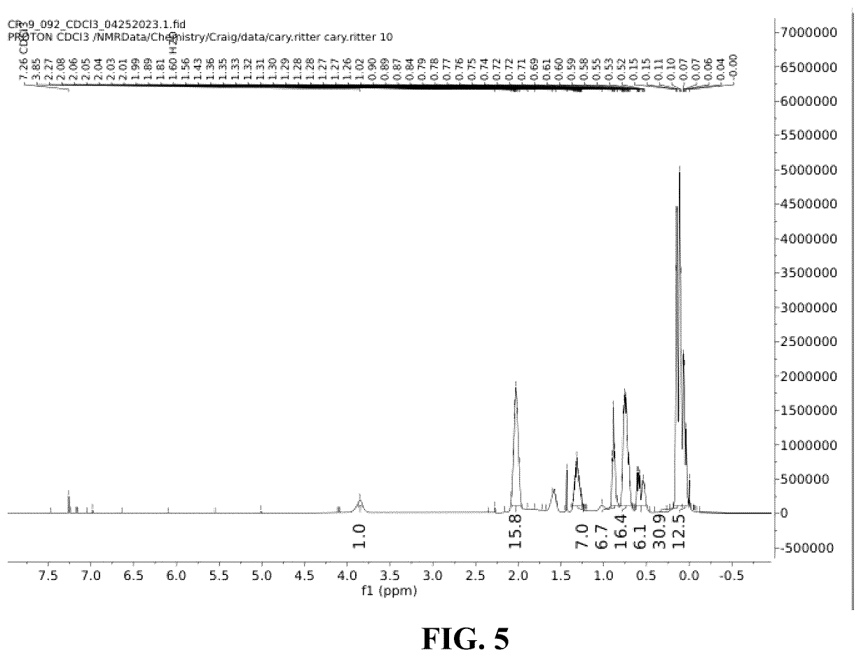

FIG. 5 is an ¹H NMR spectra of 80F-50 (500 MHz, CDCl₃);

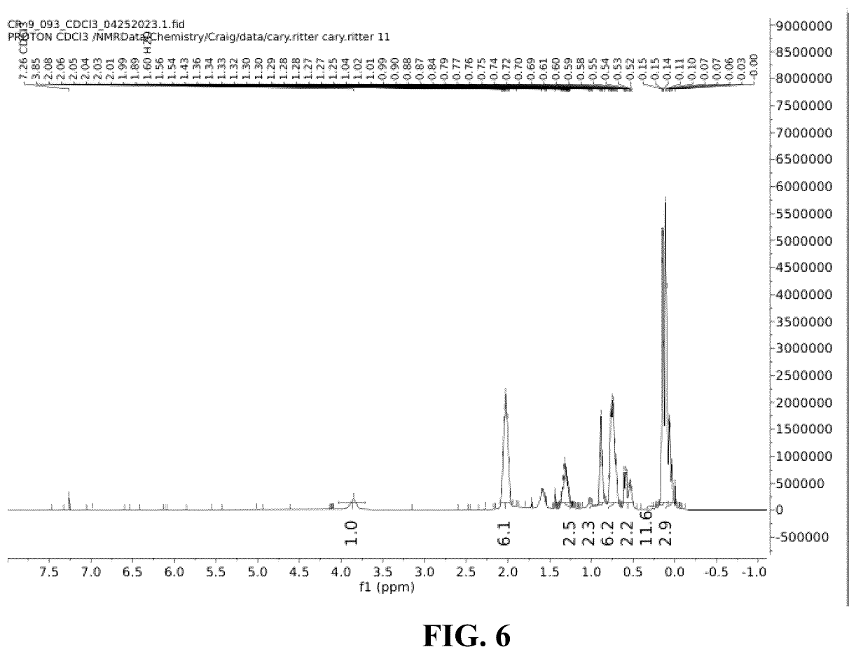

FIG. 6 is an ¹H NMR spectra of 90F-50 (500 MHz, CDCl₃);

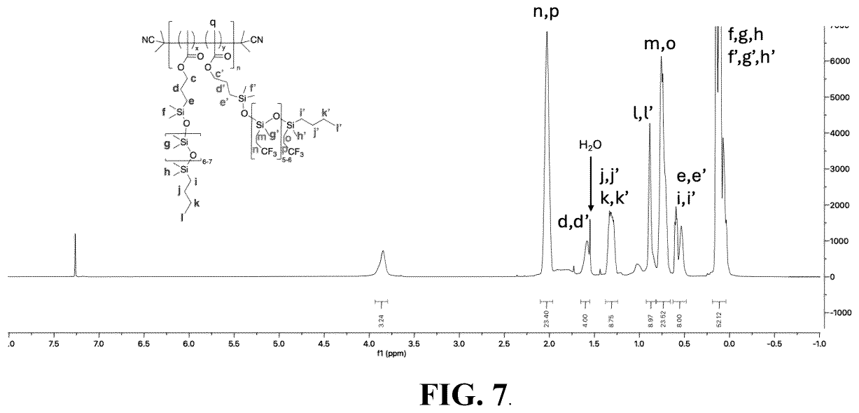

FIG. 7 is a ¹H NMR of 90 mol. % fluorinated siloxane bottlebrush in CDCl₃;

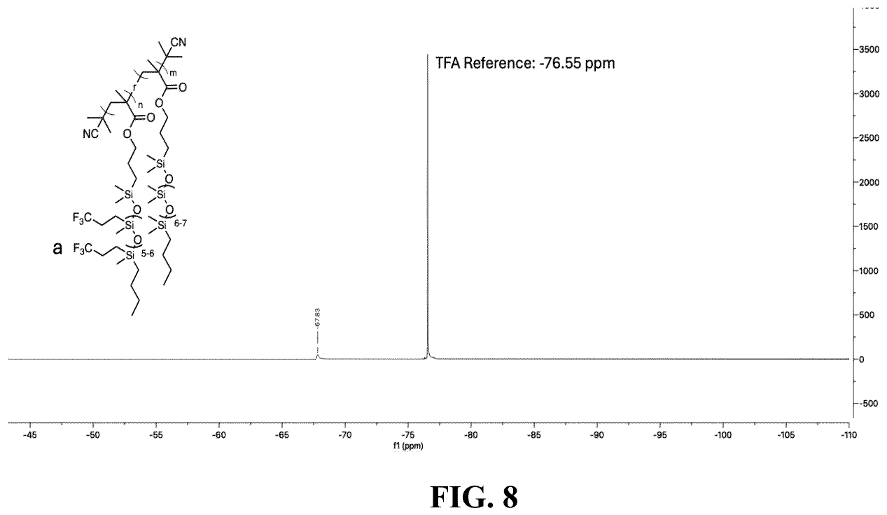

FIG. 8 is a 1° F. NMR of 90 mol. % fluorinated siloxane bottlebrushes in CDCl₃;

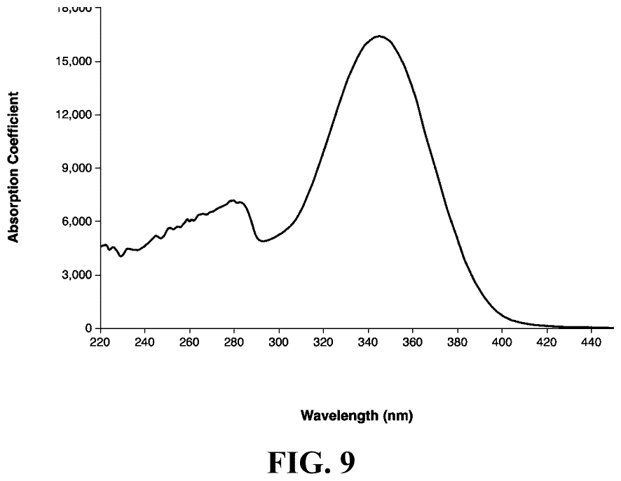

FIG. 9 is a chromatophore trace for a 3-Butyl-6-methoxy-7-hydroxy-4H-chromen-4-one UV blocking monomer.

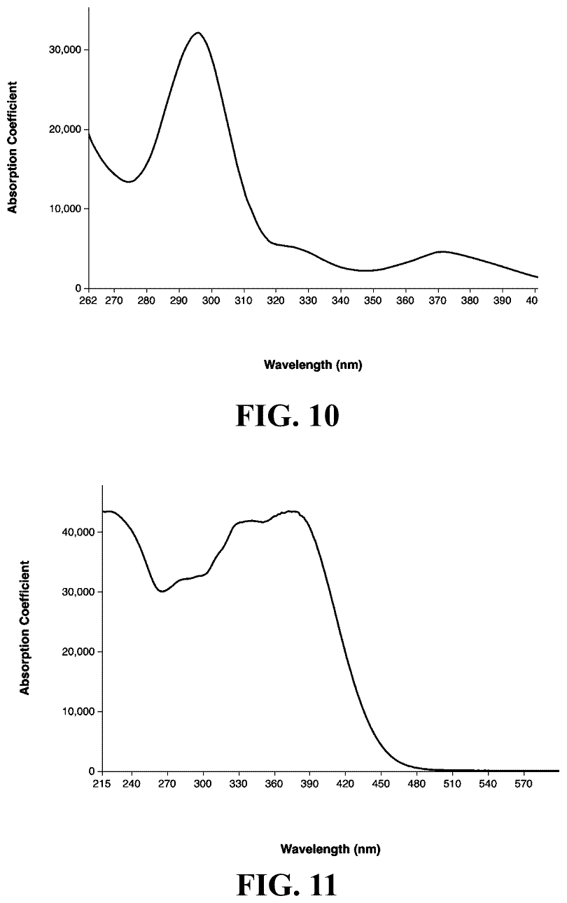

FIG. 10 is a chromatophore trace for a Khellol UV blocking monomer.

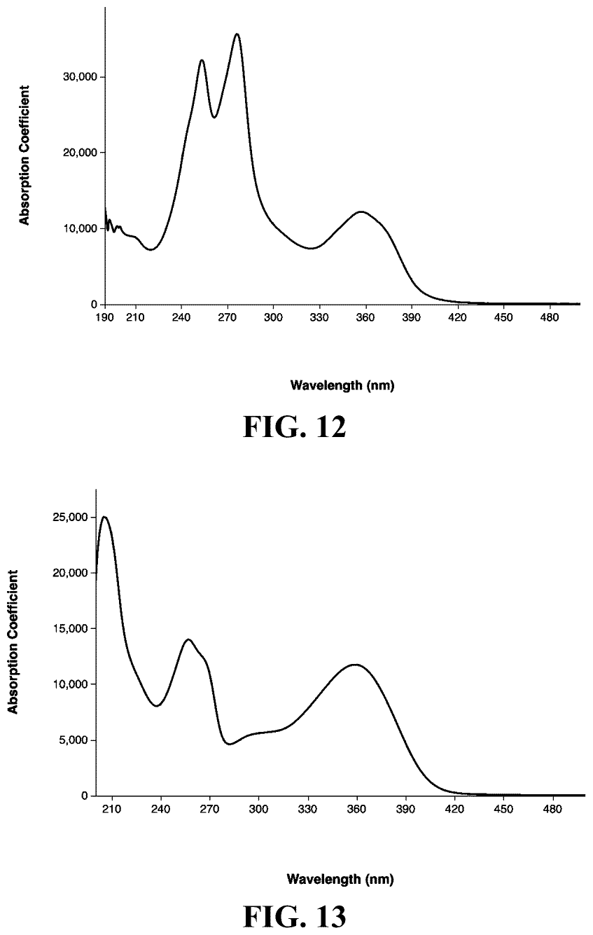

FIG. 11 is a chromatophore trace for an all trans-Retinal UV blocking monomer.

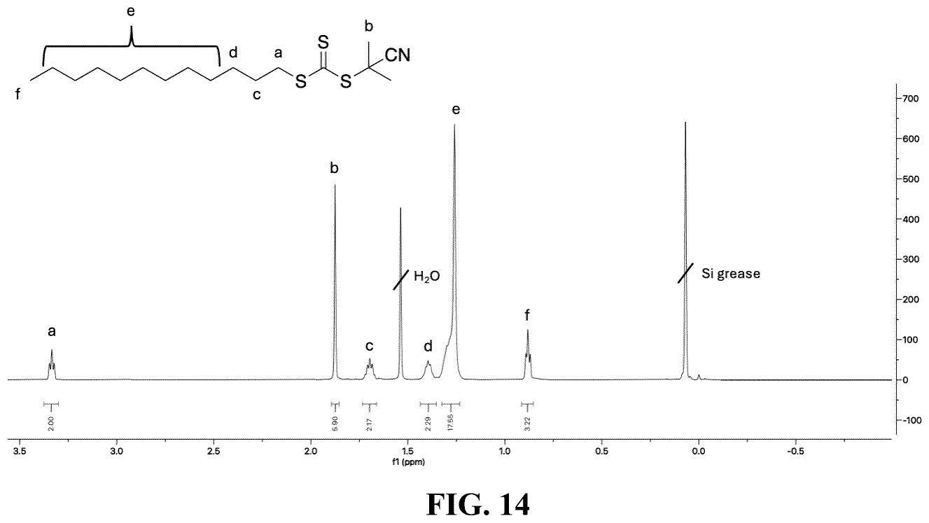

FIG. 12 is a chromatophore trace for an Ellagic Acid Dihydrate UV blocking monomer.

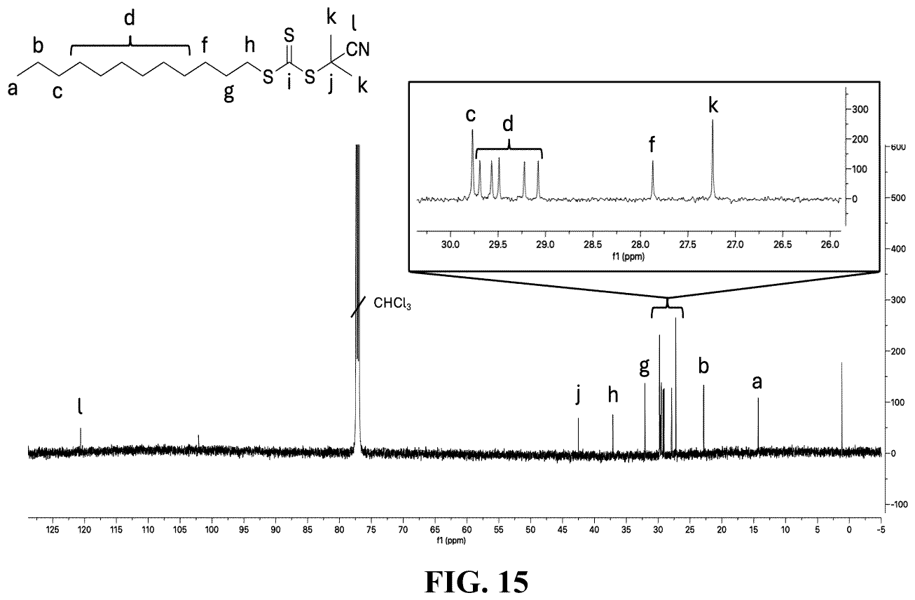

FIG. 13 is a chromatophore trace for a Rutin trihydrate UV blocking monomer.

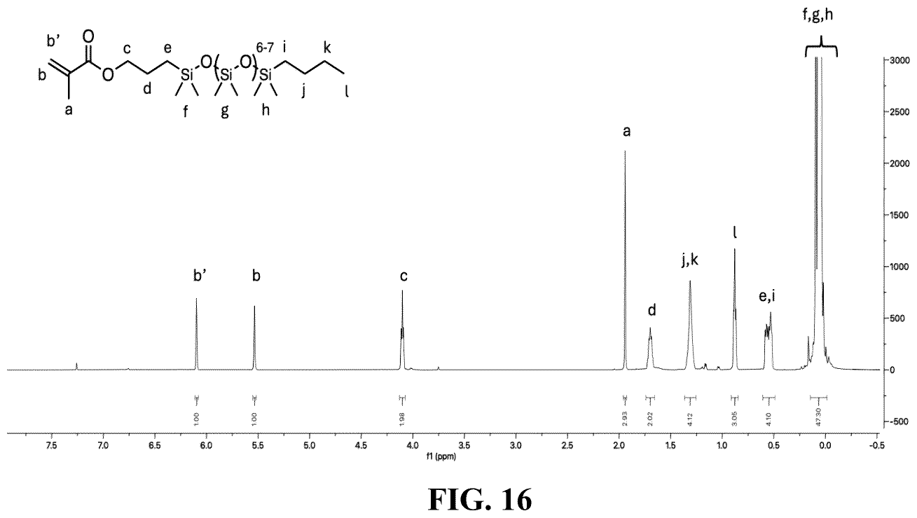

FIG. 14 is a ¹H NMR of 2-cyano-2-propyl dodecyl trithiocarbonate RAFT CTA in CDCl₃;

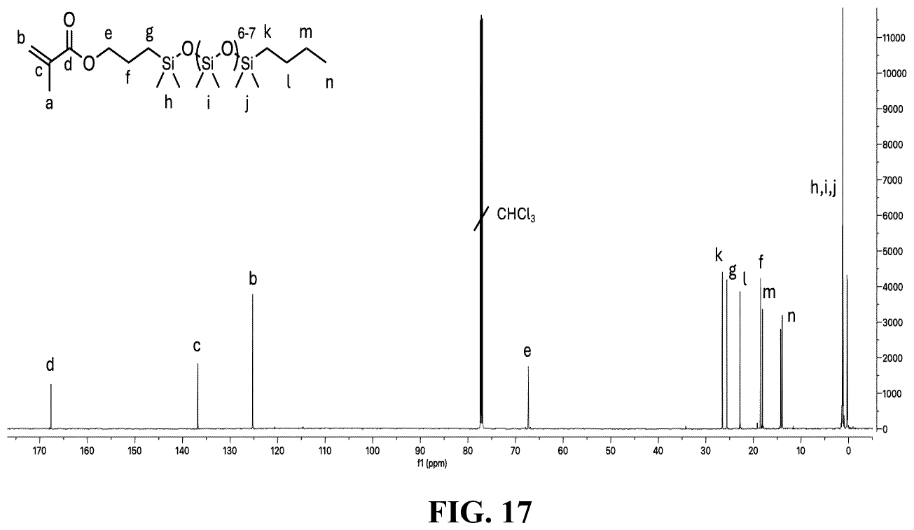

FIG. 15 is a ¹³C NMR of 2-cyano-2-propyl dodecyl trithiocarbonate RAFT CTA in CDCl₃;

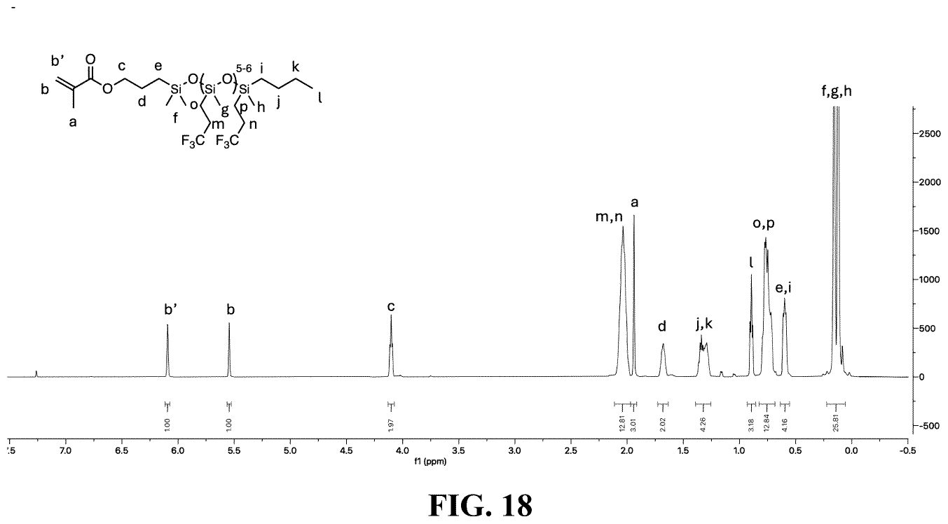

FIG. 16 is a ¹H NMR of monomethacryloxypropyl-terminated polydimethylsiloxane, asymmetric (PDMS-MA) monomer in CDCl₃;

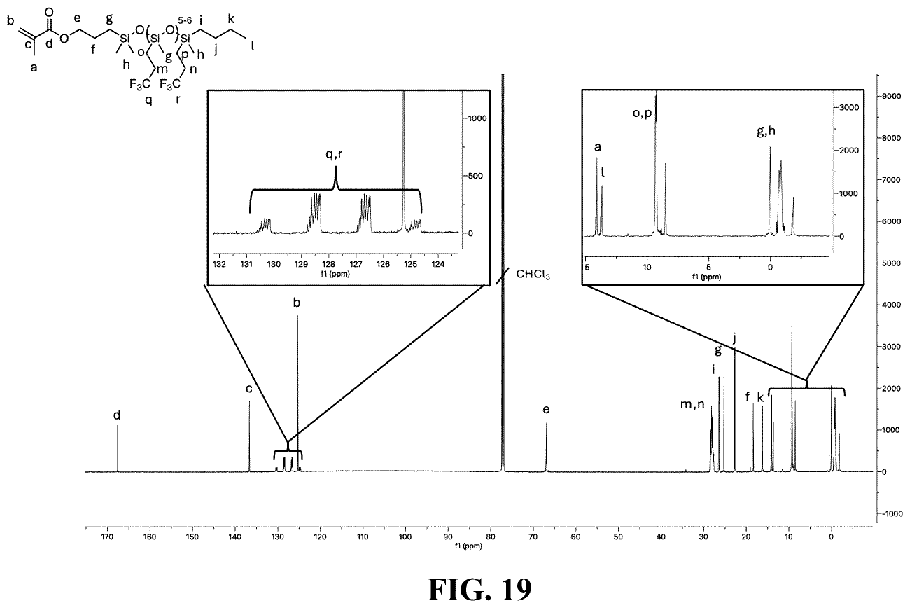

FIG. 17 is a ¹³C NMR of monomethacryloxypropyl-terminated polydimethylsiloxane, asymmetric (PDMS-MA) monomer in CDCl₃;

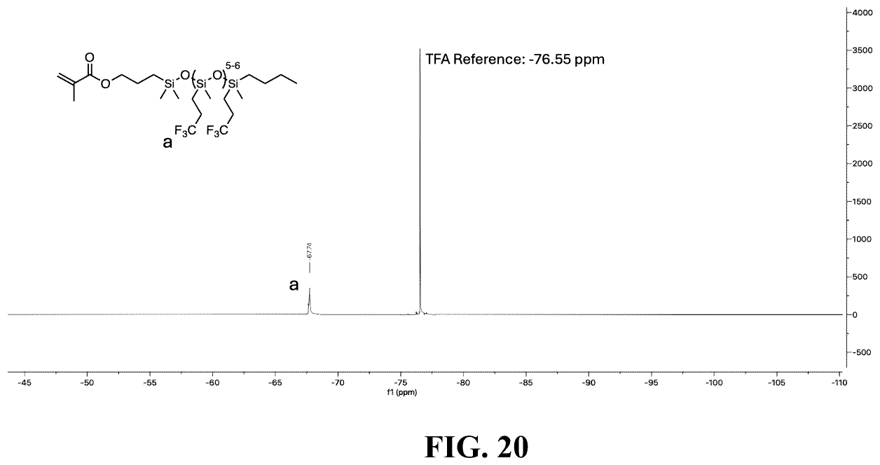

FIG. 18 is a ¹H NMR of monomethacryloxypropyl-terminated poly(3,3,3-trifluoropropylmethylsiloxane) (PTFPMS) monomer in CDCl₃;

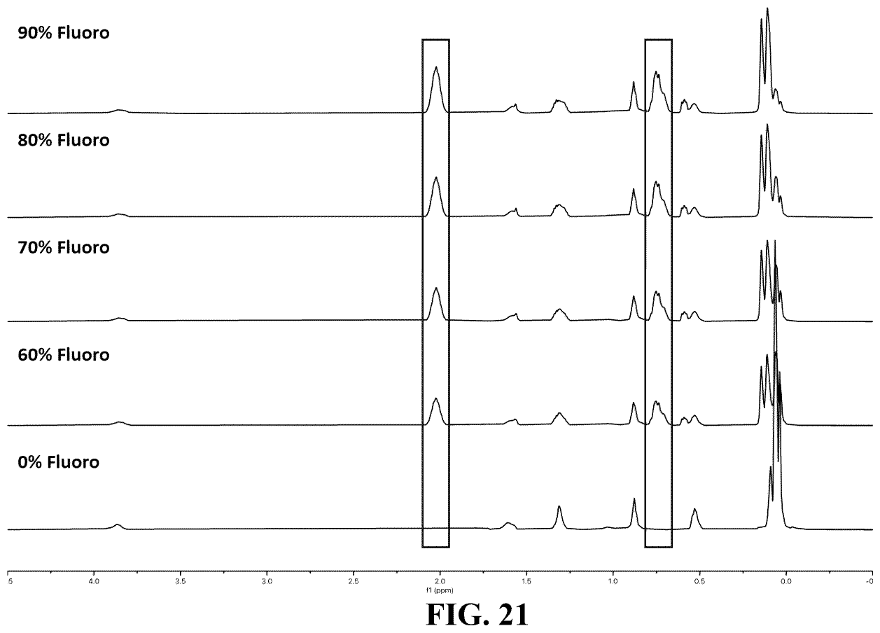

FIG. 19 is a ¹³C NMR of monomethacryloxypropyl-terminated poly(3,3,3-trifluoropropylmethylsiloxane) (PTFPMS) monomer in CDCl₃;

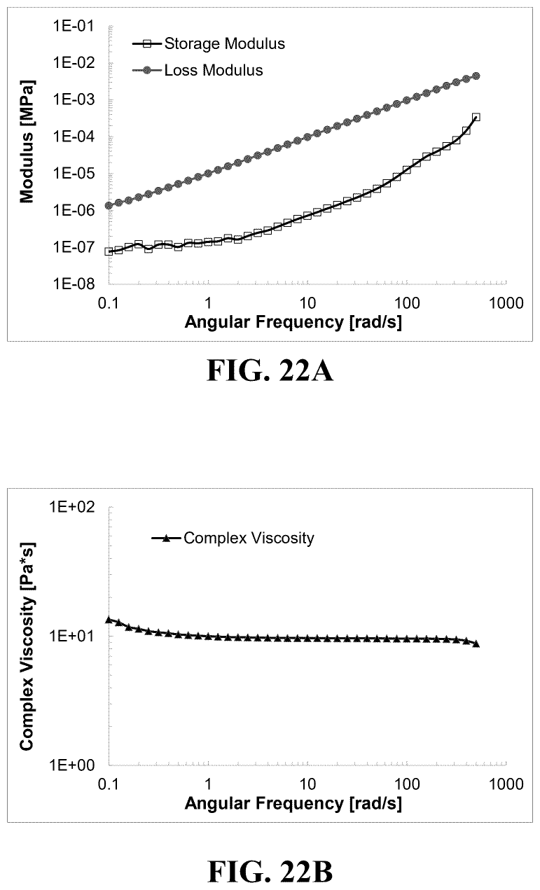

FIG. 20 is a ¹⁹F NMR of monomethacryloxypropyl-terminated poly(3,3,3-trifluoropropylmethylsiloxane) (PTFPMS) monomer in CDCl₃;

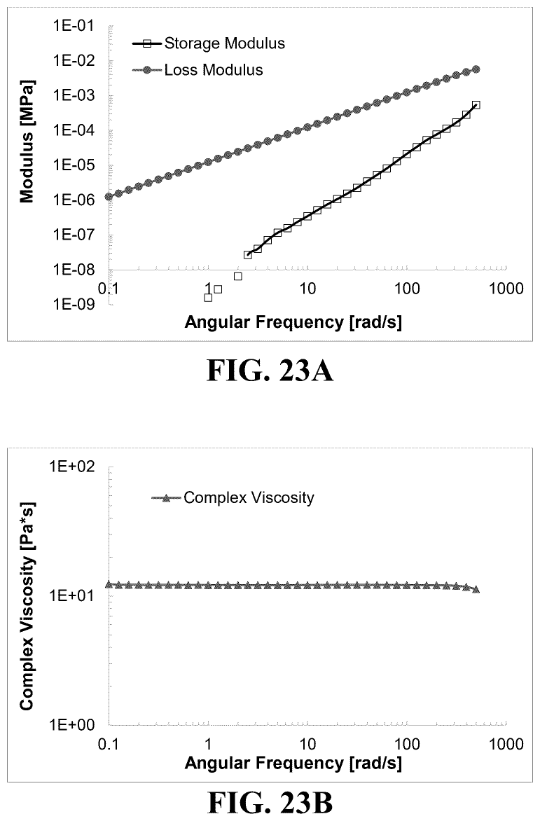

FIG. 21 is a graphic comparison of ¹H NMR spectra for bottlebrush copolymers according to embodiments of the present invention having 0 mol. %, 60 mol. %, 70 mol. %, 80 mol. %, and 90 mol. % Flouro-MA units.

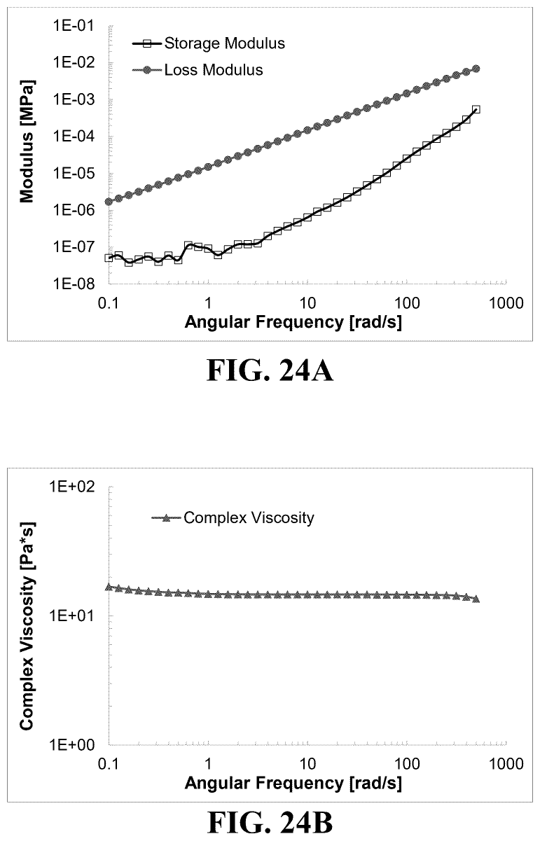

FIG. 22 are graphs of a rheology frequency sweep of 60F-50 at 37° C. showing storage modulus and loss modulus (FIG. 22A) and complex viscosity (FIG. 22B);

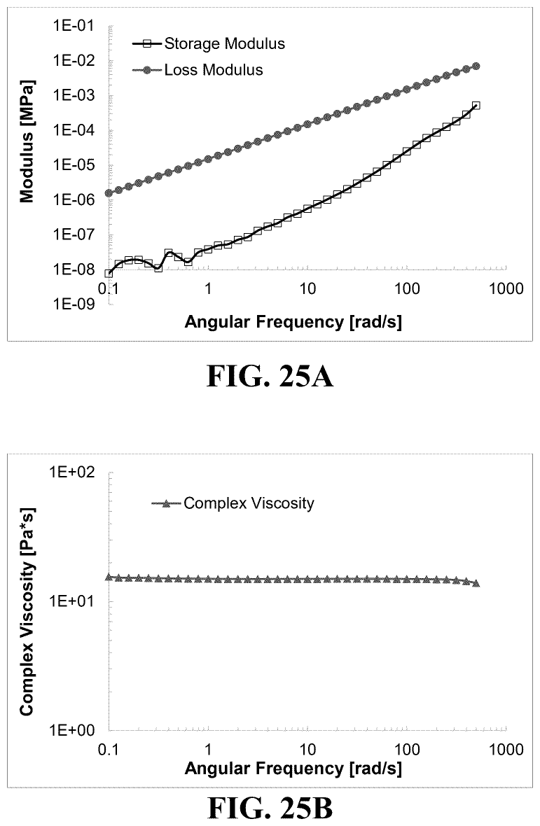

FIGS. 23A-B are graphs of a rheology frequency sweep of 70F-50 at 37° C. showing storage modulus and loss modulus (FIG. 23A) and complex viscosity (FIG. 23B).

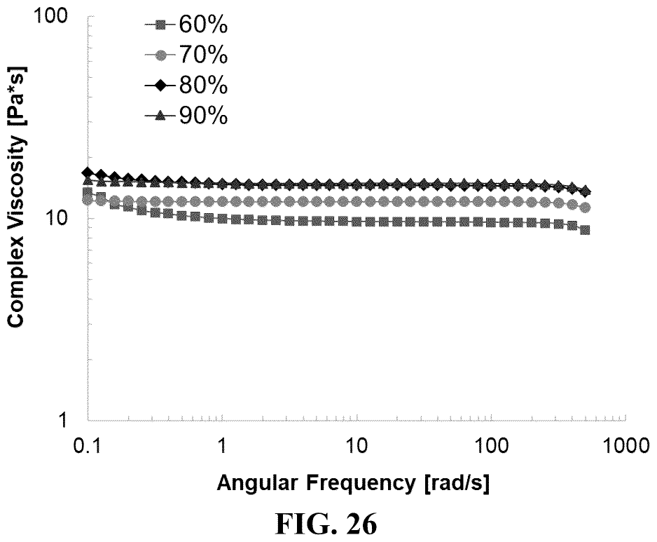

FIGS. 24A-B are graphs of a rheology frequency sweep of 80F-50 at 37° C. showing storage modulus and loss modulus (FIG. 24A) and complex viscosity (FIG. 24B);

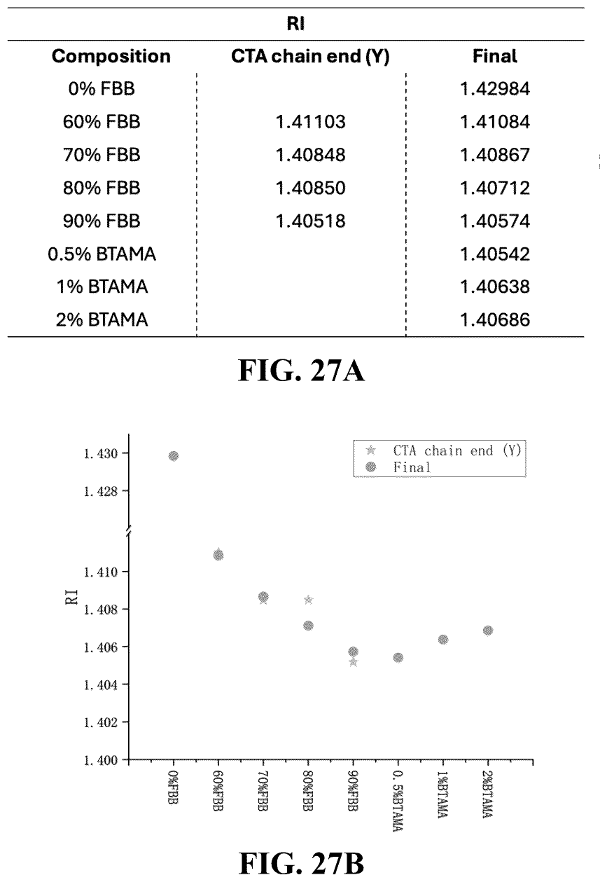

FIGS. 25A-B are graphs of a rheology frequency sweep of 90F-50 at 37° C. showing storage modulus and loss modulus (FIG. 25A) and complex viscosity (FIG. 25B);

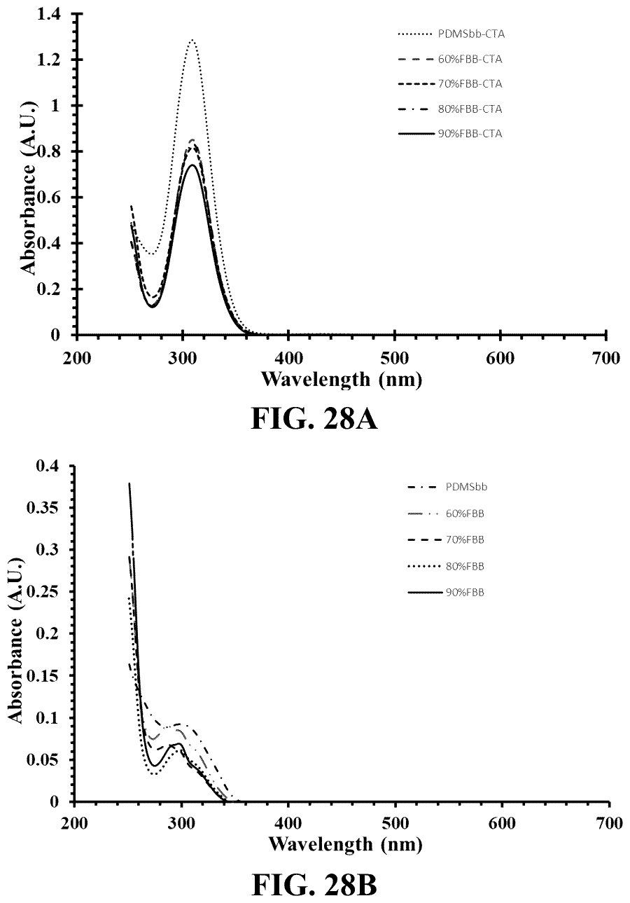

FIG. 26 is a comparison of the complex viscosity for 60F-50, 70F-50, 80F-50, and 90F-50;

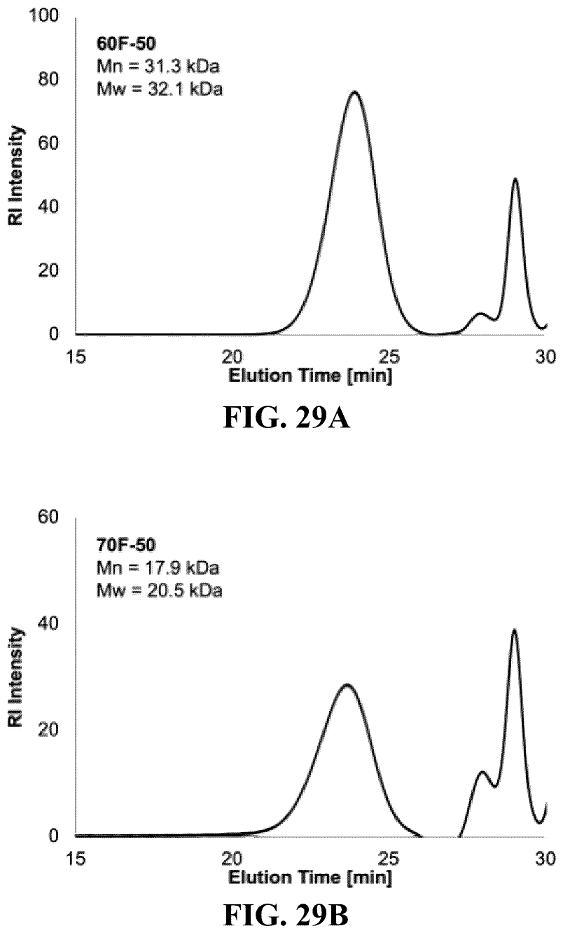

FIGS. 27A-B are a table (FIG. 27A) and a graph showing the refractive index (RI) of bottlebrush copolymers according to embodiments of the present invention having 0 mol. %, 50 mol. %, 60 mol. %, 70 mol. %, 80 mol. %, and 90 mol. % Flouro-MA units, with and without CTA chain end groups and the refractive index (RI) of bottlebrush copolymers according to embodiments of the present invention having 0.5 mol. %, 1.0 mol. %, and 1.0 mol. % BTAMA units (FIG. 27B). Refractometry of the Flouro-MA compositional range showcases that the bottlebrush fluorine content dominates refractive index with negligible contribution from trithiol carbonate RAFT agent fragments;

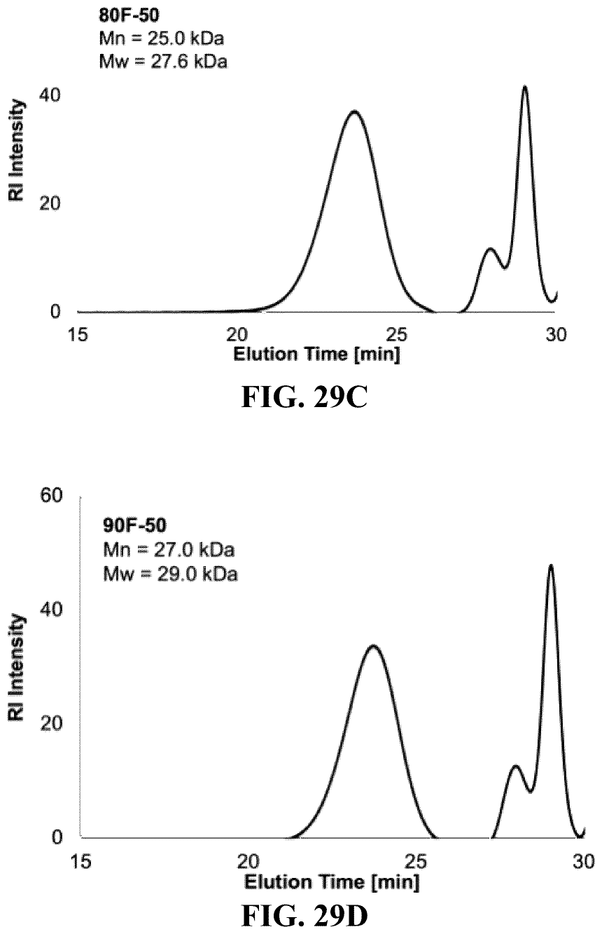

FIG. 28A-B is a comparison of UV-Vis spectra for the 60F-50, 70F-50, 80F-50, and 90F-50 bottlebrush copolymers with (FIG. 28A) and without (FIG. 28B) trithiol CTA end groups collected with a Shimadzu UV-3600i with a 1 cm pathlength quartz cuvette across a 300-600 nm spectral range.

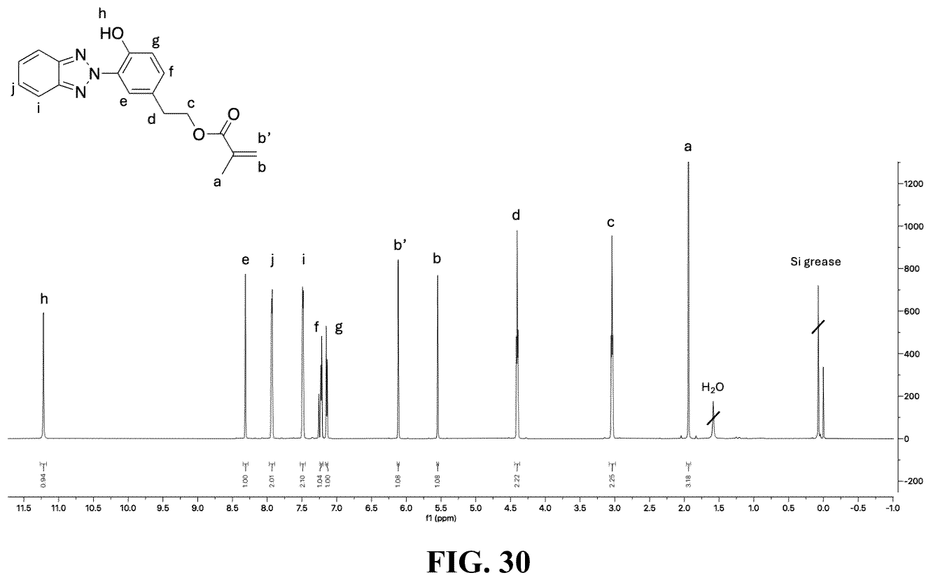

FIG. 29A-D is a comparison of Size Exclusion Chromatography (SEC) traces for 60F-50 (FIG. 29A), 70F-50 (FIG. 29B), 80F-50 (FIG. 29C), and 90F-50 (FIG. 29D) bottlebrush copolymers;

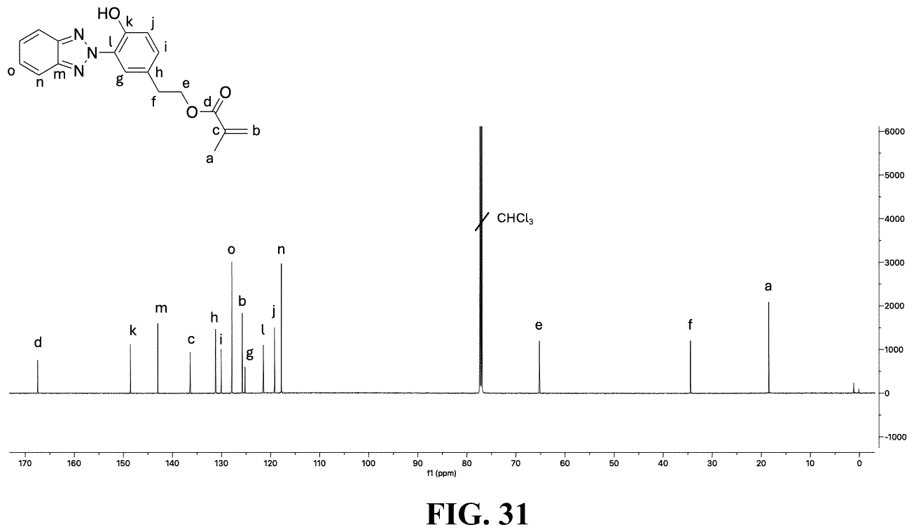

FIG. 30 is a ¹H NMR of 2-[3-(2H-benzotriazol-2-yl)-4-hydroxyphenyl]ethyl methacrylate UV chromophore (BTAMA) in CDCl₃

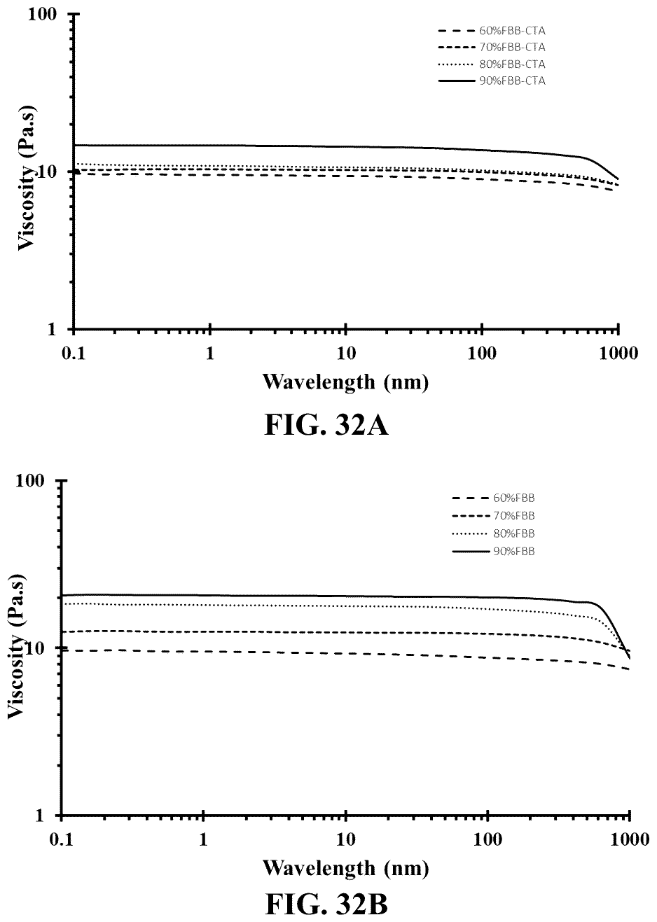

FIG. 31 is a ¹³C NMR of ¹³C NMR of 2-[3-(2H-benzotriazol-2-yl)-4-hydroxyphenyl]ethyl methacrylate UV chromophore (BTAMA) in CDCl₃2;

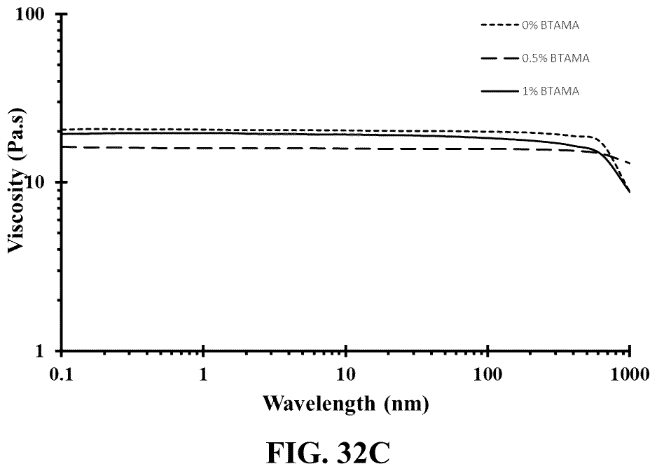

FIGS. 32A-C are graphs showing viscosity measurements for bottlebrush copolymers according to embodiments of the present invention having 60 mol. %, 70 mol. %, 80 mol. %, and 90 mol. % Flouro-MA units, with (FIG. 32A) and without (FIG. 32B) CTA chain end groups; and for bottlebrush copolymers according to embodiments of the present invention having 0 mol. % Flouro-MA units and embodiments of the present invention having 0.5 mol. %, 1.0 mol. %, and 1.0 mol. % BTAMA units (FIG. 32C);

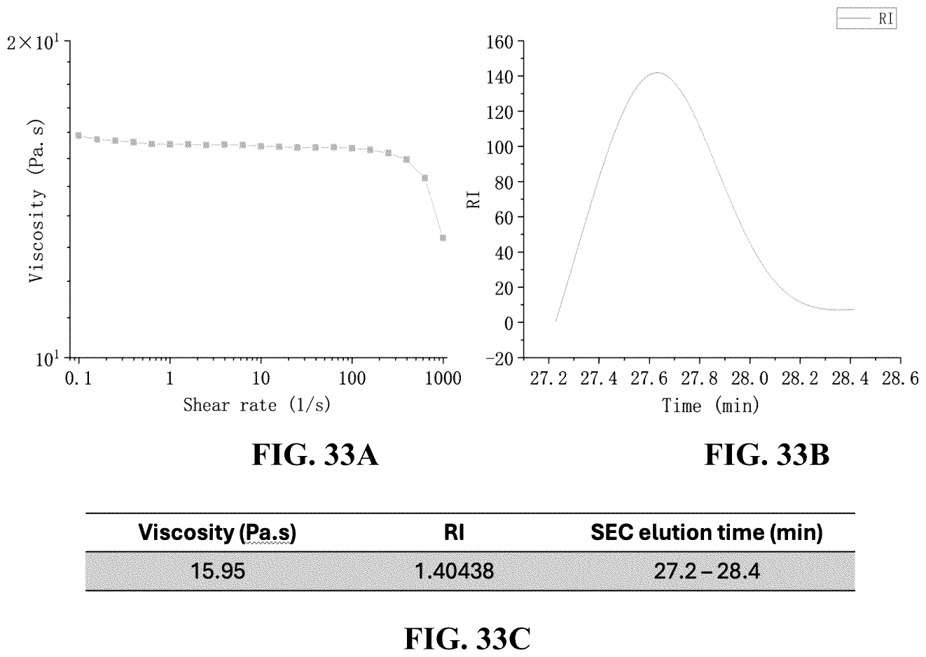

FIGS. 33A-C are graphs showing rheology results (FIG. 33A) and SEC (FIG. 33B) results for a 90%-50 optically clear UV blocking bottlebrush copolymer containing 1 mole percent BTAMA with the viscosity, refractive index (RI) and elution time are reported in FIG. 33C;

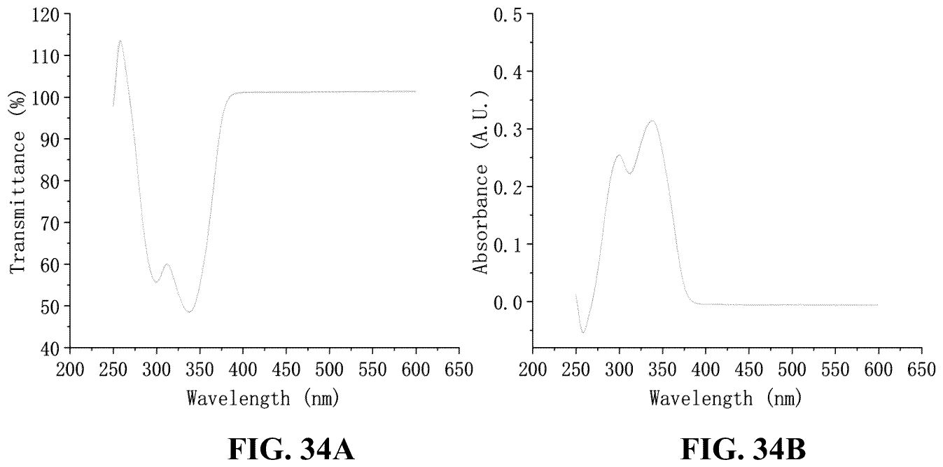

FIGS. 34A-B are graphs of UV-Vis Spectroscopy results showing transmittance (FIG. 34A) and absorbance (FIG. 34B) results for a 90%-50 optically clear UV blocking bottlebrush copolymer containing 1 mole percent BTAMA;

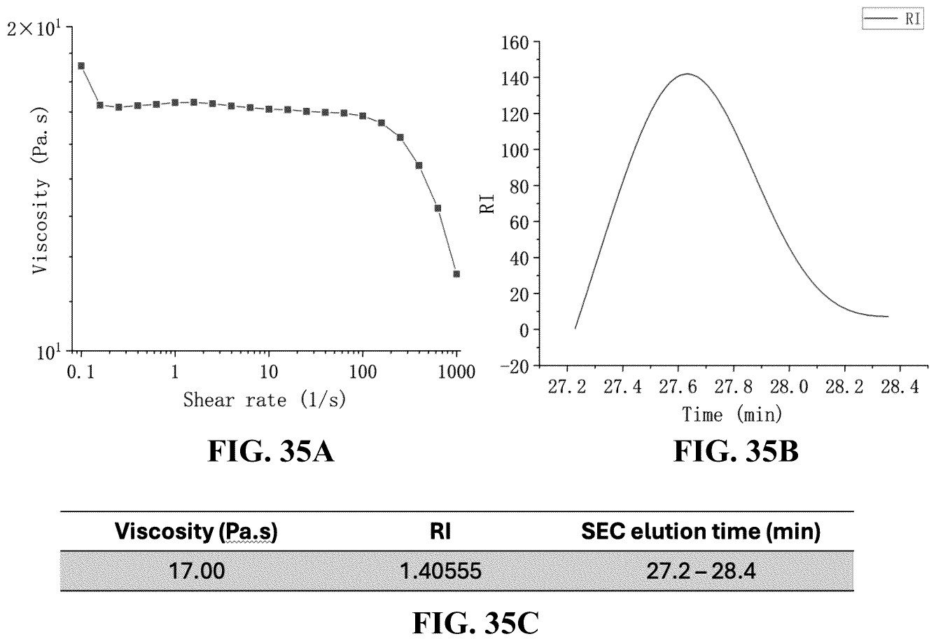

FIGS. 35A-C are graphs showing rheology results (FIG. 35A) and SEC (FIG. 35B) results for a 90%-50 optically clear UV blocking bottlebrush copolymer containing 2 mole percent BTAMA with the viscosity, refractive index (RI) and SEC elution time are reported in FIG. 35C;

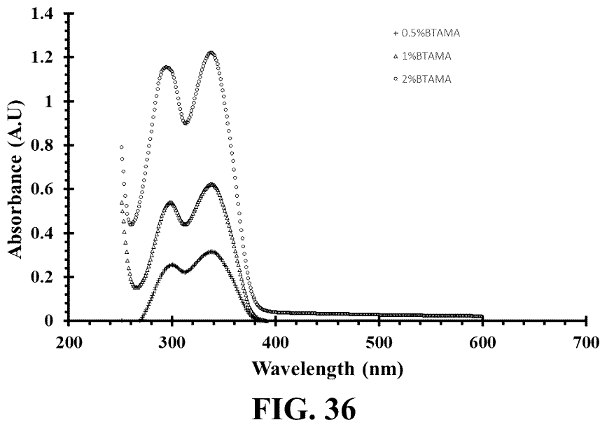

FIG. 36 is a comparison of UV-Vis spectra for 90F-50 bottlebrush copolymers with 1%, 1.5% and 2% BTAMA.

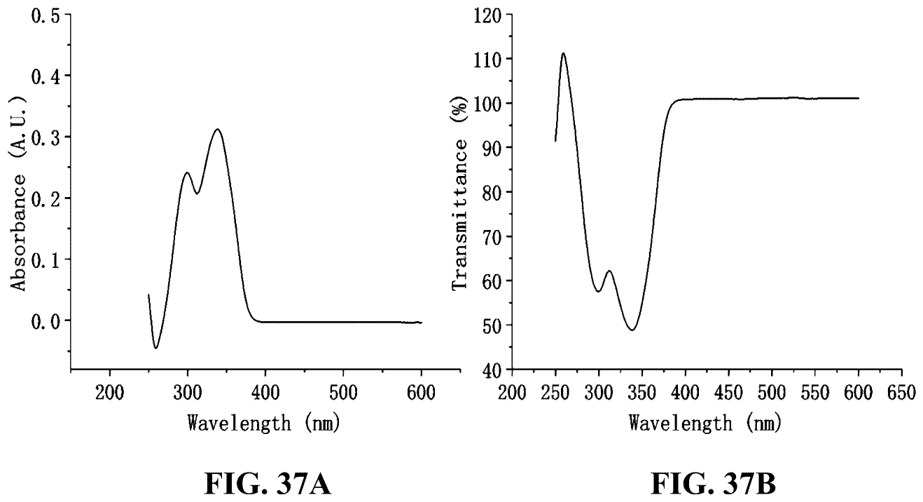

FIGS. 37A-B are graphs of UV-Vis Spectroscopy results showing transmittance (FIG. 37A) and absorbance (FIG. 37B) results for a 90%-50 optically clear UV blocking bottlebrush copolymer containing 2 mole percent BTAMA;

### DETAILED DESCRIPTION OF THE ILLUSTRATIVE EMBODIMENTS

The following is a detailed description of the disclosure provided to aid those skilled in the art in practicing the present disclosure. Those of ordinary skill in the art may make modifications and variations in the embodiments described herein without departing from the spirit or scope of the present disclosure. Unless otherwise defined, all technical and scientific terms used herein have the same meaning as commonly understood by one of ordinary skill in the art to which this disclosure belongs. The terminology used in the description of the disclosure herein is for describing particular embodiments only and is not intended to be limiting of the disclosure.

As set forth above, the present invention provides an optically clear bottlebrush copolymer suitable for use in intraocular lenses (IOLs) and accommodating or adaptive intraocular lenses (A-IOLs), in surgery for treating cataracts, and other optical maladies. These bottlebrush copolymers are optically clear and avoid the haze and/or yellow tint common to these types of polymers. (See FIGS. 1A-B) As set forth above, the optically clear bottlebrush copolymers of the present invention avoid the optical haze problems described above and removing the yellow thiocarbonyl end groups that would otherwise give the polymer a yellow tint.

In various embodiments, the optically clear bottlebrush copolymers of the present invention comprises one or more monomethacryloxy terminated polydimethylsiloxane (PDMS-MA) units, and or more monomethacryloxy terminated fluorinated siloxane (Fluoro-MA) units, and two 2-cyano isobutane end groups. In some other embodiments, the optically clear bottlebrush copolymers of the present invention comprises one or more monomethacryloxy terminated polydimethylsiloxane (PDMS-MA) units, one or more monomethacryloxy terminated fluorinated siloxane (Fluoro-MA) units, one or more UV blocking dye units and two 2-cyano isobutane end groups.

In addition to being optically clear, the viscosity and other properties of these bottlebrush copolymers are controllable through manipulating the degree of polymerization, the mole percent of Fluoro-MA units in the polymer, and the length and composition of the PDMS-MA and Fluoro-MA side chains that form the bottlebrush. In various embodiments, the optically clear bottlebrush copolymers of the present invention will have complex viscosity (η) at 37° C. that make them are suitable for use as filler materials in intraocular lenses (IOLs) and accommodating or adaptive intraocular lenses (A-IOLs) for use in surgery for treating cataracts and other optical maladies.

The following terms may have meanings ascribed to them below, unless specified otherwise. As used herein, the terms “comprising” “to comprise” and the like do not exclude the presence of further elements or steps in addition to those listed in a claim. Similarly, the terms “a,” “an” or “the” before an element or feature does not exclude the presence of a plurality of these elements or features, unless the context clearly dictates otherwise.

Unless specifically stated or obvious from context, as used herein, the term “about” is understood as within a range of normal tolerance in the art, for example within 2 standard deviations of the mean. “About” can be understood as within 5%, 4%, 3%, 2%, 1%, 0.5%, 0.1%, 0.05%, or 0.01% of the stated value. Unless otherwise clear from context, all numerical values provided herein in the specification and the claim can be modified by the term “about.”

It should be also understood that the ranges provided herein are a shorthand for all of the values within the range and, further, that the individual range values presented herein can be combined to form additional non-disclosed ranges. For example, a range of 1 to 50 is understood to include any number, combination of numbers, or sub-range from the group consisting 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50.

As will be apparent, the term “polymer” is used to refer to a macromolecule having a series of repeated monomer units or, more broadly, to a material made therefrom. Unless otherwise indicated or otherwise clear from the context, the term “polymer” is intended to be interpreted broadly and encompasses all types of polymers, including, but not limited to, homopolymers, copolymers, block copolymers, random copolymers, and other known polymer species. As used herein, the term “homopolymer” refers to a polymer derived from a single monomeric species. And as follows, unless otherwise indicated, the term “copolymer” refers to a polymer derived from two, three or more monomeric species and includes alternating copolymers, periodic copolymers, random copolymers, statistical copolymers and block copolymers. Unless otherwise indicated, the term “block copolymer” comprises two or more homopolymer or copolymer subunits linked by covalent bonds.

As used herein, the term “residue(s)” is used to refer generally to the part of a monomer or other chemical unit that has been incorporated into a polymer or large molecule. By extension, the terms “residue of the chain transfer agent” and the “chain transfer agent residue” are used interchangeably to refer to the parts of the chain transfer agent that have been incorporated into the bottlebrush copolymers. Conversely, a polymer “comprises” or is “derived from” a stated monomer if that monomer is incorporated into the polymer. Thus, the incorporated monomer that the polymer comprises is not the same as the monomer prior to incorporation into a polymer, in that at the very least, certain terminal groups are incorporated into the polymer backbone. A polymer is said to comprise a specific type of linkage if that linkage is present in the polymer.

Further, any compositions or methods provided herein can be combined with one or more of any of the other compositions and methods provided herein. The fact that given features, elements or components are cited in different dependent claims does not exclude that at least some of these features, elements or components maybe used in combination together.

In a first aspect, the present invention is directed to an optically clear bottlebrush copolymer comprising a random copolymer having one or more acryloxy or monomethacryloxy terminated polydimethylsiloxane (PDMS-MA) units and one or more acryloxy or monomethacryloxy terminated fluorinated siloxane (Fluoro-MA) units. As will be apparent, both the PDMS-MA and the Fluoro-MA units of the bottlebrush copolymer are formed from monomers comprising acryloxy or monomethacryloxy end groups, which will form the backbone of the polymer. The PDMS-MA and Fluoro-MA will further include either a polydimethylsiloxane segment (PDMS-MA) or a fluorinated siloxane segment (Fluoro-MA), a short spacer segment, and a tail segment.

In various embodiments, the short spacer segment of both the PDMS-MA and the Fluoro-MA units will be a linear alkenyl chain (—CH₂—) of from 1 to about 6 carbon atoms in length. In one or more embodiments, the short spacer segment of both the PDMS-MA and the Fluoro-MA units will be a linear alkenyl chain (—CH₂—) of 3 carbon atoms in length. In one or more embodiments, the tail segment of both the PDMS-MA and the Fluoro-MA units will be a linear alkyl chain of from 1 to about 5 carbon atoms in length. In one or more embodiments, the tail segment in both the PDMS-MA and the Fluoro-MA units will be a linear alkyl chain of 4 carbon atoms in length.

In various embodiments, polydimethylsiloxane segment comprises from about 2 to about 22 dimethyl siloxane units. In some embodiments, the polydimethylsiloxane segment comprises from about 2 to about 20 polydimethylsiloxane units, in other embodiments, from about 5 to about 20, in other embodiments, from about 10 to about 20, in other embodiments, from about 15 to about 20, in other embodiments, from about 2 to about 15, in other embodiments, from about 2 to about 10, and in other embodiments, from about 2 to about 5, dimethyl siloxane units. In some embodiments, the polydimethylsiloxane segment comprises from about 4 to about 8 polydimethylsiloxane units. In some embodiments, the polydimethylsiloxane segment comprises about 6 polydimethylsiloxane units. Here, as well as elsewhere in the specification and claims, individual range values can be combined to form additional non-disclosed ranges.

In one or more embodiments, the PDMS-MA units will comprise the residue of monomers having a formula selected from:

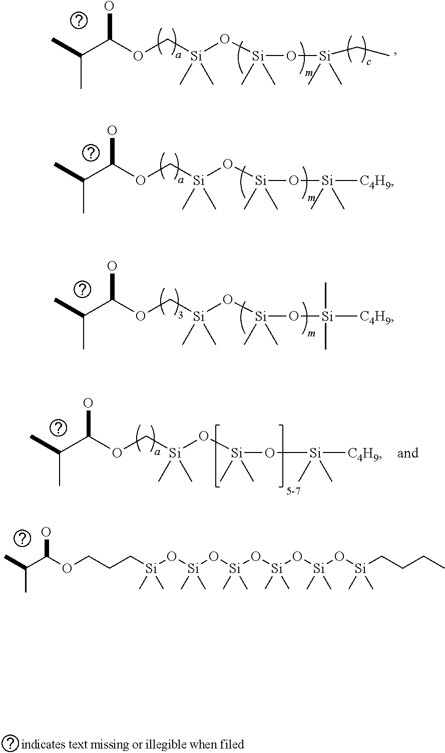

where a is an integer from about 1 to about 6; c is an integer from 1 to 5; and m is an integer from about 2 to about 20. In some of these embodiments, the PDMS-MA units will comprise the residue of monomethacryloxypropyl-terminated polydimethylsiloxane, asymmetric monomers.

The Fluoro-MA units are similar in composition to the PDMS-MA units described above except that one or more of the siloxane units are fluorinated using 3,3,3-trifluoropropyl groups. In some embodiments, all of the siloxane units are fluorinated. In some other embodiments, all but one of the siloxane units are fluorinated. In various embodiments, the Fluoro-MA units will comprise the residue of monomers having a formula selected from:

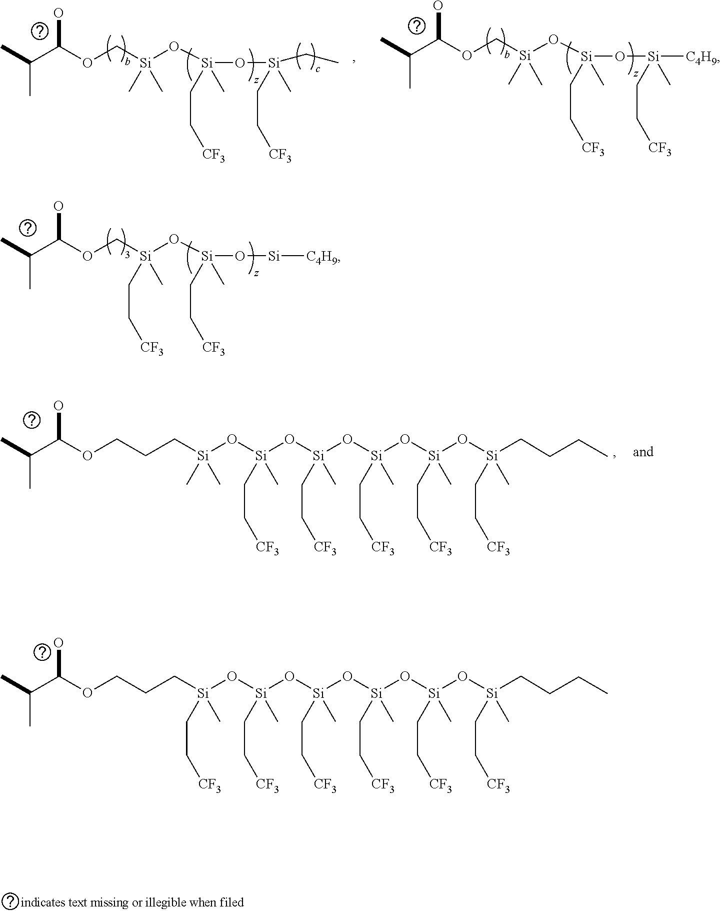

where b is an integer from about 1 to about 6; c is an integer from 1 to 5; and z is an integer from about 2 to about 20. In some of these embodiments, the Fluoro-MA units are the residue of monomethacryloxypropyl-terminated poly(3,3,3-trifluoropropyl)methylsiloxane, asymmetric monomers.

The optically bottlebrush copolymer of the present invention are generally linear and will have a first end and ordinarily a second end group. As described in more detail in the method section below, the RAFT chain transfer agents used to form optically clear bottlebrush copolymers of the present invention will have a first end containing a cyano moiety (e.g., a 2-cyano isobutane moiety) and a second end containing a di or trithiol moiety (e.g., a dithiobenzoate or trithiocarbonate moiety). During the RAFT polymerization reaction, the monomers will polymerize at a location at or near the center of the RAFT chain transfer agent, splitting it, with each half of the RAFT chain transfer agent forming an end group for the bottlebrush copolymer. (See, e.g., Schemes 1, 2, 4, and 6, below). Accordingly, the first end group will comprise the residue of the cyano moiety of the RAFT chain transfer agent and the specific structure of the first end group will depend upon the RAFT chain transfer agent used. For example, where the RAFT chain transfer agent is 2-cyano-2-propyl dodecyl trithiocarbonate, the first end group on the optically clear bottlebrush copolymer of the present invention will be a 2-cyano isobutane (—C(CH₃)₂CN) group.

As set forth above, the thiobenzyl or thiocarbonyl end group residues from the RAFT chain transfer agent create a yellow tint in the polymer and are removed by reacting the bottlebrush copolymer with an excess of an initiator, as described below. (See Schemes 2, 3, 5, and 7, below) In these embodiments, the second end group, if present, is introduced by the initiator used to remove the thiobenzyl or thiocarbonyl end group residues of the RAFT chain transfer agent. The specific structure of the second end group will, therefore, depend upon the initiator used to remove the thiobenzyl or thiocarbonyl end group residues. In various embodiments, for example, the initiator used to remove the thiobenzyl or thiocarbonyl end group residues is AIBN, which removes the yellow thiocarbonyl end group residues from the second end of the bottlebrush copolymer and replaced it with a terminal 2-cyano isobutane (—C(CH₃)₂CN) group. Accordingly, in some embodiments of the optically clear bottlebrush copolymer of the present invention, both the first and second end group will comprise 2-cyano isobutane (—C(CH₃)₂CN) groups.

In some embodiments, the optically clear bottlebrush copolymer of the present invention contains from about 1 mol. % to about 99 mol. %, in other embodiments, from about 1 mol. % to about 70 mol. %, in other embodiments, from about 1 mol. % to about 50 mol. %, in other embodiments, from about 1 mol. % to about 30 mol. %, in other embodiments, from about 1 mol. % to about 20 mol. %, in other embodiments, from about 1 mol. % to about 10 mol. %, in other embodiments, from about 20 mol. % to about 99 mol. %. %, in other embodiments, from about 40 mol. % to about 99 mol. %. %, in other embodiments, from about 60 mol. % to about 99 mol. % and in other embodiments, from about 80 mol. % to about 99 mol. % PDMS-MA units. In various embodiments, the bottlebrush copolymer will contain from about 1 mol. % to about 50 mol. %, preferably from about 1 mol. % to about 30 mol. %, and more preferably from about 1 mol. % to about 10 mol. % PDMS-MA units. In some embodiments, the optically clear bottlebrush copolymers of the present invention will comprise about 10 mol. % PDMS-MA units.

In some embodiments, the optically clear bottlebrush copolymer of the present invention contains from about 1 mol. % to about 99 mol. %, in other embodiments, from about 50 mol. % to about 99 mol. %, in other embodiments, from about 70 mol. % to about 99 mol. %, in other embodiments, from about 80 mol. % to about 99 mol. %, and in other embodiments, from about 80 mol. % to about 90 mol. % Fluoro-MA units. In various embodiments, the bottlebrush copolymer will contain from about 50 mol. % to about 99 mol. %, preferably from about 70 mol. % to about 99 mol. %, and more preferably from about 80 mol. % to about 90 mol. % Fluoro-MA units. In some embodiments, the optically clear bottlebrush copolymers of the present invention will comprise about 90 mol. % Fluoro-MA units.

In one or more embodiments, the optically clear bottlebrush copolymer of the present invention will comprise a random copolymer of monomethacryloxypropyl-terminated polydimethylsiloxane, asymmetric and monomethacryloxypropyl-terminated poly(3,3,3-trifluoropropyl)methylsiloxane, asymmetric.

In various embodiments, the optically clear bottlebrush copolymer of the present invention will have a degree of polymerization of from about 10 to about 200, more preferably from about 20 to about 100, and still more preferably from about 50 to about 80. In some embodiments, the optically clear bottlebrush copolymer of the present invention has a degree of polymerization of 50.

In various embodiments, the optically clear bottlebrush copolymer of the present invention will have a complex viscosity (η) at 37° C. of from about 5 Ps·s to about 15 Ps·s, preferably from about 5 Ps·s to about 15 Ps·s, and more preferably from about 9 Ps·s to about 15 Ps·s, as measured by a rheometer. In some of these embodiments, the optically clear bottlebrush copolymer of the present invention has a complex viscosity (η) at 37° C. of from 14 Ps·s to 15 Ps·s, as measured by a rheometer.

The optically clear bottlebrush copolymers of the present invention will have a number average molecular mass Mₙ of from about 25,000 g/mole to about 250,000 g/mole. In some embodiments, the Mₙ of the optically clear bottlebrush copolymers of the present invention is from about 50,000 g/mole to about 250,000 g/mole, in other embodiments, from about 100,000 g/mole to about 250,000 g/mole, in other embodiments, from about 150,000 g/mole to about 250,000 g/mole, in other embodiments, from about 200,000 g/mole to about 250,000 g/mole, in other embodiments, from about 25,000 g/mole to about 200,000 g/mole, in other embodiments, from about 25,000 g/mole to about 150,000 g/mole, in other embodiments, from about 25,000 g/mole to about 100,000 g/mole, and in other embodiments, from about 25,000 g/mole to about 50,000 g/mole, as measured by size exclusion chromatography (SEC). In some embodiments, Mₙ is from about 50,000 g/mole to about 200,000 g/mole, as measured by size exclusion chromatography (SEC). In some other embodiments, Mₙ is from about 100,000 g/mole to about 200.000 g/mole, as measured by size exclusion chromatography (SEC).

The optically clear bottlebrush copolymers of the present invention will have a number average molecular mass (M_{w}) of from about 30,000 g/mole to about 500,000 g/mole, preferably from about 100,000 g/mole to about 400,000 g/mole, and more preferably from about 150,000 g/mole to about 300,000 g/mole, as measured by size exclusion chromatography (SEC).

In various embodiments, the optically clear bottlebrush copolymer of the present invention has the formula:

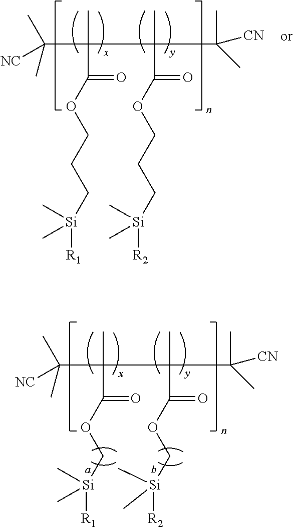

where R₁ is a siloxane; R₂ is a fluorinated siloxane; x is a mole fraction from about 0.99 to about 0.01; y is a mole fraction from about 0.01 to about 0.99; n is the degree of polymerization from about 10 to about 200; a is an integer from about 1 to about 6; b is an integer from about 1 to about 6; and x+y=1.00. In some embodiments, x is 0.1 and y is 0.9. In some embodiments, n is from about 30 to about 70. In other embodiments, n is 50. Here, as well as elsewhere in the specification and claims, individual range values can be combined to form additional non-disclosed ranges.

In some embodiments, a is from 1 to 6, in other embodiments, from about 1 to about 5, in other embodiments, from about 1 to about 4, in other embodiments, from about 1 to about 3, in other embodiments, from about 1 to about 2, in other embodiments, from about 2 to about 6, in other embodiments, from about 3 to about 6, in other embodiments, from about 4 to about 6, and in other embodiments, from about 5 to about 6. In some embodiments, b is from 1 to 6, in other embodiments, from about 1 to about 5, in other embodiments, from about 1 to about 4, in other embodiments, from about 1 to about 3, in other embodiments, from about 1 to about 2, in other embodiments, from about 2 to about 6, in other embodiments, from about 3 to about 6, in other embodiments, from about 4 to about 6, and in other embodiments, from about 5 to about 6. Here, as well as elsewhere in the specification and claims, individual range values can be combined to form additional non-disclosed ranges.

In one or more embodiments, the he optically clear bottlebrush copolymer of the present invention has the formula:

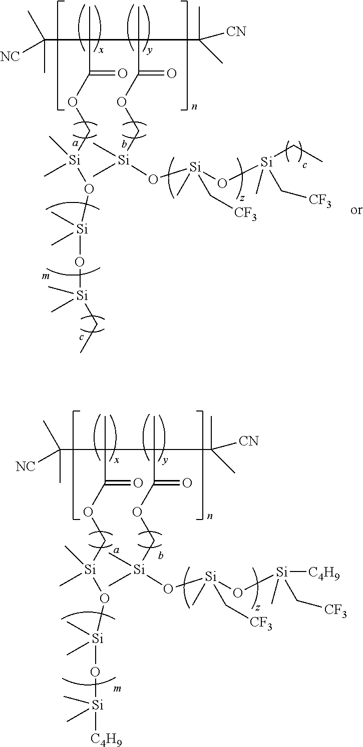

where x is a mole fraction from about 0.99 to about 0.01; y is a mole fraction from about 0.01 to about 0.99; n is the degree of polymerization from about 10 to about 200; a is an integer from about 1 to about 6; b is an integer from about 1 to about 6; c is an integer from 1 to 6; m is an integer from about 2 to about 20; and z is an integer from about 2 to about 20; and x+y=1.00.

In some of these embodiments, m is an integer from 2 to 20, in other embodiments, from about 5 to about 20, in other embodiments, from about 10 to about 20, in other embodiments, from about 15 to about 20, in other embodiments, from about 2 to about 18, in other embodiments, from about 2 to about 16, in other embodiments, from about 2 to about 14, in other embodiments, from about 2 to about 10, and in other embodiments, from about 2 to about 6. In some of these embodiments, m is 6 or 7.

In some of these embodiments, z is an integer from 2 to 20, in other embodiments, from about 5 to about 20, in other embodiments, from about 10 to about 20, in other embodiments, from about 15 to about 20, in other embodiments, from about 2 to about 18, in other embodiments, from about 2 to about 16, in other embodiments, from about 2 to about 14, in other embodiments, from about 2 to about 10, and in other embodiments, from about 2 to about 6. In some of these embodiments, z is 5 or 6.

In some of these embodiments, c is an integer from 1 to 6, in other embodiments, from about 1 to about 5, in other embodiments, from about 1 to about 4, in other embodiments, from about 1 to about 3, in other embodiments, from about 1 to about 2, in other embodiments, from about 2 to about 6, in other embodiments, from about 3 to about 6, in other embodiments, from about 4 to about 6, and in other embodiments, from about 5 to about 6. In various embodiments, a, b, and n are as set forth above. Here, as well as elsewhere in the specification and claims, individual range values can be combined to form additional non-disclosed ranges.

In one or more embodiment, the optically clear bottlebrush copolymer of the present invention has the formula:

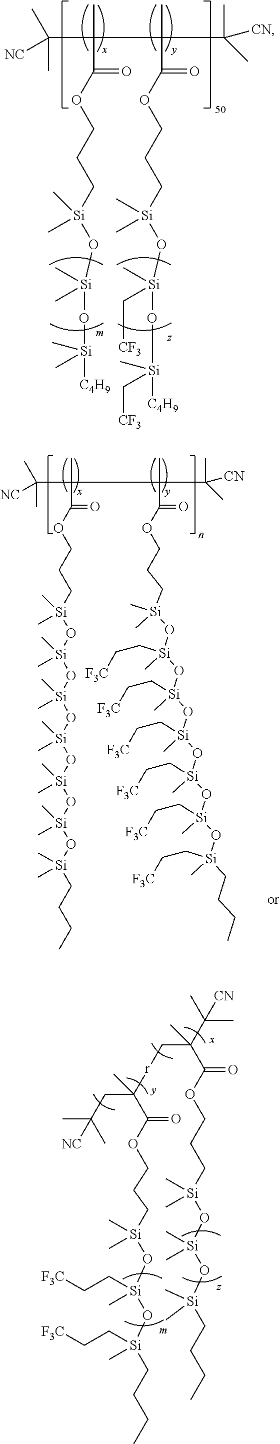

where x is a mole fraction from about 0.99 to about 0.01; y is a mole fraction from about 0.01 to about 0.99; x+y=1.00; n is the degree of polymerization from about 10 to about 200; m is an integer from about 2 to about 20; and z is an integer from about 2 to about 20. In one or more of these embodiments, x, y, z, a, b, n and m are all as set forth above. Here, as well as elsewhere in the specification and claims, individual range values can be combined to form additional non-disclosed ranges.

In some embodiments, the optically clear bottlebrush copolymer of the present invention has the formula:

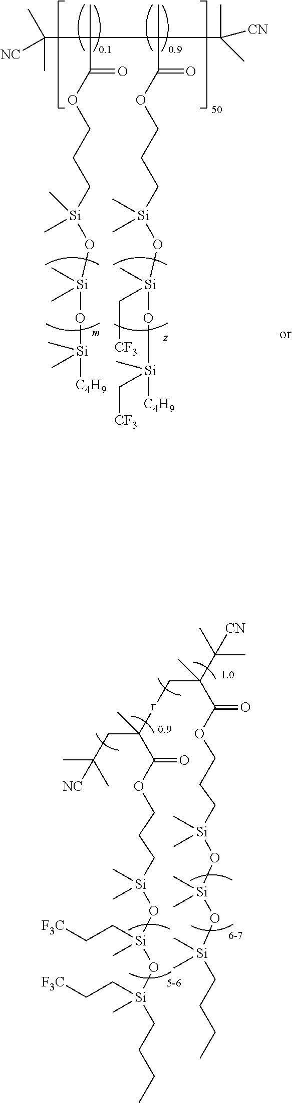

where m is an integer from about 4 to about 8 and z is an integer from about 3 to about 8. In one or more of these embodiments, m and z are as set forth above. In some of these embodiments, m is 5 or 6 and z is 6 or 7.

FIG. 2 is an exemplary ¹H NMR spectra with proton assignments for the copolymer 60F-50. ¹H NMR spectra of optically clear bottlebrush polymers of the present invention having 60%, 70%, 80% and 90% Flouro-MA monomers and a degree of polymerization of 50 are shown in FIGS. 3-6. A ¹H NMR spectra and a 19F NMR spectra of 90 mol. % fluorinated siloxane bottlebrush copolymers are shown in FIGS. 7, 8.

In a second embodiment of the present invention, the optically clear bottlebrush copolymers may be as set forth above but will also comprise a plurality of UV blocking dye units. These units are introduced into the copolymer during the RAFT polymerization process, using one or more methacrylate terminated UV blocking monomers. In various embodiments, the UV blocking dye units are the residue of 2-[3-(2H-Benzotriazol-2-yl)-4-hydro-xyphenyl]ethyl methacrylate (BTAMA) monomers.

As will be apparent, these monomers will have a terminal acryloxy or methacryloxy moiety that allows the monomer to be added to the backbone of the copolymer in the same manner as the PDMS-MA and Flouro-MA monomers. The UV blocking group will form a side chain extending outward from the polymethacrylate/acrylate polymer backbone.

The UV blocking group used is not particularly limited and any suitable material capable of blocking or otherwise reducing transmission of UV 200 to 400 nm) light through the polymer may be used provided that it has a reactive methacylate or acrylate end group and does not interfere with the RAFT polymerization reaction. Suitable UV blocking groups may include, without limitation, 2-[3-(2H-Benzotriazol-2-yl)-4-hydro-xyphenyl] groups or a 3-Butyl-6-methoxy-7-hydroxy-4H-chromen-4-one, Khellol, all trans-Retinal, Ellagic Acid Dihydrate, or Rutin trihydrate monomer residue, or a combination of these blocking groups. In one or more embodiments, the UV blocking group will be the residue of a 2-[3-(2H-Benzotriazol-2-yl)-4-hydro-xyphenyl]ethyl methacrylate (BTAMA) UV blocking monomer. In some other embodiments, the UV blocking group will be the residue of a 3-Butyl-6-methoxy-7-hydroxy-4H-chromen-4-one, Khellol, all trans-Retinal, Ellagic Acid Dihydrate, or Rutin trihydrate monomer. Chromatophore traces for 3-Butyl-6-methoxy-7-hydroxy-4H-chromen-4-one, Khellol, all trans-Retinal, Ellagic Acid Dihydrate, and Rutin trihydrate monomers are attached as FIGS. 9-13, respectively.

In one or more embodiments, the UV blocking monomer will have a formula selected from:

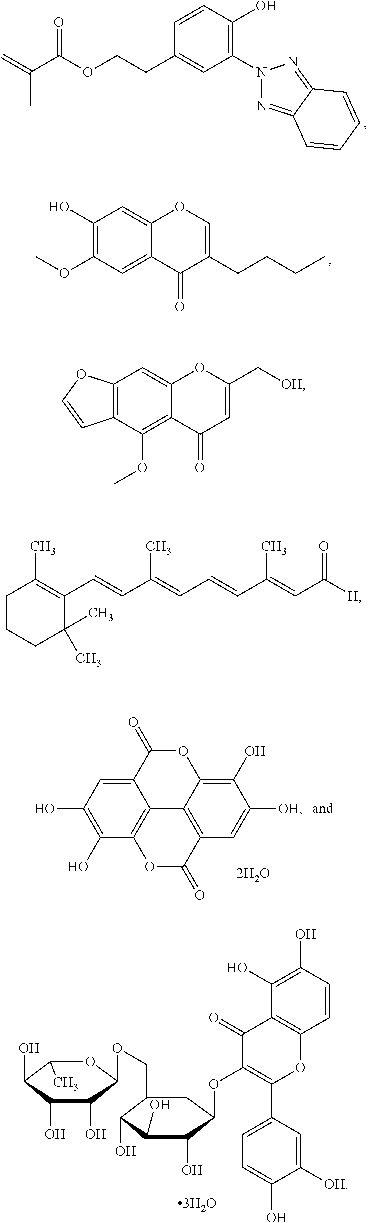

In various embodiments, the UV blocking optically clear bottlebrush copolymers of the present invention significantly reduces transmission of UV light through the copolymer, relative to the optically clear bottlebrush copolymers without the UV blocking dye units. In one or more embodiments, the UV blocking optically clear bottlebrush copolymers of the present invention will reduce transmission of UV light through the polymer by from about 90% to about 99.9%, relative to the optically clear bottlebrush copolymers without the UV blocking dye units. In some embodiments, the UV blocking optically clear bottlebrush copolymers of the present invention will reduce transmission of UV light through the polymer by from about 90% to about 99%, in other embodiments, from about 90% to about 97%, in other embodiments, from about 90% to about 95%, in other embodiments, from about 90% to about 93%, in other embodiments, from about 90% to about 91%, in other embodiments, from about 92% to about 99.9%, in other embodiments, from about 94% to about 99.9%, in other embodiments, from about 96% to about 99.9%, and in other embodiments, from about 98% to about 99.9%. In embodiments where the UV blocking optically clear bottlebrush copolymers of the present invention are used as a filler material for artificial lenses, the UV blocking dye units are useful in reducing the amount of UV light that passes through the clear bottlebrush copolymers and reach the retina of the eye.

As with the optically clear bottlebrush copolymers without the UV blocking dye units, the yellow thiocarbonyl end group residues from the chain transfer agent are also removed from these polymers, as described herein. In one or more embodiment, the optically clear UV blocking bottlebrush copolymers will have the same first and second end groups as the optically clear bottlebrush copolymers described above. In various embodiments, the yellow tinted thiocarbonyl or thiobenzyl end groups are replaced by terminal 2-cyano isobutane (—C(CH₃)₂CN) groups, to leave the polymer optically clear.

In various embodiments, the PDMS-MA monomers, Fluoro-MA monomers, and chain transfer agents used to form the optically clear UV blocking bottlebrush copolymers may be as set forth above. In some of these embodiments, the Fluoro-MA units are the residue of 2-[3-(2H-Benzotriazol-2-yl)-4-hydro-xyphenyl]ethyl methacrylate, asymmetric monomers. In some embodiments, the PDMS-MA units are the residue of monomethacryloxypropyl-terminated polydimethylsiloxane, asymmetric monomers. In some of these embodiments, the UV absorbing monomer will be 2-[3-(2H-Benzotriazol-2-yl)-4-hydro-xyphenyl]ethyl methacrylate (BTAMA).

The UV blocking dye units comprise a relatively small portion of the UV blocking optically clear bottlebrush copolymers of the present invention In various embodiments, the UV blocking optically clear bottlebrush copolymers will comprise from about 0.1 mol. % to about 5 mol. %, preferably from about 0.1 mol. % to about 3 mol. %, and more preferably from about 0.1 mol. % to about 1 mol. % UV blocking dye units. In some embodiments, the UV blocking optically clear bottlebrush copolymers of the present invention contains from about 0.1 mol. % to about 4 mol. %, in other embodiments, from about 0.1 mol. % to about 2 mol. %, in other embodiments, from about 0.1 mol. % to about 1 mol. %, in other embodiments, from about 0.5 mol. % to about 5 mol. %, and in other embodiments, from about 1 mol. % to about 5, in other embodiments, from about 2 mol. % to about 5 mol. %, in other embodiments, from about 3 mol. % to about 5 mol. %, in other embodiments, from about 4 mol. % to about 5 mol. % UV blocking dye units. In some embodiments, the optically clear bottlebrush copolymers of the present invention will comprise about 1 mol. % UV blocking dye units.

In some embodiments, the optically clear UV blocking bottlebrush copolymer of the present invention contains from about 1 mol. % to about 99 mol. %, in other embodiments, from about 1 mol. % to about 70 mol. %, in other embodiments, from about 1 mol. % to about 50 mol. %, in other embodiments, from about 1 mol. % to about 30 mol. %, in other embodiments, from about 1 mol. % to about 20 mol. %, in other embodiments, from about 1 mol. % to about 10 mol. %, in other embodiments, from about 20 mol. % to about 99 mol. %, in other embodiments, from about 40 mol. % to about 99 mol. %, in other embodiments, from about 60 mol. % to about 99 mol. % and in other embodiments, from about 80 mol. % to about 99 mol. % PDMS-MA units. In various embodiments, the optically clear UV blocking bottlebrush copolymer will contain from about 1 mol. % to about 50 mol. %, preferably from about 1 mol. % to about 30 mol. %, and more preferably from about 1 mol. % to about 10 mol. % PDMS-MA units. In some embodiments, the optically clear UV blocking bottlebrush copolymers of the present invention will comprise about 10 mol. % PDMS-MA units.

In some embodiments, the optically clear UV blocking bottlebrush copolymer of the present invention contains from about 1 mol. % to about 99 mol. %, in other embodiments, from about 50 mol. % to about 99 mol. %, in other embodiments, from about 70 mol. % to about 99 mol. %, in other embodiments, from about 80 mol. % to about 99 mol. %, and in other embodiments, from about 80 mol. % to about 90 mol. % Fluoro-MA units. In various embodiments, the bottlebrush copolymer will contain from about 50 mol. % to about 99 mol. %, preferably from about 70 mol. % to about 99 mol. %, and more preferably from about 80 mol. % to about 90 mol. % Fluoro-MA units. In some embodiments, the optically clear UV blocking bottlebrush copolymers of the present invention will comprise about 90 mol. % Fluoro-MA units.

In various embodiments, the UV blocking optically clear bottlebrush copolymers of the present invention will have the same degree of polymerization, complex viscosity (η), Mₙ, and M_{w} as the optically clear bottlebrush copolymers not having the UV blocking dye units described above.

In one or more embodiments, the UV blocking optically clear bottlebrush copolymer of the present invention will comprise a random copolymer of monomethacryloxypropyl-terminated polydimethylsiloxane, asymmetric, monomethacryloxypropyl-terminated poly(3,3,3-trifluoropropyl)methylsiloxane, asymmetric, and 2-[3-(2H-Benzotriazol-2-yl)-4-hydro-xyphenyl]ethyl methacrylate formed by RAFT polymerization wherein the yellow thiocarbonyl end group residues from the chain transfer agent are removed and replaced with terminal 2-cyano isobutane (—C(CH₃)₂CN) groups, to leave the polymer optically clear.

In one or more embodiments, the UV blocking optically clear bottlebrush copolymers will have the formula:

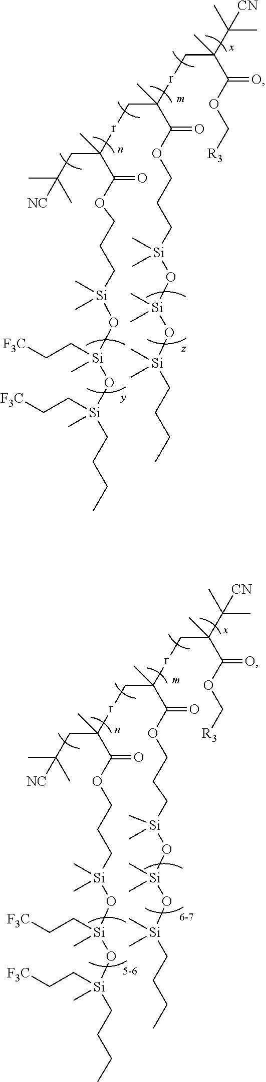

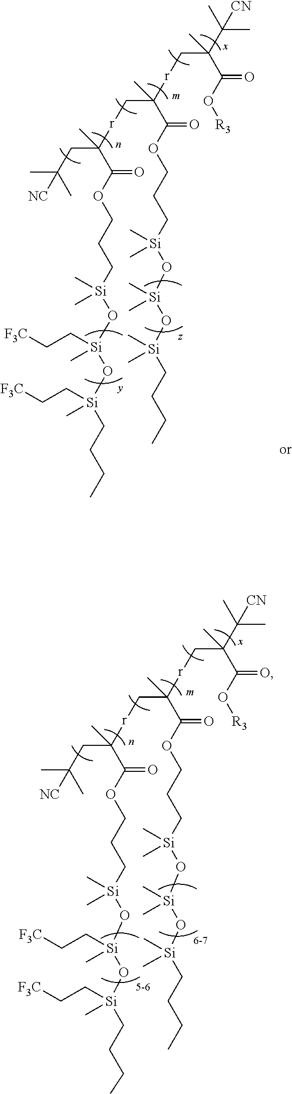

wherein n, m, and x are mole fractions where n+m+x=1, y is an integer from about 2 to about 20; z is an integer from about 2 to about 20; R₃ is a UV blocking group and r indicates random polymerization.

In some of these embodiments, n is a mole fraction from about 0.1 to about 0.99, in other embodiments, from about 0.3 to about 0.99, in other embodiments, from about 0.5 to about 0.99, in other embodiments, from about 0.7 to about 0.99, in other embodiments, from about 0.8 to about 0.99, in other embodiments, from about 0.9 to about 0.99, in other embodiments, from about 0.1 to about 90, in other embodiments, from about 0.1 to about 0.8, in other embodiments, from about 0.1 to about 0.7, in other embodiments, from about 0.1 to about 0.6, in other embodiments, from about 0.1 to about 0.5, and in other embodiments, from about 0.1 to about 0.4. In some embodiments, n is a mole fraction from about 0.85 to about 0.95. In some embodiments. n is 0.9. Here, as well as elsewhere in the specification and claims, individual range values can be combined to form additional non-disclosed ranges.

In some of these embodiments, m is a mole fraction from about 0.01 to about 0.99, in other embodiments, from about 0.01 to about 0.80, in other embodiments, from about 0.01 to about 0.60, in other embodiments, from about 0.01 to about 0.5, in other embodiments, from about 0.01 to about 0.4, in other embodiments, from about 0.01 to about 0.3, in other embodiments, from about 0.01 to about 0.2, in other embodiments, from about 0.01 to about 0.1, in other embodiments, from about 0.1 to about 0.95, in other embodiments, from about 0.2 to about 0.95, in other embodiments, from about 0.3 to about 0.95, in other embodiments, from about 0.4 to about 0.95, in other embodiments, from about 0.5 to about 0.95, in other embodiments, from about 0.6 to about 0.95, in other embodiments, from about 0.7 to about 0.0.95, and in other embodiments, from about 0.80 to about 0.95. In some embodiments, m is a mole fraction from about 0.05 to about 0.15. In some embodiments, n is 0.1. Here, as well as elsewhere in the specification and claims, individual range values can be combined to form additional non-disclosed ranges.

In some of these embodiments, x is a mole fraction from about 0.003 to about 0.025, in other embodiments, from about 0.01 to about 0.025, in other embodiments, from about 0.15 to about 0.025, in other embodiments, from about 0.015 to about 0.025, in other embodiments, from about 0.020 to about 0.025, in other embodiments, from about 0.005 to about 0.020, in other embodiments, from about 0.005 to about 0.015, and in other embodiments, from about 0.005 to about 0.01. In some embodiments, x is a mole fraction from about 0.005 to about 0.015. In some embodiments, x is 0.01. Here, as well as elsewhere in the specification and claims, individual range values can be combined to form additional non-disclosed ranges.

In some of these embodiments, z is from about 4 to about 20, in other embodiments, from about 8 to about 20, in other embodiments, from about 12 to about 20, in other embodiments, from about 15 to about 20, in other embodiments, from about 2 to about 18, in other embodiments, from about 2 to about 16, in other embodiments, from about 2 to about 14, in other embodiments, from about 2 to about 10, and in other embodiments, from about 2 to about 6. In some of these embodiments, z is 6 or 7. Here, as well as elsewhere in the specification and claims, individual range values can be combined to form additional non-disclosed ranges.

In some of these embodiments, y is from about 4 to about 20, in other embodiments, from about 8 to about 20, in other embodiments, from about 12 to about 20, in other embodiments, from about 15 to about 20, in other embodiments, from about 2 to about 18, in other embodiments, from about 2 to about 16, in other embodiments, from about 2 to about 14, in other embodiments, from about 2 to about 10, and in other embodiments, from about 2 to about 6. In some of these embodiments, z is 5 or 6. Here, as well as elsewhere in the specification and claims, individual range values can be combined to form additional non-disclosed ranges.

In some embodiments, R3 will be a residue of a 2-[3-(2H-Benzotriazol-2-yl)-4-hydro-xyphenyl] group or a 3-Butyl-6-methoxy-7-hydroxy-4H-chromen-4-one monomer, Khellol monomer, all trans-Retinal monomer, Ellagic Acid Dihydrate monomer, or Rutin trihydrate monomer.

In one or more embodiments, the UV blocking optically clear bottlebrush copolymers will have the formula:

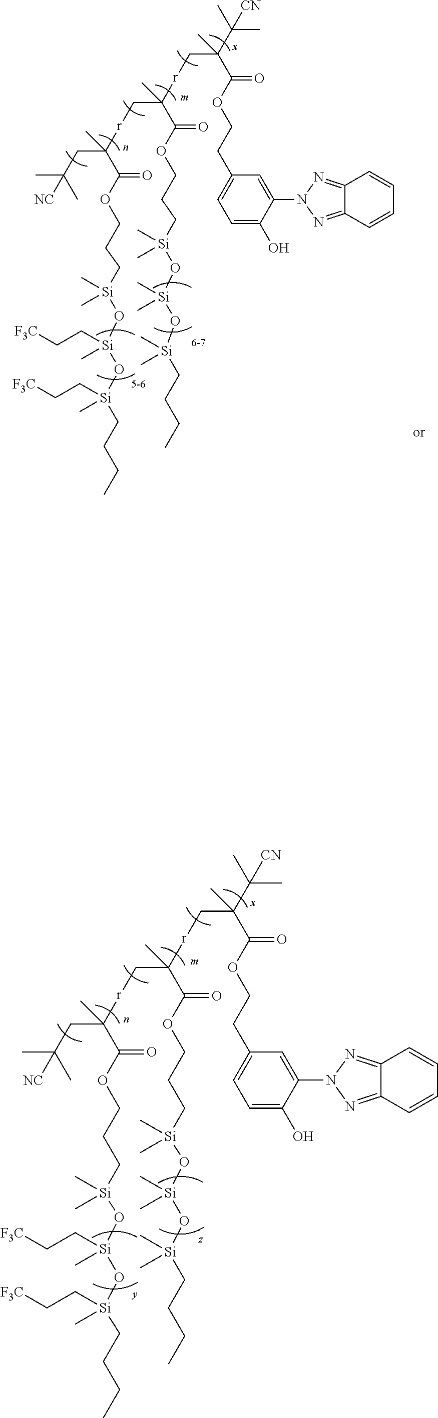

where n, m, and x are mole fractions (n+m+x=1); y is an integer from about 2 to about 20; z is an integer from about 2 to about 20; and r indicates random polymerization. In one or more of these embodiments, n, m, x, y, and z are all as set forth above. In some embodiments, m is an integer from about 4 to about 8 and z is an integer from about 3 to about 8. In some of these embodiments, y is 5 or 6 and z is 6 or 7.

In a third aspect, the present invention is directed to a two-step method for forming the optically clear bottlebrush copolymers discussed above. In the first step, a yellow tinted bottlebrush copolymer intermediate is formed by reversible addition fragmentation chain-transfer (RAFT) polymerization of a PDMS-MA monomer, a Fluoro-MA monomer, and optionally a UV blocking monomer. As set forth above, bottlebrush copolymers formed using RAFT polymerization will generally have thiocarbonyl end groups, giving the polymer a yellow tint. Accordingly, in a second step, the thiocarbonyl end groups are removed and replaced with 2-cyano isobutane (—C(CH₃)₂CN) end groups.

In the first step, a series of methacryloxy or, optionally, acryloxy terminated monomers are combined with a chain transfer agent and an initiator to produce a yellow tinted bottlebrush copolymer intermediate using standard RAFT polymerization techniques. In one or more embodiments, the yellow tinted bottlebrush copolymer intermediate may be prepared as shown in Scheme 1, below.

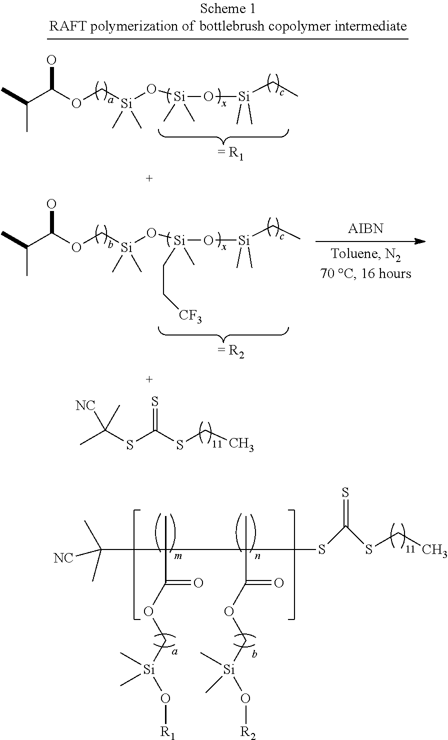

where a and b are each an integer from 1 to 6; each c is an integer from about 1 to about 6; each x is an integer from about 1 to about 20; and m and n are each a mole fraction.

In various embodiments, the method first involves combining a PDMS-MA monomer, a Fluoro-MA monomer, a chain transfer agent suitable for RAFT polymerization reactions, an initiator, and an anhydrous solvent in a sealed reaction vessel, as shown in Scheme 1, above. In the optically clear UV blocking bottlebrush copolymer embodiments, however, the method first involves combining a PDMS-MA monomer, a Fluoro-MA monomer, a UV blocking monomer, a chain transfer agent suitable for RAFT polymerization reactions, an initiator, and an anhydrous solvent to the sealed reaction vessel. In various embodiments, the reaction vessel will comprise a Schenk flask with a magnetic stirring bar sealed with a rubber septum or other similar apparatus.

In one or more embodiment, the PDMS-MA monomer, Fluoro-MA monomer, and UV blocking monomer may be any of those described above. In some embodiments, the PDMS-MA monomer is monomethacryloxypropyl-terminated polydimethylsiloxane, asymmetric. In some embodiments, the Fluoro-MA monomer is monomethacryloxypropyl-terminated poly(3,3,3-trifluoropropyl)methylsiloxane, asymmetric. In some embodiments, the UV blocking monomer is 2-[3-(2H-Benzotriazol-2-yl)-4-hydro-xyphenyl]ethyl methacrylate.

Suitable RAFT chain transfer agents are well known in the art and may include, without limitation, dithiobenzoates, trithiocarbonates, and combinations thereof. In some embodiments, the RAFT chain transfer agent comprises 2-cyano-2-propyl dodecyl trithiocarbonate. In some other embodiments, the RAFT chain transfer agent may be 4-cyano-4-[(dodecylsulfanylthiocarbonyl)sulfanyl] pentanoic acid or 4-cyano-4-(thiobenzoylthio) pentanoic acid. In one or more embodiments, the RAFT chain transfer agent is selected from the group consisting of dithiobenzoates, trithiocarbonates, 2-cyano-2-propyl dodecyl trithiocarbonate, 4-cyano-4-[(dodecylsulfanylthiocarbonyl)sulfanyl] pentanoic acid, 4-cyano-4-(thiobenzoylthio) pentanoic acid; 4-(benzodithioyl)-4-cyanopentanoic acid, 2-cyanopropan-2-yl benzodithioate, and combinations thereof.

In some other embodiments, the RAFT agent may comprise a dithiobenzoate having the formula:

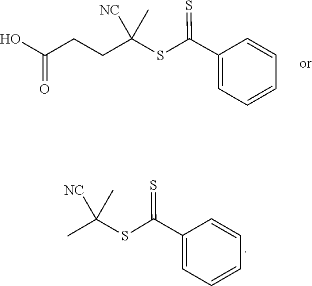 [SMILES: CC(C#N)(CCC(=O)O)SC(=S)c1ccccc1 ; CC(C)(C#N)SC(=S)c1ccccc1]

In some other embodiments, the RAFT chain transfer agent may comprise a trithiocarbonates having the formula:

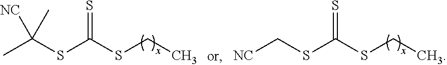

where x is an integer from 3 to 11. In still other embodiments, the RAFT chain transfer agent will have the formula:

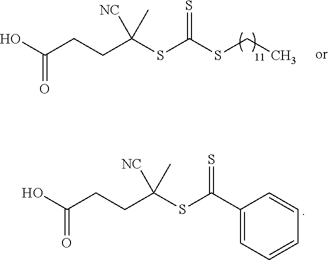

In some embodiments, the chain transfer agent has the formula:

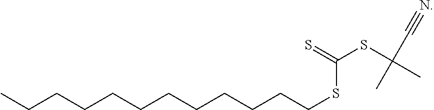 [SMILES: CCCCCCCCCCCCSC(=S)SC(C)(C)C#N]

The initiator may be any free-radical initiator know in the art, provided that it is nontoxic and compatible with the reagents being used. Suitable initiators may include, without limitation, azo compounds (e.g., 2,2′-Azobis(2-methylpropionitrile, AIBN), organic peroxides (e.g., benzoyl peroxide), inorganic peroxides, or combinations thereof. One of ordinary skill in the art will be able to select a free-radical initiator without undue experimentation. In some embodiments, the initiator comprises 2,2′-azobis(2-methylpropionitrile) (AIBN).

The reaction solvent is not particularly limited provided that capable of dissolving, or at least suspending, all of the reagents. In one or more embodiments, the solvent is anhydrous. Further, since the solvent must be removed, it is preferred that the amount of solvent used be minimized and only enough to dissolve or suspend the other reagents be used. Suitable solvents will include toluene, tetrahydrofuran (THF), hexane, dichloromethane, chloroform, and combinations thereof. One of ordinary skill in the art will be able to select a reaction solvent without undue experimentation. In one or more embodiment, the solvent is anhydrous toluene.

In various embodiments, the molar ratio of Fluoro-MA monomer to PDMS-MA monomer in the reaction mixture will be to about 9:1. in other embodiments, about 8:1, in other embodiments, about 7:1, in other embodiments, about 6:1, in other embodiments, about 5:1, in other embodiments, about 4:1, in other embodiments, about 3:1, in other embodiments, about 2:1, and in other embodiments, about 1:1.

In one or more embodiments, the mole percent of chain transfer agent in the reaction mixture will be from about 0.5 mol. % to about 5.0 mol. %. In some embodiments, the amount of chain transfer agent in the reaction mixture will be from about 1 mol. % to about 5 mol. %, in other embodiments, from about 1.5 mol. % to about 5 mol. %, in other embodiments, from about 2 mol. % to about 5 mol. %, in other embodiments, from about 2.5 mol. % to about 5 mol. %, in other embodiments, from about 3 mol. % to about 5 mol. %, in other embodiments, from about 4 mol. % to about 5 mol. %, in other embodiments, from about 0.5 mol. % to about 4 mol. %, in other embodiments, from about 0.5 mol. % to about 3 mol. %, in other embodiments, from about 0.5 mol. % to about 2.5 mol. %, in other embodiments, from about 0.5 mol. % to about 2 mol. %, in other embodiments, from about 0.5 mol. % to about 1.5 mol. %, and in other embodiments, from about 0.5 mol. % to about 1 mol. %.

In various embodiments, the molar percent of free-radical initiator in the reaction mixture will be from about 0.5 mol. % to about 5.0 mol. %. In some embodiments, the amount of free-radical initiator in the reaction mixture will be from about 1 mol. % to about 5 mol. %, in other embodiments, from about 1.5 mol. % to about 5 mol. %, in other embodiments, from about 2 mol. % to about 5 mol. %, in other embodiments, from about 2.5 mol. % to about 5 mol. %, in other embodiments, from about 3 mol. % to about 5 mol. %, in other embodiments, from about 4 mol. % to about 5 mol. %, in other embodiments, from about 0.5 mol. % to about 4 mol. %, in other embodiments, from about 0.5 mol. % to about 3 mol. %, in other embodiments, from about 0.5 mol. % to about 2.5 mol. %, in other embodiments, from about 0.5 mol. % to about 2 mol. %, in other embodiments, from about 0.5 mol. % to about 1.5 mol. %, and in other embodiments, from about 0.5 mol. % to about 1 mol. %.

In the UV blocking embodiments, the mole percent of UV blocking monomer in the reaction mixture will be from about 0.3 mol % to about 5.0 mol. %. In some embodiments, the mole percent of UV blocking monomer in the reaction mixture will be from about 0.5 mol. % to about 5.0 mol. %, in other embodiments, from about 1.0 mol. % to about 5.0 mol. %, in other embodiments, from about 1.5 mol. % to about 5.0 mol. %, in other embodiments, from about 2.0 mol. % to about 5.0 mol. %, in other embodiments, from about 2.5 mol. % to about 5.0 mol. %, in other embodiments, from about 3 mol. % to about 5.0 mol. %. in other embodiments, from about 4.0 mol. % to about 5.0 mol. %, in other embodiments, from about 0.3 mol. % to about 4.0 mol. %, in other embodiments, from about 0.3 mol. % to about 3.0 mol. %, in other embodiments, from about 0.3 mol. % to about 2.5 mol. %, in other embodiments, from about 0.3 mol. % to about 2.0 mol. %, in other embodiments, from about 0.3 mol. % to about 1.5 mol. %, and in other embodiments, from about 0.3 mol. % to about 1.0 mol. %.

In the next step, the sealed reaction vessel is sparged with an inert gas to remove any oxygen that may be present in the reaction vessel. In various embodiments, the sealed reaction vessel is sparged with an inert gas for from about 5 min to about 60 min. The inert gas used is not particularly limited and any inert gas may be used. In some embodiments, the sealed reaction vessel is sparged with nitrogen gas (N₂) gas for from about 20 min to about 30 min.

The reaction vessel is then heated to begin the reaction. The reaction vessel may be heated using any conventional method, including, but not limited to an oil bath or a heating mantle. In some embodiments, the reaction vessel is heated by placing it in an oil bath preheated to 70° C. In various embodiments, the reaction temperature will be between 60° C. and 80° C., preferably between 65° C. and 80° C., and more preferably between 70° C. and 75° C. In some of these embodiments, the reaction temperature is about 70° C. In one or more embodiments, the reaction time is between 6 hours and 24 hours, preferably between 9 hours and 20 hours, and more preferably between 12 hours and 16 hours. In some of these embodiments, the reaction time will between 12 hours and 16 hours.

The reaction is then quenched is then quenched as is known in the art. In some embodiments, the reaction is quenched by opening the reaction vessel to the air and allowing it to cool to room temperature. The yellow-tinted bottlebrush copolymer intermediate thereby produced is then isolated from the reaction mixture and purified as is known in the art. In some embodiments, the polymer solution is then washed with a polar organic solvent, such as methanol to yield a yellow-tinted bottlebrush copolymer intermediate having thiocarbonyl end groups. In some embodiments, the polymer solution is washed by adding an excess of methanol to the polymer solution, vortexing, and then of cooling the mixture in an ice bath for from about 30 seconds to about 30 min to form a biphasic system having a methanol supernatant. In these embodiments, the methanol supernatant is then decanting off to leave a yellow-tinted bottlebrush copolymer intermediate having thiocarbonyl end groups. In various embodiments, this process is repeated from 2 to 4 times before moving on to next step.

During the RAFT polymerization reaction, the PDMS-MA, Fluoro-MA monomers and, if present, UV blocking monomers, will polymerize at a location at or near the center of the RAFT chain transfer agent, splitting the RAFT chain transfer agent, with each half of the RAFT chain transfer agent forming an end group for the bottlebrush copolymer formed. As set forth above, the presence of thiocarbonyl or similar end groups from the RAFT chain transfer agent, give the polymer a yellow tint which is undesirable for optical applications.

To address this, these end groups are removed in a second reaction. In this reaction, the yellow tinted thiocarbonyl end groups are removed with an excess of the initiator, preferably AIBN, to produce the optically clear bottlebrush copolymers or optically clear UV blocking bottlebrush copolymers of the present invention. In some embodiments, the yellow tinted thiocarbonyl end groups are replaced with 2-cyano isobutane (—C(CH₃)₂CN) end groups during the reaction. In one or more embodiments, the yellow tinted bottlebrush copolymer intermediate may be removed and replaced by 2-cyano isobutane (—C(CH₃)₂CN) end groups as shown in Scheme 2, below.

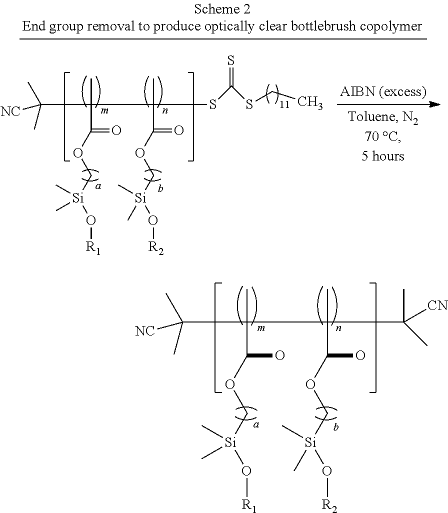

where a and b are each an integer from 1 to 6; m and n are each a mole fraction; and R₁ and R₂ are as shown in Scheme 2, above.

In this reaction, the washed yellow bottlebrush copolymer intermediate and a second quantity of initiator are dissolved in an anhydrous polar solvent, such as toluene. Suitable anhydrous polar solvents may include, without limitation, toluene and methyl ethyl ketone (MEK). In various embodiments, the initiator used to remove the thiocarbonyl end groups will be the same one used for the RAFT polymerization reaction that formed the yellow tinted bottlebrush copolymer intermediate, but this need not be the case and any of the initiators described above may be used. In one or more of these embodiments, the initiator will be AIBN. As set forth above, the initiator is added to the reaction vessel in “excess.” As used herein, an excess amount of the initiator will be a quantity of initiator greater than the amount of initiator that was required for the RAFT polymerization. In one or more embodiment, from 1 eq. to 10 eq. of initiator to the CTA used in RAFT polymerization will be used to remove the yellow tinted thiocarbonyl or thiobenzyl end groups In some embodiments, 3-4 eq. of initiator to the CTA used in RAFT polymerization will be used in this step.

The reaction vessel is then sparged with an inert gas, such as nitrogen gas (N₂) for from 5 min to 1 hour and then heated as described above for from about 2 to about 6 hours. In some embodiments, the reaction mixture is heated for from about 2 h to about 5 h, in other embodiments, from about 2 h to about 4 h, in other embodiments, from about 2 h to about 3 h, in other embodiments, from about 3 h to about 6 h, in other embodiments, from about 4 h to about 6 h, and in other embodiments, from about 5 h to about 6 h. In the embodiment shown in Scheme 2, above, the reaction mixture is heated for about 5 hours to produce the optically clear bottlebrush copolymer or optically clear UV blocking bottlebrush copolymer of the present invention.

The optically clear bottlebrush copolymers or optically clear UV blocking bottlebrush copolymers are then isolated and purified as is known in the art. In some embodiments, the resulting reaction solution is concentrated to remove the toluene and washed with an organic nonpolar solvent, such as methanol, as described above. In these embodiments, the reaction mixture is cooled in an ice bath for from about 30 seconds to about 30 min to form a biphasic system having a methanol supernatant and decanting off the methanol supernatant to leave the optically clear bottlebrush copolymer. In various embodiments, the reaction solution is washed with methanol from 2 to about 5 times. In some embodiments, the polymer is then dissolved in THF and passed through a suitable PTFE filter. In some embodiments, the polymer is passed through a 2 μm PTFE filter. Finally, the filtered polymer is concentrated to remove any trace of solvent and dried under a vacuum for from 6 to 18 hours to produce the optical clear bottlebrush copolymer. The resulting polymers are optically clear, as shown in FIGS. 1A-B.

In one or more embodiment, the method of the present invention comprises: combining one or more acryloxy or monomethacryloxypropyl-terminated polydimethylsiloxane, asymmetric (PDMS-MA), one or more acryloxy or monomethacryloxypropyl-terminated poly(3,3,3-trifluoropropyl)methylsiloxane, asymmetric (Fluoro-MA), a chain transfer agent suitable for RAFT polymerization reactions; an initiator, and an anhydrous solvent in a sealed reaction vessel; sparging the reaction mixture with an inert gas and heating it for from about 12 hours to about 24 hours; quenching the reaction by opening the reaction vessel to the air and allowing it to cool; washing the resulting mixture with a polar organic solvent to produce a yellow bottlebrush copolymer intermediate having yellow thiocarbonyl end groups; dissolving the yellow bottlebrush copolymer intermediate and an initiator in a suitable anhydrous solvent in a sealed reaction vessel; sparging the reaction mixture with an inert gas and heating it for from about 2 hours to about 6 hours; concentrating the reaction mixture to remove the anhydrous solvent and washing to produce an optically clear bottlebrush copolymer.

In another embodiment, the method of the present invention comprises: combining one or more acryloxy or monomethacryloxypropyl-terminated polydimethylsiloxane, asymmetric (PDMS-MA), one or more acryloxy or monomethacryloxypropyl-terminated poly(3,3,3-trifluoropropyl)methylsiloxane, asymmetric (Fluoro-MA), one or more 2-[3-(2H-Benzotriazol-2-yl)-4-hydro-xyphenyl]ethyl methacrylate (BTAMA) monomer, a chain transfer agent suitable for RAFT polymerization reactions; an initiator, and an anhydrous solvent in a sealed reaction vessel; sparging the reaction mixture with an inert gas and heating it for from about 12 hours to about 24 hours; quenching the reaction by opening the reaction vessel to the air and allowing it to cool; washing the resulting mixture with a polar organic solvent to produce a yellow bottlebrush copolymer intermediate having yellow thiocarbonyl end groups; dissolving the yellow bottlebrush copolymer intermediate and an initiator in a suitable anhydrous solvent in a sealed reaction vessel; sparging the reaction mixture with an inert gas and heating it for from about 2 hours to about 6 hours; concentrating the reaction mixture to remove the anhydrous solvent and washing to produce an optically clear UV blocking bottlebrush copolymer.

In another aspect, the present invention is directed to a molecular fluid filling material for use in an artificial lens comprising the optically clear bottlebrush copolymers described above. In these embodiments, the optically clear bottlebrush copolymers of the present invention will have a refractive index of from about 1.39 to about 1.48, preferably from about 1.40 to about 1.46, and more preferably from about 1.42 to about 1.46 and a complex viscosity of from about 0.5 to about 50 Pa·s. In some embodiments, the artificial lens is an accommodating intraocular lens (A-IOL) or a presbyopia-correcting IOL. Advantageously, little or no solvent or other diluent is required to obtain a suitable viscosity for use in an artificial lens. In some embodiments, the filler material of the present invention is free of any solvent or diluent.

In yet another aspect, the present invention is directed to an intraocular lens comprising the optically clear bottlebrush copolymers described above. In one or more embodiments, the optically clear, biostable bottlebrush copolymers of the present invention may be used to create an A-IOL having a thin flexible shell and a filling material comprising the optically clear, biostable bottlebrush copolymers. When the ciliary muscles of the eye contract during accommodation, the flexible lens will change shape such that the power of the lens will increase and allow the patient to focus at near. Once the muscles of accommodation relax, the lens will resume its baseline shape, allowing the patient to see at distance.

In some embodiments, the artificial lens will be an accommodating intraocular lens (A-IOL). In some embodiments, the intraocular lens will not be accommodating. In some embodiments, the artificial lens will be a custom-molded lens, made specifically for one patient's eye. In some embodiments, the IOL may be an intraocular lens as described in U.S. Pat. No. 10,278,810, US Patent Application Publication 2019/0321163 A1, or International Application Number PCT/US20/52316, or International Application Number PCT/US22/30255, the disclosures of which are incorporated herein by reference in their entirety. In some embodiments, the artificial lens is an accommodating intraocular lens (A-IOL) or a presbyopia-correcting IOL.

The natural lens loses its elasticity over time, growing thicker and less flexible leading to presbyopia. With age, the lens becomes thicker and more opaque, leading to blurred vision and cataracts. The artificial lens according to the present invention is implanted in the eye of a patient to replace a lens that has become thicker, less flexible, and more opaque with age. This A-IOL should have a refractive index (nr) between 1.40-1.48 and complex viscosity to allow it to be deformed by the muscles of the eye to allow the eye to focus. The present disclosure provides a solution for presbyopia and cataracts with an accommodating intraocular lens that can change shape in response to the muscles of accommodation and obviate the need for eyeglasses and contact lenses by providing clear vision over a range of distances.

All publications, patent applications, patents, and other references mentioned herein are expressly incorporated by reference in their entirety, which means that they should be read and considered by the reader as part of this text. That the document, reference, patent application, or patent cited in this text is not repeated in this text is merely for reasons of conciseness. In the case of conflict, the present disclosure, including definitions, will control. All technical and scientific terms used herein have the same meaning, unless otherwise indicated.

### EXAMPLES

The following examples are offered to more fully illustrate the invention, but are not to be construed as limiting the scope thereof. Further, while some of examples may include conclusions about the way the invention may function, the inventor do not intend to be bound by those conclusions, but put them forth only as possible explanations. Moreover, unless noted by use of past tense, presentation of an example does not imply that an experiment or procedure was, or was not, conducted, or that results were, or were not actually obtained. Efforts have been made to ensure accuracy with respect to numbers used (e.g., amounts, temperature), but some experimental errors and deviations may be present. Unless indicated otherwise, parts are parts by weight, molecular weight is weight average molecular weight, temperature is in degrees Centigrade, and pressure is at or near atmospheric.

### Example 1

To more fully illustrate and reduce the invention to practice, optically clear bottlebrush copolymers according to embodiments of the present invention were synthesized as set forth above from PDMS-MA and Flouro-MA monomers in various proportions and their molecular masses, molecular mass distributions, complex viscosity, and refractive index were evaluated by ¹H NMR (500 MHz), Size Exclusion Chromatograph (SEC), Discovery Hybrid Rheometer, and refractometer.

### I. GENERAL INFORMATION

### a. Materials

Toluene, methanol (MeOH), tetrahydrofuran (THF), chloroform-d (CDCl₃), basic alumina, and 2-cyano-2-propyl dodecyl trithiocarbonate (chain transfer agent, CTA) were purchased from Sigma-Aldrich (St. Louis, MO) and used as received. 2,2′-azobis(2-methylpropionitrile) (AIBN), also purchased from Sigma-Aldrich (St. Louis, MO), was recrystallized before use (MeOH, 50° C. to 0° C.). Both macromonomers—monomethacryloxypropyl-terminated polydimethylsiloxane, asymmetric (PDMS-MA) and monomethacryloxypropyl-terminated poly(3,3,3-trifluoropropyl)methylsiloxane, asymmetric (Fluoro-MA)-were purchased from Gelest; each was purified before use by passing through a plug of basic alumina to remove any inhibitor.

### b. Characterization

¹H NMR (500 MHz) spectra were obtained using a Bruker 500 MHz NMR spectrometer operated at room temperature (RT). All chemical shifts are reported in ppm (δ) and referenced to the chemical shifts of residual solvent resonances (CDCl₃ ¹H: δ=7.26 ppm). Rheology measurements were obtained with a Discovery Hybrid Rheometer (DHR, TA Instruments, New Castle, DE, USA).

Size Exclusion Chromatograph (SEC) was performed on all samples using an EcoSEC HLC-8320GPC (Tosoh Bioscience LLC, King of Prussia, PA) equipped with a TSKgel GMH_{HR}-M mixed bead column and refractive index (RI) detector. Molecular masses and molecular mass distributions were calculated using a calibration curve determined from polystyrene standards (PStQuick MP-M standards, Tosoh Bioscience, LLC) in THF.

### II. SYNTHETIC PROCEDURES

Optically clear bottlebrush copolymers having 60 mol. %, 70 mol. %, 80 mol. %, and 90 mol. % Fluoro-MA units were synthesized using the two-step process generally shown in Scheme 3, below.

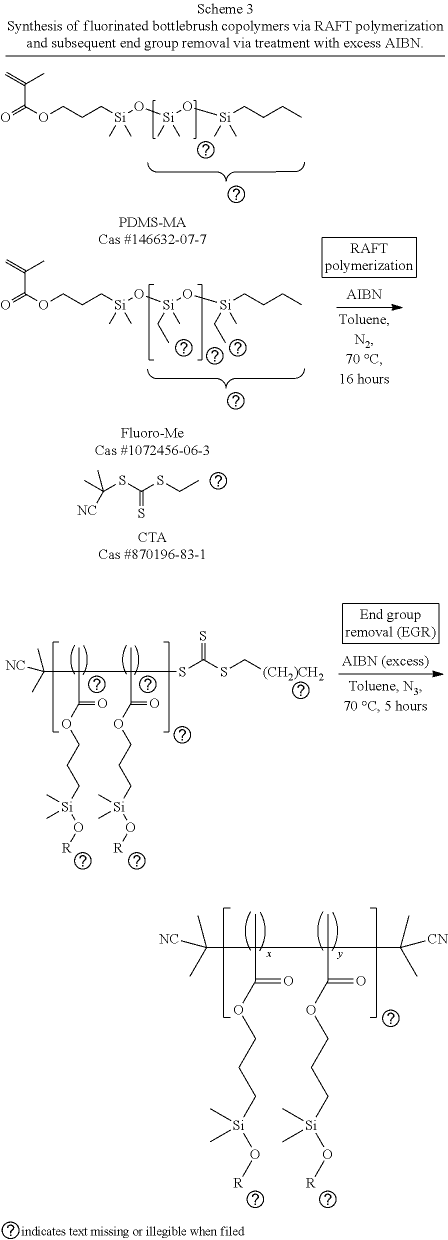

### a. General Procedure for RAFT Polymerization

A series of optically clear bottlebrush copolymers having 60 mol. %, 70 mol. %, 80 mol. %, and 90 mol. % Fluoro-MA units and a degree of polymerization of about 50 (see Tables 1-4, below) were synthesized as shown in Scheme 4, below. ° C.

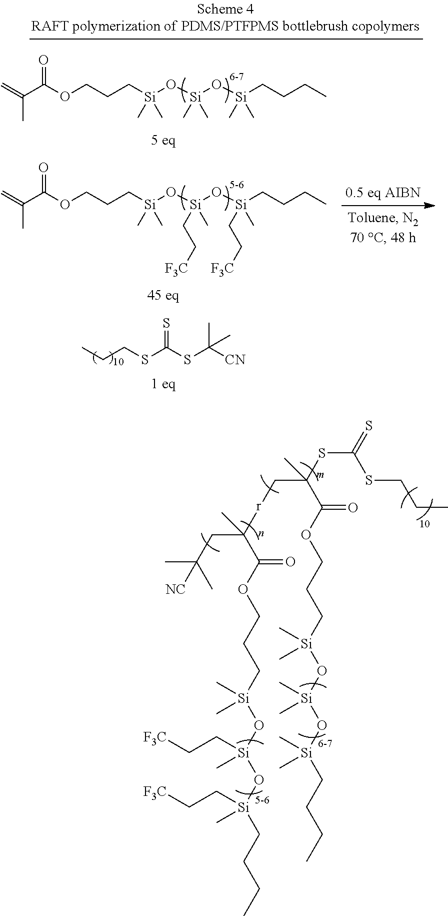

¹H NMR and ¹³C NMR spectra of 2-cyano-2-propyl dodecyl trithiocarbonate RAFT CTA are shown in FIGS. 14 and 15. ¹H NMR and ¹³C NMR spectra of ¹H NMR of monomethacryloxypropyl-terminated polydimethylsiloxane, asymmetric (PDMS-MA) monomer shown in Scheme 4 above are shown in FIGS. 16 and 17. ¹H NMR and ¹³C NMR spectra of the monomethacryloxypropyl-terminated poly(3,3,3-trifluoropropylmethylsiloxane) (PTFPMS) monomer shown in Scheme 4 above are shown in FIGS. 18, 19, 20 and 21.

Copolymerization of 90 mol. % Fluoro-MA/10 mol. % PMDS-MA (DP=50) taken as example. Fluoro-MA (11.0 mL, 8.0 mmol, 45 eq), PMDS-MA (0.649 mL, 0.89 mmol, 5 eq), AIBN (14.6 mg, 0.41 mmol, 0.5 eq), CTA (61.5 mg, 0.18 mmol, 1 eq), and toluene (5 mL) were added to a single-neck, round-bottomed flask. The reaction mixture was sparged with N₂ for 40 minutes and submerged in an oil bath heated to 70° C. for 48 h. The reaction mixture was quenched by exposure to air, allowed to cool to 23° C., and dried with a rotary evaporator. The resulting viscous yellow oil was washed with methanol, cooled in an ice bath, and decanted three times. The product was dissolved in THF and concentrated using a rotary evaporator.

### b. General procedure for End Group Removal (EGR)

The yellow thiocarbonyl end groups were removed from the polymers via treatment with excess AIBN, as shown in Scheme 5, below.

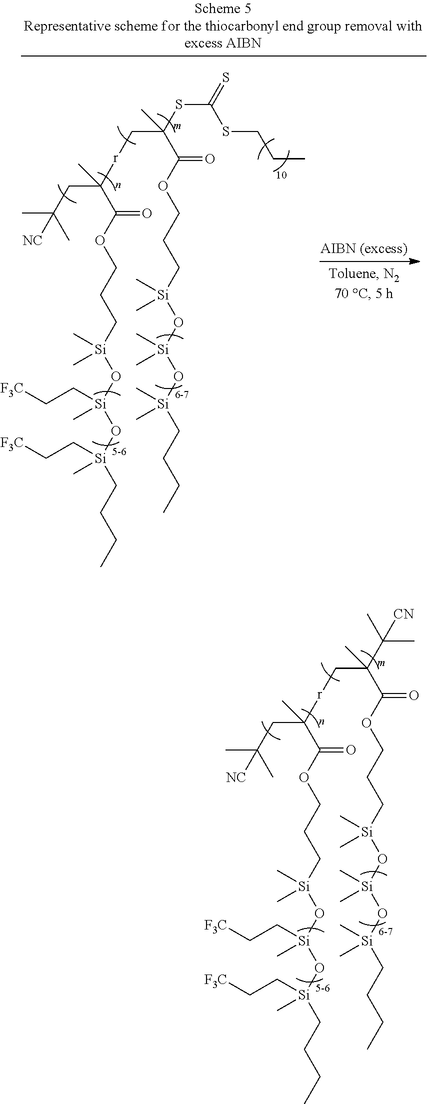

where n, m, and x are mole fractions and n+m+x=1.00.

Yellow bottlebrush copolymer (approx. 2 g, 0.04 mmol, 1 eq.) and AIBN (approx. 20 mg, 0.12 mmol, 3-4 eq. to the CTA used in RAFT polymerization) were dissolved in anhydrous toluene (10 mL). The reaction was sparged with N₂ for 30-40 minutes, then heated to 70° C. for approximately 5 hours. Then, the reaction solution was concentrated under reduced pressure to remove the toluene, then subsequently washed with MeOH (approx. 10 mL, 4-5x), similarly to the RAFT workup. After, polymer was dissolved in THF, passed through a 0.2 μm PTFE filter, then concentrated to remove any trace solvent, then dried on high vacuum overnight to yield a colorless viscous oil. ¹H NMR (CDCl₃, 500 MHz) confirmed 69% incorporation of the fluorinated monomer, Fluoro-MA.

### c. Reagents and Quantities Used for the 60 mol. %, 70 mol. %, 80 mol. %, and 90 mol. % Fluoro-MA Polymers

The reagents and specific quantities used for the 60 mol. %, 70 mol. %, 80 mol. %, and 90 mol. % Fluoro-MA polymers described below are set forth in Tables 1-4, below.

TABLE 1
60% Fluoro-MA incorporation, d.p. = 50

| | Molar Mass | | | | |
|---|---|---|---|---|---|
| Reagent | (g/mol) | Equiv. | Mass | Volume | mmol |
| PDMS-MA | 600-800 | 19 | — | 0.5 mL | 0.690 |
| Fluoro-MA | 1200-1800 | 31 | — | 1.5 mL | 1.090 |
| CTA | 345 | 1 | 12.3 mg | — | 0.036 |
| AIBN | 164 | 0.5 | 2.9 mg | — | 0.018 |
| Toluene | — | 0.5 g/mL | — | 1 mL | — |

All polymers then subjected to EGR using excess AIBN (approximately 20 mg, 0.121 mmol, 4 eq. to the CTA used during RAFT polymerization) as set forth above.

TABLE 2
70% Fluoro-MA incorporation, d.p. = 50

| | Molar Mass | | | | |
|---|---|---|---|---|---|
| Reagent | [g/mol] | Equiv. | Mass | Volume | mmol |
| PDMS-MA | 600-800 | 13 | — | 0.3 mL | 0.411 |
| Fluoro-MA | 1200-1800 | 37 | — | 1.7 mL | 1.235 |
| CTA | 345 | 1 | 11.4 mg | — | 0.033 |
| AIBN | 164 | 0.5 | 2.7 mg | — | 0.017 |
| Toluene | — | 0.5 g/mL | — | 1 mL | — |

All polymers then subjected to EGR using excess AIBN (approximately 20 mg, 0.121 mmol, 4 eq. to the CTA used during RAFT polymerization) as set forth above.

TABLE 3
80% Fluoro-MA incorporation, d.p. = 50

| | Molar Mass | | | | |
|---|---|---|---|---|---|
| Reagent | [g/mol] | Equiv. | Mass | Volume | mmol |
| PDMS-MA | 600-800 | 9 | — | 0.2 mL | 0.274 |
| Fluoro-MA | 1200-1800 | 41 | — | 1.8 mL | 1.308 |
| CTA | 345 | 1 | 10.9 mg | — | 0.032 |
| AIBN | 164 | 0.5 | 2.6 mg | — | 0.016 |
| Toluene | — | 0.5 g/mL | — | 1 mL | — |

All polymers then subjected to EGR using excess AIBN (approximately 20 mg, 0.121 mmol, 4 eq. to the CTA used during RAFT polymerization) as set forth above.

TABLE 4
90% Fluoro-MA incorporation, d.p. = 50

| | Molar Mass | | | | |
|---|---|---|---|---|---|
| Reagent | [g/mol] | Equiv. | Mass | Volume | mmol |
| PDMS-MA | 600-800 | 5 | — | 0.1 mL | 0.137 |
| Fluoro-MA | 1200-1800 | 45 | — | 1.9 mL | 1.381 |
| CTA | 345 | 1 | 10.5 mg | — | 0.030 |
| AIBN | 164 | 0.5 | 2.5 mg | — | 0.015 |
| Toluene | — | 0.5 g/mL | — | 1 mL | — |

All polymers then subjected to EGR using excess AIBN (approximately 20 mg, 0.121 mmol, 4 eq. to the CTA used during RAFT polymerization) as set forth above.

### III. BOTTLEBRUSH COPOLYMER CHARACTERIZATION

Rheology measurements for the 60F-50, 70F-50, 80F-50, and 90F-50 bottlebrush copolymers were obtained using a Discovery Hybrid Rheometer (DHR, TA Instruments, New Castle, DE, USA). The complex viscosity (η) results are shown in Table 5 below and in FIGS. 22-26.

Refractive indices for the 60F-50, 70F-50, 80F-50, and 90F-50 bottlebrush copolymers were measured with Bellingham-Stanley Ltd. RFM 340 refractometer. The liquid bottlebrush samples were placed on the refractometer heated to 37° C. after calibrating with benzyl methacrylate (1.512) and DI water (1.33) at 37° C. The results are shown in Table 5 below and in FIGS. 27A-B . . .

TABLE 5

RI

| | With CTA | Without CTA |
|---|---|---|
| | end group | end group |
| 0F-50FBB | 1.42998 | 1.42984 |
| 60F-50 | 1.41103 | 1.41084 |
| 70F-50 | 1.40848 | 1.40867 |
| 80F-50 | 1.4085 | 1.40712 |
| 90F-50 | 1.40518 | 1.40574 |

¹H NMR (500 MHz) spectra were obtained for the 60F-50, 70F-50, 80F-50, and 90F-50 bottlebrush copolymers using a Bruker 500 MHz NMR spectrometer operated at room temperature (RT). All chemical shifts are reported in ppm (δ) and referenced to the chemical shifts of residual solvent resonances (CDCl₃ ¹H: δ=7.26 ppm). The ¹H NMR spectra for the 60F-50, 70F-50, 80F-50, and 90F-50 bottlebrush copolymers are shown in FIGS. 3-6.

UV-Vis spectra for the 60F-50, 70F-50, 80F-50, and 90F-50 bottlebrush copolymers were collected with a Shimadzu UV-3600i with a 1 cm pathlength quartz cuvette across a 300-600 nm spectral range. The spectrophotometer was zeroed using a chloroform blank. The samples were allowed to dissolve overnight in chloroform, at concentration ~5 mg/mL and filtered through a 0.22 μm PTFE filter. The results are shown in FIGS. 28A-B.

Size Exclusion Chromatography (SEC) for the 60F-50, 70F-50, 80F-50, and 90F-50 bottlebrush copolymers was performed using a Tosoh Bioscience EcoSEC HCL-8320GPC equipped with a TSKgel GMH_{HR}-M mixed bead column and MALS detector. Molecular masses (Mₙ) and dispersity (D) were calculated using a polystyrene standard calibration curve (PStQuick MP-M) in THF. The samples were allowed to dissolve overnight in THE, at concentration ~2 mg/mL and filtered through a 0.22 μm PTFE filter. Size Exclusion Chromatography (SEC) traces for the 60F-50, 70F-50, 80F-50, and 90F-50 bottlebrush copolymers are shown in FIG. 29A-D.

Bottlebrush copolymer IDs are named (Table 5) according to the mole percentage of Fluoro-MA used in the monomer feed during polymerization, followed by the targeted degree of polymerization (d.p.). Because each of the two macromonomers have varying chain lengths, and therefore varying molar masses (600-800 g/mol and 1200-1800 g/mol of PDMS-MA and Fluoro-MA, respectively), the actual percent incorporation of Fluoro-MA (F %) was subsequently determined by ¹H NMR. An example spectrum for 60F-50 is pictured in FIG. 2. F % may be estimated by integration of the resonances for the methyl siloxane protons (labeled below as f, g, and h for the PDMS branch, and f′, g′, and h′ for the fluoro branch), with the —Si—CH₂—CH₂—CF₃ protons (labeled below as m, n, o, and p), characteristic to only the fluoro monomer branch.

### Example 2

To more fully illustrate and reduce the invention to practice, optically clear PDMS-PTFPMS-BTAMA bottlebrush copolymers according to embodiments of the present invention were synthesized as set forth above from PDMS-MA, Flouro-MA, and BTAMA monomers. Samples of the PDMS-PTFPMS-BTAMA bottlebrush copolymers having 0.5 mol. %, 1.0 mol. % and 2.0 mol. % BTAMA were synthesized and their structure, molecular mass, molecular mass distribution, complex viscosity, and refractive index were evaluated by ¹H NMR (500 MHz), ¹³C NMR, ¹⁹F NMR, Size Exclusion Chromatograph (SEC), UV-Vis spectroscopy, Discovery Hybrid Rheometer, and refractometer.

### I. Materials for PDMS-PTFPMS-BTAMA Bottlebrush Copolymer

Toluene, methanol, tetrahydrofuran (THF), chloroform-d (CDCl₃), basic alumina (activated, Brockmann I) (CAS Number: 1344-28-1), 2-[3-(2H-Benzotriazol-2-yl)-4-hydro-xyphenyl]ethyl methacrylate (99%, “BTAMA”) (CAS Number: 96478-09-0) and 2-cyano-2-propyl dodecyl trithiocarbonate (97%, “CTA”) (CAS Number: 870196-83-1), were purchased from Sigma-Aldrich and used as received. Azobisisobutyronitrile (98%, AIBN) was purchased from Sigma-Aldrich and recrystallized from methanol before use. Monomethacryloxypropyl-terminated polydimethylsiloxane, asymmetric (PDMS-MA) (CAS Number: 146632-07-7) and monomethacryloxypropyl-terminated poly(3,3,3-trifluoropropylmethylsiloxane) (PTFPMS), asymmetric (Fluoro-MA) (CAS Number: 1072456-05-3) were purchased from Gelest and purified with a basic alumina plug before use.

### II. Synthesis of the PDMS-PTFPMS-BTAMA Bottlebrush Copolymer

The PDMS-PTFPMS-BTAMA bottlebrush copolymer intermediate was formed as shown in Scheme 6 below.

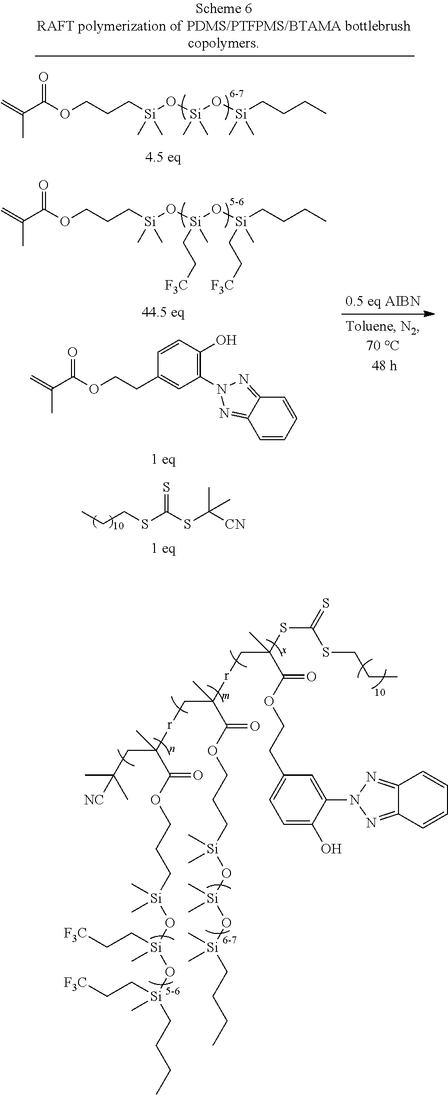

where n, m, and x are mole fractions and n+m+x=1.00. ¹H NMR and ¹³C NMR spectra of the 2-[3-(2H-benzotriazol-2-yl)-4-hydroxyphenyl]ethyl methacrylate UV chromophore (BTAMA) monomer are attached as FIGS. 30, 31 ¹H NMR and ¹³C NMR spectra of the Chain transfer agent and the PDMS-MA and Flouro-MA monomers are shown in FIGS. 14-20.

In these experiments, copolymerization of 89 mol. % Fluoro-MA/10 mol. % PMDS-MA/1 mol. % BTAMA (DP=50) was taken as an example. Fluoro-MA (10.9 mL, 7.9 mmol, 44.5 eq), PMDS-MA (0.642 mL, 0.88 mmol, 5 eq), BTAMA (28.8 mg, 0.09 mmol, 0.5 eq), AIBN (14.6 mg, 0.41 mmol, 0.5 eq), CTA (61.5 mg, 0.18 mmol, 1 eq), and toluene (5 mL) were added to a single-neck, round-bottomed flask. The reaction mixture was sparged with N₂ for 40 minutes and submerged in an oil bath heated to 70° C. for 48 h. The reaction mixture was then quenched by exposure to air, allowed to cool to 23° C., and dried with a rotary evaporator. The resulting viscous yellow oil was washed with cold methanol, cooled in an ice bath, and decanted three times. The product was dissolved in THF and concentrated using a rotary evaporator to produce the PDMS-PTFPMS-BTAMA bottlebrush copolymer intermediate. The resulting PDMS-PTFPMS-BTAMA bottlebrush copolymer intermediate will have 1.0 mol % BTAMA. For comparison, the same procedure was used with appropriate amounts of BTAMA to make PDMS-PTFPMS-BTAMA bottlebrush copolymer intermediate having 0.5 mol. % and 2.0 mol. % BTAMA.

### III. Bottlebrush CTA Fragment End Group Removal

To improve optical clarity, the yellow thiocarbonyl chain ends were removed from the PDMS-PTFPMS-BTAMA bottlebrush copolymer intermediates via treatment with excess AIBN, as shown in Scheme 7 below.

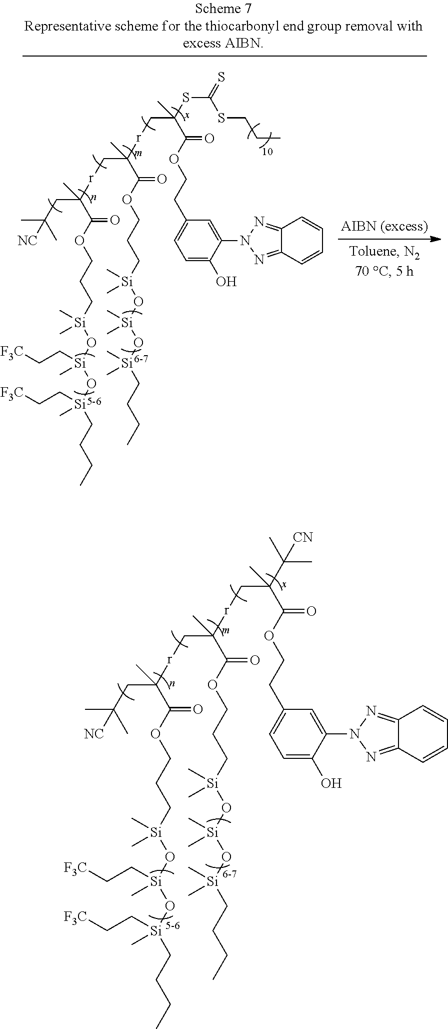

Here, the PDMS-PTFPMS-BTAMA bottlebrush copolymer intermediate (approx. 2 g, 0.04 mmol, 1 eq.) and AIBN (approx. 20 mg, 0.12 mmol, 3-4 eq. to the CTA used in RAFT polymerization) were dissolved in toluene (10 mL). The reaction mixture was sparged with N₂ for 30-40 minutes, then heated to 70° C. for 5 h. The reaction mixture was then concentrated using a rotary evaporator and washed with methanol using the same procedure described above. This procedure was performed three times for each sample. The resulting clear and colorless oil was dissolved in THF, passed through a 1 mm PTFE filter, concentrated, then dried in vacuo for 48 h to produce the optically clear UV blocking PDMS-PTFPMS-BTAMA bottlebrush copolymers having 0.5 mol. %, 1.0 Mol. %, and 2.0 mol. % BTAMA. For clarity, the three samples will be referred to herein as 0.5% BTAMA, 1.0% BTAMA, and 2.0% BTAMA.

### IV. ANALYTICAL METHODS

Nuclear magnetic resonance (NMR) spectroscopy was performed on the 0.5% BTAMA, 1.0% BTAMA, and 2.0% BTAMA optically clear UV blocking PDMS-PTFPMS-BTAMA bottlebrush copolymers in CDCl₃ using a 600 MHz Bruker Avance III at 23° C. as shown in Table 6, below.

TABLE 6

| | ¹H | ¹³C |
|---|---|---|
| Number of scans | 16 | 1024 |
| Dummy scans | 2 | 4 |
| Size of fid | 65536 | 65536 |
| Pulse width (μsec) | 12.2 | 9.8 |
| Relaxation delay (sec) | 1 | 2 |
| Spectral width (ppm) | 20.0433 | 239.11 |
| Center of spectrum | 6.175 | 99.995 |
| Sample temperature (k) | 298 | 298 |

Rheological experiments were performed on the 0.5% BTAMA, 1.0% BTAMA, and 2.0% BTAMA optically clear UV blocking PDMS-PTFPMS-BTAMA bottlebrush copolymers using a TA Instruments DHR-3 at 37° C., including amplitude sweep (angular frequency at 10 rad/s, strain between 0.001% and 1000%), frequency sweep (strain at 10%, angular frequency between 0.01 rad/s and 500 rad/s) and flow sweep (shear rate between 0.1 l/s and 1000 l/s). These measurements were made on a Smart Swap™ geometry with 20 mm disposable aluminum parallel plates with a 200 μm gap. Measurement parameters were set with a sampling frequency of 1 Hz and 0.1% strain. Samples used were dried in vacuo to ensure dryness before analysis. Complex viscosity was determined from flow sweep at shear rate 1 l/s. Typical values fell between 9-20 Pa*s dependent on composition and molecular weight. The results are shown in FIGS. 32A-C, 34A, 33A, 33C, 35A, and 35C.

UV-Vis spectra for the 0.5% BTAMA, 1.0% BTAMA, and 2.0% BTAMA optically clear UV blocking PDMS-PTFPMS-BTAMA bottlebrush copolymers were collected with a Shimadzu UV-3600i at 0.5 mg/mL with a 1 cm pathlength quartz cuvette across a 300-600 nm spectral range. The spectrophotometer was zeroed using a chloroform blank. The samples were allowed to dissolve overnight in chloroform, at concentration ~5 mg/mL and filtered through a 0.22 μm PTFE filter. The results are shown in FIGS. 28A-B, 36, and 37A-B.

Refractive indices for the 0.5% BTAMA, 1.0% BTAMA, and 2.0% BTAMA optically clear UV blocking PDMS-PTFPMS-BTAMA bottlebrush copolymers were measured with Bellingham-Stanley Ltd. RFM 340 refractometer. The liquid bottlebrush samples were placed on the refractometer heated to 37° C. after calibrating with benzyl methacrylate (1.512) and DI water (1.33). The results are reported in Table 8 and shown in FIGS. 27A-B, 33B, and 35B

TABLE 8

| Bottlebrush Copolymer | RI |
|---|---|
| 0.5% BTAMA | 1.40542 |
| 1% BTAMA | 1.40638 |
| 2% BTAMA | 1.40686 |

Size Exclusion Chromatography (SEC) for the 0.5% BTAMA, 1.0% BTAMA, and 2.0% BTAMA optically clear UV blocking PDMS-PTFPMS-BTAMA bottlebrush copolymers was performed using a Tosoh Bioscience EcoSEC HCL-8320GPC equipped with a TSKgel GMH_{HR}-M mixed bead column and MALS detector. Molecular masses (Mₙ) and dispersity (D) were calculated using a polystyrene standard calibration curve (PStQuick MP-M) in THE. The samples were allowed to dissolve overnight in THF, at concentration ~2 mg/mL and filtered through a 0.22 μm PTFE filter. The results are shown in FIGS. 29A-D, 33C, 35C.

### V. CONCLUSIONS

Collectively, these methods and fluoropolymer bottlebrush materials have afforded a molecular fluid that does not disperse in water, does not form an emulsion, and had a refractive index that make it suitable for optical applications. The refractive index can be tuned precisely with molecular composition of the fluorinated methacrylate. The viscosity of the bottle brush is low enough to enable fast fluid flow to eliminate resistance to movement during the shape change of the implanted lens. Also, the inclusion of a UV blocking agent does not change the properties of the fluorinated bottlebrush significantly.

In light of the foregoing, it should be appreciated that the present invention significantly advances the art by providing an optically clear bottlebrush copolymer that is structurally and functionally improved in a number of ways. While particular embodiments of the invention have been disclosed in detail herein, it should be appreciated that the invention is not limited thereto or thereby inasmuch as variations on the invention herein will be readily appreciated by those of ordinary skill in the art. The scope of the invention shall be appreciated from the claims that follow.

1. An optically clear bottlebrush copolymer comprising one or more monomethacryloxy terminated polydimethylsiloxane (PDMS-MA) units and one or more monomethacryloxy terminated fluorinated siloxane (Fluoro-MA) units.

2. The optically clear bottlebrush copolymer of claim 1 wherein the PDMS-MA units are the residue of monomers having a formula selected from: 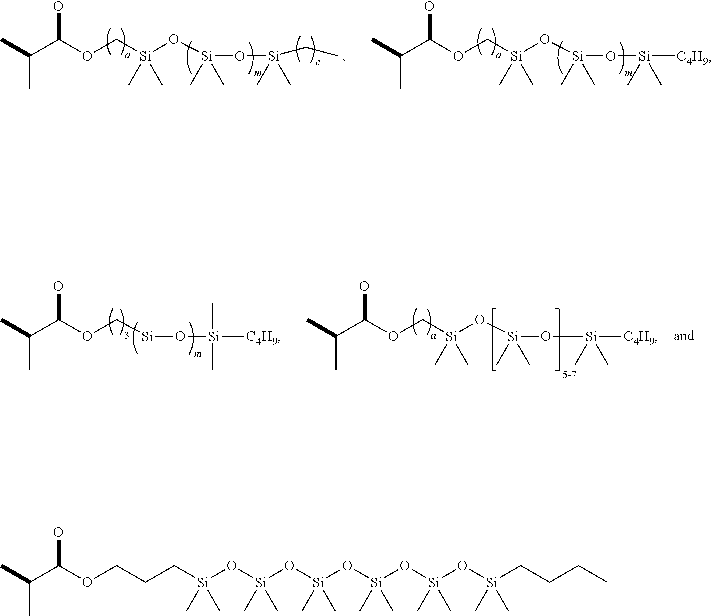
where a is an integer from about 1 to about 6; c is an integer from 1 to 5; and m is an integer from about 2 to about 20.

3. The optically clear bottlebrush copolymer of claim 1 wherein the PDMS-MA units comprise the residue of monomethacryloxypropyl-terminated polydimethylsiloxane, asymmetric monomers.

4. The optically clear bottlebrush copolymer of claim 1 wherein the Fluoro-MA units are the residue of monomers having a formula selected from: 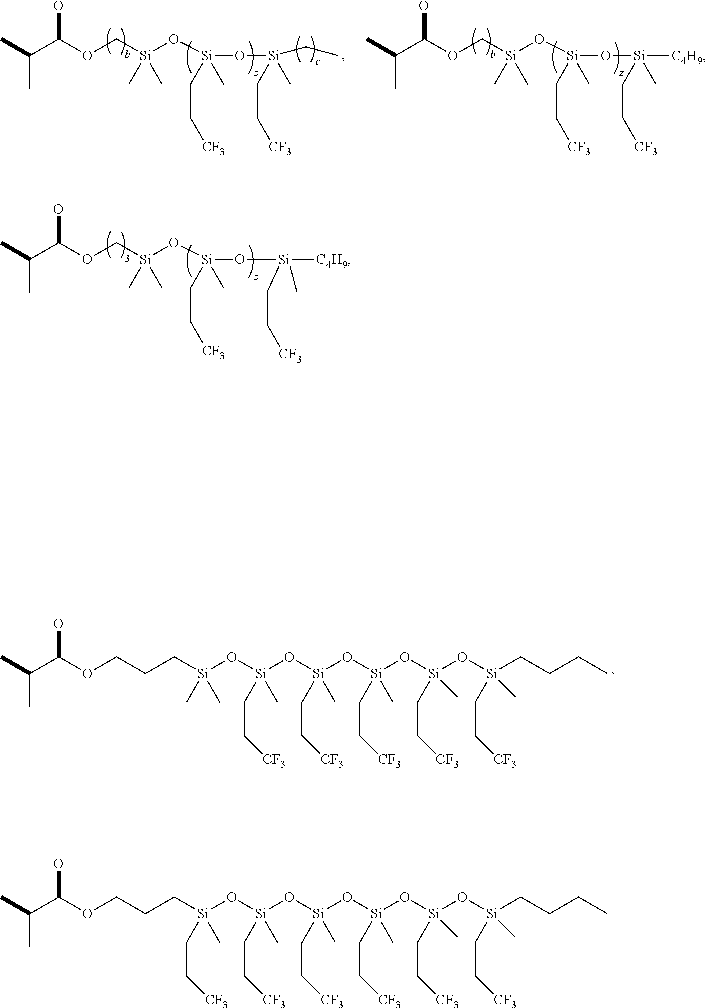
where b is an integer from about 1 to about 6; c is an integer from 1 to 5; and z is an integer from about 2 to about 20.

5. The optically clear bottlebrush copolymer of claim 1 wherein the Fluoro-MA units are the residue of monomethacryloxypropyl-terminated poly(3,3,3-trifluoropropyl)methylsiloxane, asymmetric monomers.

6. The optically clear bottlebrush copolymer of claim 1 further comprising one or more terminal 2-cyano isobutane (—C(CH₃)₂CN) groups.

7. The bottlebrush copolymer of claim 1 containing from about 50 mol. % to about 99 mol. % Fluoro-MA units.

8. The optically clear bottlebrush copolymer of claim 1 containing about 90 mol. % Fluoro-MA units.

9. The optically clear bottlebrush copolymer of claim 1 comprising a random copolymer of monomethacryloxypropyl-terminated polydimethylsiloxane, asymmetric and monomethacryloxypropyl-terminated poly(3,3,3-trifluoropropyl)methylsiloxane, asymmetric.

10. (canceled)

11. (canceled)

12. The optically clear bottlebrush copolymer of claim 1 having a complex viscosity (η) at 37° C. of from about 5 Ps·s to about 15 Ps·s.

13. The optically clear bottlebrush copolymer of claim 1 having a complex viscosity (η) at 37° C. of from 14 Ps·s to 15 Ps·s, as measured by a rheometer.

14. The optically clear bottlebrush copolymer of claim 1 having the formula selected from: 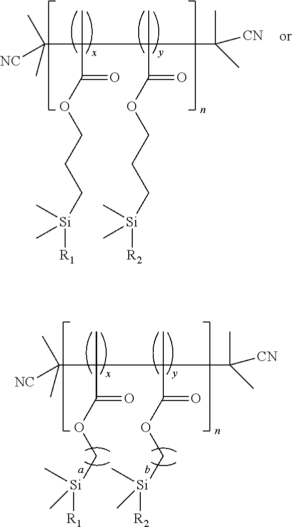
where R₁ is a siloxane; R₂ is a fluorinated siloxane; x is a mole fraction from about 0.99 to about 0.01; y is a mole fraction from about 0.01 to about 0.99; n is the degree of polymerization from about 10 to about 200; a is an integer from about 1 to about 6; b is an integer from about 1 to about 6; and x+y=1.00.

15. The optically clear bottlebrush copolymer of claim 1 having a formula selected from: 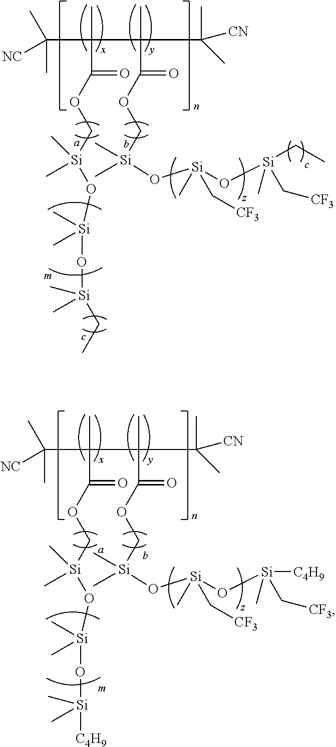 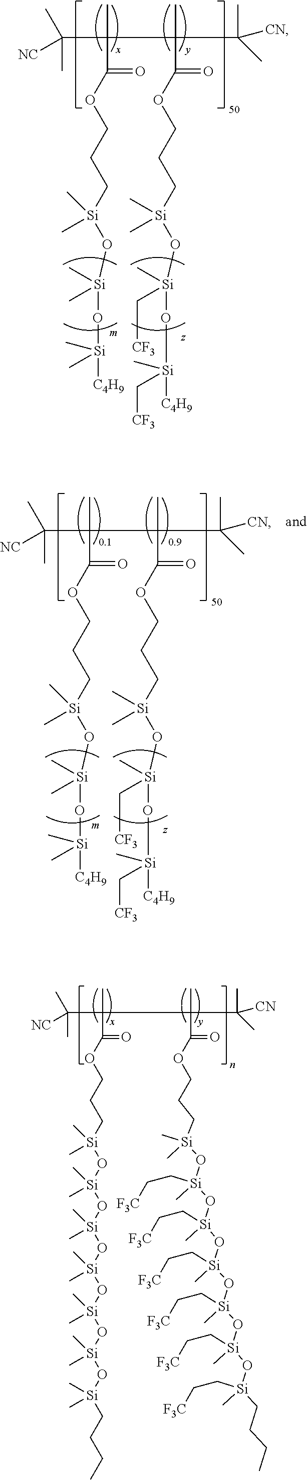
where x is a mole fraction from about 0.99 to about 0.01; y is a mole fraction from about 0.01 to about 0.99; n is the degree of polymerization from about 10 to about 200; a is an integer from about 1 to about 6; b is an integer from about 1 to about 6; c is an integer from 1 to 6; m is an integer from about 2 to about 20; and z is an integer from about 2 to about 20; and x+y=1.00.

16. (canceled)

17. The optically clear bottlebrush copolymer of claim 1 further comprising one or more UV blocking dye units.

18. The optically clear bottlebrush copolymer of claim 17 wherein said one or more UV blocking dye units are the residue of 2-[3-(2H-Benzotriazol-2-yl)-4-hydro-xyphenyl]ethyl methacrylate (BTAMA) monomers.

19. The optically clear bottlebrush copolymer of claim 17 containing from about 0.1 mol. % to about 5 mol. % BTAMA units.

20. (canceled)

21. The optically clear bottlebrush copolymer of claim 17 having the formula: 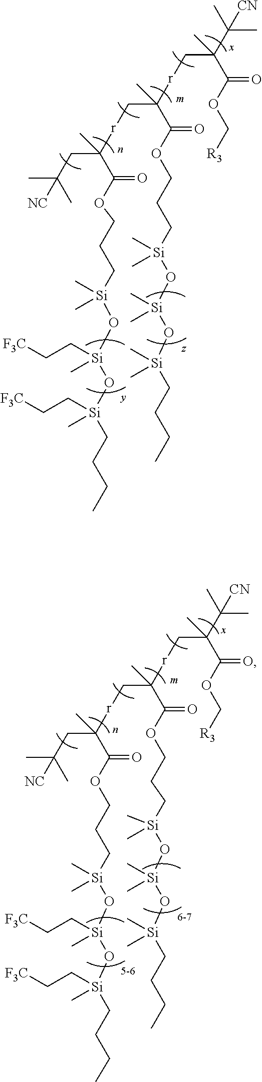 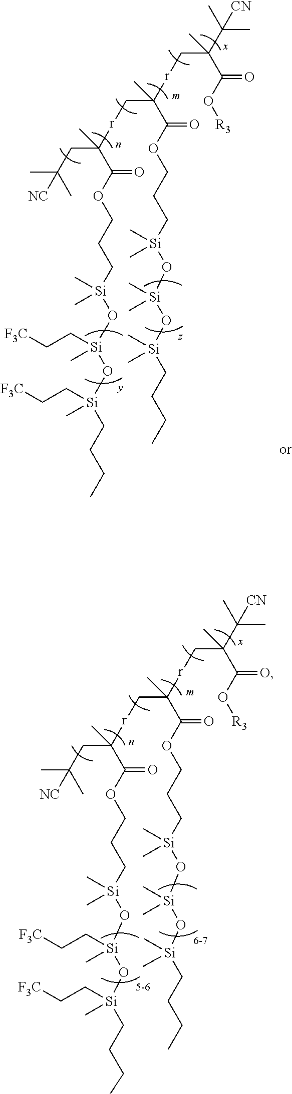
wherein n, m, and x are mole fractions where n+m+x=1, y is an integer from about 2 to about 20; z is an integer from about 2 to about 20; R₃ is a UV blocking group and r indicates random polymerization.

22. The optically clear bottlebrush copolymer of claim 17 having the formula: 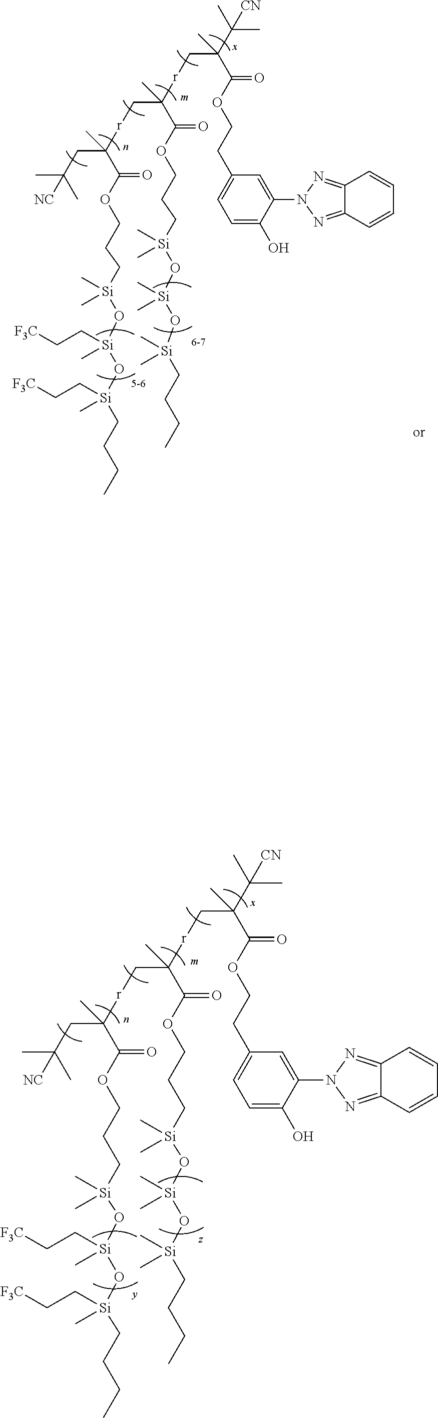
where n, m, and x are mole fractions (n+m+x=1); y is an integer from about 2 to about 20; z is an integer from about 2 to about 20; and r indicates random polymerization.

23. A method for forming an optically clear bottlebrush copolymer comprising:
A) combining one or more monomethacryloxypropyl-terminated polydimethylsiloxane, asymmetric (PDMS-MA), one or more monomethacryloxypropyl-terminated poly(3,3,3-trifluoropropyl)methylsiloxane, asymmetric (Fluoro-MA), a chain transfer agent suitable for RAFT polymerization reactions; an initiator, and an anhydrous solvent in a sealed reaction vessel;
B) sparging the reaction mixture with an inert gas and heating it for from about 12 hours to about 24 hours;
C) quenching the reaction by opening the reaction vessel to the air and allowing it to cool;
D) washing the resulting mixture with a polar organic solvent to produce a yellow bottlebrush copolymer intermediate having yellow thiocarbonyl end groups;
E) dissolving the yellow bottlebrush copolymer intermediate and an initiator in a suitable anhydrous solvent in a sealed reaction vessel;
F) sparging the reaction mixture of step E in an inert gas and heating it for from about 2 hours to about 6 hours to remove said yellow thiocarbonyl end groups; and
G) concentrating the reaction mixture of step F to remove the anhydrous solvent and washing it to produce an optically clear bottlebrush copolymer.

24. (canceled)

25. (canceled)

26. The method of claim 23 wherein the chain transfer agent in Step A has the formula:

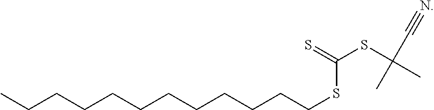 [SMILES: CCCCCCCCCCCCSC(=S)SC(C)(C)C#N]

27. The method of claim 23 wherein the each one of the initiators in Steps A and E is selected from azo compounds, organic peroxides, inorganic peroxides, or combinations thereof.

28. The method of claim 23 wherein the initiator in at least one of Step A and Step E is 2,2′-azobis(2-methylpropionitrile) (AIBN).

29. (canceled)

30. The method of claim 23 wherein the step of washing the resulting mixture with a polar organic solvent (Step D) comprises:
1) adding an excess of methanol to the reaction mixture of Step C and vortexing;
2) cooling the mixture in an ice bath for from about 30 seconds to about 30 min to form a biphasic system having a methanol supernatant; and
3) decanting off the methanol supernatant to leave the yellow bottlebrush copolymer intermediate having yellow thiocarbonyl end groups.

31. (canceled)

32. The method of claim 23 wherein the step of washing in Step G comprises:
1) adding an excess of methanol to the reaction mixture of Step F and vortexing;
2) cooling the mixture in an ice bath for from about 30 seconds to about 30 min to form a biphasic system having a methanol supernatant; and
3) decanting off the methanol supernatant to leave the optically clear bottlebrush copolymer;
4) dissolving the optically clear bottlebrush copolymer in a suitable solvent and passing it through a 2 μm PTFE filter;
5) concentrating the resulting filtered polymer to remove any remaining solvent;
6) drying the polymer of step 5 under vacuum for from 6 to 18 hours to produce the optically clear bottlebrush copolymer.

33. (canceled)

34. The method of claim 23 wherein the step of combining further comprising adding a UV blocking dye methacrylate monomer to said sealed reaction vessel.

35. (canceled)
